(19) United States
(12) Patent Application Publication
(10) Pub. No.: US 2018/0361704 A1
(43) Pub. Date: Dec. 20, 2018

(54) ADAPTIVE SMART TEXTILES, METHOD OF PRODUCING THEM, AND APPLICATIONS THEREOF

(71) Applicants: The Regents of the University of California, Oakland, CA (US); NanoSD, Inc., San Diego, CA (US)

(72) Inventors: Sungho JIN, San Diego, CA (US); Calvin GARDNER, San Diego, CA (US); Ying ZHONG, San Diego, CA (US); Gunwoo KIM, La Jolla, CA (US); Renkun CHEN, San Diego, CA (US); Chulmin CHOI, San Diego, CA (US); Yuongjin KIM, La Jolla, CA (US)

(21) Appl. No.: 15/780,551

(22) PCT Filed: Dec. 1, 2016
(86) PCT No.: PCT/US16/64423

§ 371 Date: May 31, 2018

Related U.S. Application Data
(60) Provisional application No. 62/261,688, filed on Dec. 1, 2015.
(60) Provisional application No. 62/316,418, filed on Mar. 31, 2016.
(60) Provisional application No. 62/316,407, filed on Mar. 31, 2016.
(60) Provisional application No. 62/384,301, filed on Sep. 7, 2016.
(60) Provisional application No. 62/407,975, filed on Oct. 13, 2016.

(51) Int. Cl. B32B 5/26; B32B 25/20; B32B 5/02; B32B 27/12; B32B 27/36; B32B 27/08; B32B 25/10; B32B 15/14; B32B 15/09; B32B 15/20; B32B 15/18; B32B 7/12; D06M 17/00

(52) U.S. Cl. CPC B32B 5/26; B32B 2307/30; B32B 5/024; B32B 27/12; B32B 27/36; B32B 27/08; B32B 25/10; B32B 15/14; B32B 15/09; B32B 15/20; B32B 15/18; B32B 7/12; D06M 17/00; B32B 2307/728; B32B 2262/0276; B32B 25/20

(57) ABSTRACT

Adaptive smart textiles that facilitate reduced energy consumption are described. In one implementation, a dual pane fabric arrangement includes a first pane of fabric and a second pane of fabric separated by an intra-layer gap, and an insert layer disposed in the intra-layer gap, wherein the insert layer causes a thickness of the intra-layer gap to change responsive to changes in ambient temperature.

### CROSS-REFERENCE TO RELATED APPLICATIONS

This patent document claims benefit of priority of U.S. Provisional Patent Application No. 62/261,688 entitled “ADAPTIVE SMART TEXTILES, METHOD OF PRODUCING THEM, AND APPLICATIONS THEREOF,” filed on Dec. 1, 2015; U.S. Provisional Patent Application No. 62/407,975 entitled “CREEP-RESISTANT, DIMENSION-ALTERABLE POLYMER BILAYERS, AND FABRICATION METHODS THEREFOR,” filed Oct. 13, 2016; U.S. Provisional Patent Application No. 62/384,301 entitled “DIMENSION-CHANGEABLE AND LIGHT-REFLECTION-CHANGEABLE SMART TEXTILES, FABRICATION METHODS, ASSEMBLED STRUCTURES, AND APPLICATIONS THEREOF,” filed Sep. 7, 2016; U.S. Provisional Patent Application No. 62/316,418 entitled “ARTICLE COMPRISING POROSITY-GENERATING SMART TEXTILES, ASSEMBLED STRUCTURES, METHODS OF ASSEMBLY, AND APPLICATIONS,” filed Mar. 31, 2016 and U.S. Provisional Patent Application No. 62/316,407 entitled “THICKNESS-CHANGEABLE SMART FABRICS, ASSEMBLED STRUCTURES, METHODS OF ASSEMBLY, AND APPLICATIONS,” filed Mar. 31, 2016. The entire content of the aforementioned patent applications are incorporated by reference as part of the disclosure of this patent document.

### STATEMENT REGARDING FEDERALLY SPONSORED RESEARCH OR DEVELOPMENT

This invention was made with government support under grant DE-AR0000535 awarded by the Department of Energy's Advanced Research Projections Agency-Energy (ARPA-E). The government has certain rights in the invention.

### TECHNICAL AREA

This patent document relates to thermally adaptive fabrics.

### BACKGROUND

With the increasing cost of energy, and the general impact of the increased energy consumption by humans on global ecosystem, energy efficient technologies have become commercially and socially important.

### SUMMARY

The systems, devices and techniques disclosed in this patent document provide for smart textiles, including energy saving textiles responsive to changes of temperature, humidity or both. The disclosed adaptive and smart textiles enable dimensional changes in response to the altered temperature or humidity near the human body or nearby environment so as to make the person feel more comfortable. The adaptive and smart textiles can change one or more properties actively or passively or both, including thermal insulation properties, air breathability and air flow characteristics, temperature, color and other optical properties, aesthetic properties, electronic properties, and wettability. An article of manufacturer comprising such smart textiles can be useful for various applications include indoor or outdoor personal wearable systems such as environmentally adaptive clothing, shoes, hats, jackets to, environmentally adaptive indoor curtains, draperies, bedding materials, environmentally adaptive outdoor camping equipment such as tents and sleeping bags.

In one example aspect, a dual pane fabric arrangement includes a first pane of fabric and a second pane of fabric separated by an intra-layer gap, and an insert layer disposed in the intra-layer gap, wherein the insert layer causes a thickness of the intra-layer gap to change responsive to changes in ambient temperature.

In another example aspect, a process of manufacturing an insert layer includes producing an arrangement of materials by adhesively bonding a first laminar material having a first coefficient of thermal expansion (CTE) with a second laminar material having a second CTE that is different from the first CTE using an intermediate bonding material, and roller compressing the arrangement of materials to produce the insert layer.

In yet another example aspect, a humidity responsive porosity-changeable arrangement includes a fabric and a hygroscopic layer attached at a bottom or top of the fabric, the hygroscopic layer having geometrical pores that allow air to flow to and away from the fabric.

In yet another example aspect, a method of assembly to produce humidity responsive porosity-changeable fabrics or clothing or other wearable or non-wearable structure includes attaching a humidity absorbable material layer to a regular fabric using imprint bonding, utilizing dip coated, spin coated, spray coated or ink-jet coated liquid layer.

### BRIEF DESCRIPTION OF THE DRAWING

The advantages, nature and additional features of the disclosed technology will appear more fully upon consideration of the illustrative embodiments described in the accompanying drawings. In the drawings:

FIG. 1 shows an example of a thermally adaptive, adjustable-gap-textile based on thermal expansion mismatch behavior. (a) Structural descriptions, (b) Coefficient of Thermal Expansion (CTE) mismatch bilayer ribbon stress and strain analysis, (c) Double-pane sandwich structure changing the overall thickness responding to temp change, (d) Example curvature change of bimetal consisting of a negative CTE Ni—Ti alloy ribbon (CTE=˜−30 ppm/° C.) laminated with a positive CTE 304 stainless steel ribbon (CTE=˜+17 ppm/° C.), both 50 μm thick.

FIG. 2 shows an example of thermally adaptive (passive) clothing with temperature-dependent, self-adjusted fabric thickness. (a) Schematics of temperature induced bending of negative CTE-positive CTE bonded ribbons within a dual pane fabric for thickness change, (b) Altered fabric thickness change and associated air-gap and thermal insulance change to make a person feel cooler or warmer, (c) Thermal insulance estimation of air-gapped, dual-pane fabric structure indicates the air-gap spacing required to make the skin feel at 30° C. for the given room temperature. For example, for room temp=16° C., one needs ˜6 mm air-gap to make the skin feel at 30° C. If a 2 mm gap is produced, the effective ΔT=˜4° C. worth of energy savings is obtained.

FIG. 3 shows an example of a negative CTE introduced in a Ni—Ti alloy in ribbon geometry suitable for bilayer formation by uniaxial deformation and cold rolling. The negative CTE is reproducible for many temperature cycles. The average negative CTE value in the figure is −20 to −25 ppm/K, with the alloy ribbon capable of negative CTE between −1 to −100 ppm/K, with the value dependent on processing and composition specifics.

FIG. 4 illustrates an experimental example of near-zero CTE layer (Invar) and positive CTE layer (Al alloy) temperature-responsive, dimensional changeable bilayer consisting of Invar 36 and aluminum alloy 1100 layers. The grid size in the background is 1 cm.

FIG. 5 shows an experimental example of all-metal positive CTE mismatch temperature-responsive bilayer consisting of low-carbon steel and aluminum alloy 1100 layers. Grid size is 1 cm.

FIG. 6 illustrates an experimental example of negative CTE-positive CTE temperature-responsive bilayer consisting of uniaxially deformed and roll flattened Ni—Ti alloy ribbon and a cellulose acetate polymer layer. The grid size in the background is 1 cm.

FIG. 7 illustrates an example embodiment of a metal-polymer bilayer composite (a) ribbon-shaped or (b) embedded composite with fiber-shaped geometry, capable of large bending and associated thickness change of dual-pane fabric when used as an insert. In the bilayer structure of (a), an additional thin polymer layer can optionally be added to the underneath of the Ni—Ti type negative CTE metal alloy ribbon for protection if desired (to minimize the physical contact of metal to the human skin). The off-centered configuration is essential for introducing the bending and geometry change.

FIG. 8 illustrates an experimental example of a thermally-responsive interlayer both alone and inserted within a smart textile. The fabric is a woven polyester-cotton blend and the CTE-mismatched bilayer in use consists of Ni—Ti alloy ribbon and cellulose acetate ribbon. The grid size in the background of the graph is 1 cm.

FIG. 9 shows examples of thermal insulation measurements of thickness-changeable smart fabric (S.F.) via guarded hot plate suspended in a convection oven. (Top Left) The temperature underneath the smart fabric as ambient temperature is increased and decreased; blue bars show equilibrium values. (Top Right) Temperature difference between the underside of smart fabric or reference samples and the convection chamber ambient temperature during increasing temperature test; bars show equilibrium values and green numbers show chamber set points. (Bottom Left) Temperature difference between the underside of smart fabric or reference samples and the convection chamber ambient temperature during decreasing temperature test; bars show equilibrium values and green numbers show chamber set points. (Bottom Right) Difference of underside temperature between smart fabric and flat reference sample as compared against ambient temperature; sloped trend indicates adaptive insulance property of thickness changeable smart fabric; model calculated based on reference measurements of system heat loss, 1.62 Watt power level, and observed insulation layer thickness.

FIG. 10 illustrates examples of a mechanically strengthened polymer-polymer CTE mismatch composite (a) Cross-sectional view of CTE-mismatch polymer bilayer (the adhesive middle layer is very thin), (b)(c) Cross-sectional view of dispersoid strengthened polymer bilayer, (d) CTE-mismatch polymer bilayer, (e) Cross-sectional view of fiber-reinforced polymer bilayer with the interface layer also strengthened, (f) Top view of exemplary fiber or ribbon reinforced polymer bilayer geometry. High strength and high modulus fibers such as carbon nanotubes (CNTs), graphene nanoribbons, woven glass fibers, electrospun polyacrylonitrile (PAN) nanofibers, superdrawn ultrahigh molecular weight (UHMW) PAN microfiber.

FIG. 11 illustrates some exemplary methods of attaching a low CTE layer and a high CTE layer to form a temperature-responsive, mechanically reinforced bilayer for creep-resistance dimension-change performance, (a) bonding with interfacial layer, (b) bonding via cold press lamination (or warm press lamination if adhesive curing is also obtained), and (c) bonding using periodic spot glueing and spreading.

FIG. 12 shows an example of a lamination of dispersion strengthened or fiber-reinforced, low CTE layer and high CTE layer bilayer to produce an insert material for temperature-responsive thickness changeable or flap-openable textiles. The laminated structure with adhesive bonding material at the interface is roller compression pressed for good adhesion. This approach can be made into a continuous manufacturing procedure. The initial curvature of the bilayer can be set by strain training, e.g., reheating to a desired temperature under bending stress.

FIG. 13 illustrates an experimental example of all-polymer positive CTE mismatch temperature-responsive bilayer consisting of PEEK and UHMWPE layers. The grid size in the background graph is 1 cm.

FIG. 14 illustrates an example of a temperature responsive fabric with changeable thickness and insulation by using laminated two materials having substantially different coefficients of thermal expansion (CTE) as an insert. The insert array can be positioned horizontally as in this figure, or vertically or at any other angles. Examples of negative CTE material include shape memory alloys processed into a gradient-transformation-temperature structure or shape memory polymers, or pre-strained polymers, and examples of positive CTE materials includes metallic or polymer materials such as cellulose acetate.

FIG. 15 shows an example of a lamination of negative CTE and positive CTE layers to produce an insert material for temperature-responsive thickness changeable textiles. The laminated structure with adhesive bonding material at the interface is roller compression pressed for good adhesion. This approach can be made into a continuous manufacturing procedure.

FIG. 16 shows an example of an assembly of the temperature-responsive expandable material with the dual-pane fabric layers by using a stitching method to produce a thickness-changeable textile.

FIG. 17 shows examples of friction reducing structures with (a) slippery sphere attached at the end of the bilayer ribbon, (b) ribbon ends curved up, (c) ribbon ends curved down.

FIG. 18 illustrates an example of a bilayer consisting of Ni—Ti alloy (wire drawn from 125 μm to 100 μm diameter+cold rolled to flat ˜35 μm thick×˜200 um wide ribbon) and cellulose acetate (˜80 μm thick ribbon). Bilayers were joined by a thin adhesive and cured in a pre-flexed state. After cure, the bilayer returns to flat state at 25° C. The bilayer ribbon bending and straightening behavior vs temperature change is shown with a graph paper in the back ground (1 cm grid).

FIG. 19 illustrates an example of an assembly of the temperature-responsive expandable material with the dual-pane fabric layers by using an adhesive island array and bonding of the CTE-mismatched expandable material insert.

FIG. 20 illustrates an example of an assembly of temperature-responsive structure array on adhesive islands placed on fabric surface. Adhesive island array can optionally or additionally placed on the mating fabric of the dual-pane textile as well.

FIG. 21 illustrates an example use of array stitching to assemble the temperature-responsive structure array on fabric surface. The stitch array can optionally or additionally placed on the mating fabric of the dual-pane textile as well.

FIG. 22 illustrates an example use of flexible connecting string or thread array between the upper and the lower fabric pane so that the two fabrics are kept in place during the temperature-induced expansion or contraction of the textile.

FIG. 23 illustrates an example of a temperature responsive fabric with changeable thickness and insulation by using an array of spring inserts laminated with two materials having substantially different coefficients of thermal expansion (CTE). The insert array can be positioned horizontally as in this figure, or vertically or at any other angles. Examples of negative CTE material include shape memory alloys processed into a gradient-transformation-temperature structure or shape memory polymers, or pre-strained polymers, and examples of positive CTE materials includes metallic or polymer materials such as cellulose acetate.

FIG. 24 illustrates an example of a curtain structure made of temperature responsive fabric which gets thicker when the indoor ambient temperature drops, and gets thinner when the temperature rises, due to the thickness-changing behavior of the negative CTE-positive CTE composite layer.

FIG. 25 illustrates an example of a temperature responsive, thickness-changeable (insulation-changeable) curtain structure with two regular fabrics having (a) an array of inserts of negative/positive CTE paired spring structure, (b) Vertically configured fabric (e.g., drapery) with thickness-changeable dual-pane structure comprising temperature responsive insert array, (c) an array of wave shaped, CTE-mismatched bilayer spring can be utilized instead of the Negative/positive CTE-paired spring. The array of inserts can be attached onto one of both of the outside fabric layer by stitching, stapling or adhesive bonding.

FIG. 26 shows an example of enhanced bilayer interfacial locking of negative CTE layer with positive-CTE layer (or low positive CTE-high positive CTE pairing in general) using re-entrant pore array.

FIG. 27 illustrates an example of a perforated CTE-mismatched bilayer for faster temperature response, reduced rigidity, and easier locking-in.

FIG. 28 illustrates an example of a multi-strip shaped CTE-mismatched bilayer for reduced stiffness or for faster temperature response.

FIG. 29 illustrates an example surface textured CTE-mismatched bilayers for enhanced adhesion/bonding.

FIG. 30 illustrates an example of CTE-mismatched bilayers made of negative CTE material such as a specially processed Ni-Ti alloy ribbon, or a low-CTE alloy, adhered onto a positive CTE polymer ribbon.

FIG. 31 illustrates an example of a bow-style temperature adaptation from mirrored CTE-mismatched bilayers.

FIG. 32 illustrates an example of a square-configuration thermally adaptive textile (TAT) insert.

FIG. 33 illustrates an example of a square-configuration insert for thermally adaptive textile with square array closed cells.

FIG. 34 illustrates an example of a hexagon-configuration (star shape) thermally adaptive insert made of negative CTE alloy and positive CTE polymer.

FIG. 35. illustrates an example of a hexagon-configuration (star shape) thermally adaptive insert with hexagon closed cells, (a)-(c). Also shown in (d) is a multilayer structure to increase the overall thickness change.

FIG. 36. illustrates an example of an open cell thermally adaptive insert between two textile fabrics.

FIG. 37 illustrates an example of a closer packing of bow-type thickness-changeable material for increased vertical push or pull force comprising CTE-mismatched bilayer array. The bilayer is made of negative/zero/low CTE material such as a specially processed Ni—Ti shape memory alloy ribbon (or Invar alloy or refractory metal alloy) adhered onto a large positive CTE polymer or alloy ribbon. (a) close packed triangular packing, (b)close packed square packing.

FIG. 38 illustrates some exemplary methods to control the curvature of the CTE-mismatch bilayer to obtain a preset bow-flat temperature in the temperature-responsive bilayer.

FIG. 39 illustrates various types of bilayer structures (metal-metal, metal-polymer, polymer-polymer combination) with a CTE-mismatch-induced bending to create opening (pore array) on temperature change. Different bilayer component materials are selected to induce significant bending and associated cooling effect for a person wearing such a flap-array fabric.

FIG. 40 shows an example of a temperature-responsive, pore-openable fabric by flap opening using a CTE mismatched bilayer fabric.

FIG. 41 is a schematic illustration of temperature-only-responsive flap opening fabric structure using a CTE mismatched bilayer material array. The color reflection can also be changed by flap opening.

FIG. 42 illustrates some exemplary methods of attaching a metallic low CTE layer and a metallic high CTE layer to form a temperature-responsive bilayer, (a) bonding with interfacial layer, (b) bonding via cold weld lamination, and (c) bonding using periodic spot welding or RF heating.

FIG. 43 illustrates examples of selected local area color or light-reflection change by temperature-responsive flap opening using a CTE mismatched bilayer fabric.

FIG. 44(A) illustrates an example of a combined flap open and fabric thickness change using an array of large CTE mismatch bilayer for personal comfort control.

FIG. 44(B) illustrates various other embodiments to open pores in the fabric by dimensional change of fabric component or fiber using, (a) expansion and shrinkage of a ribbon array to close or open pores, (b) rotation of paddle array, (c) fabric fiber dimensional change.

FIG. 45 illustrates an example of a humidity-responsive adaptive fabric which makes the wearer to feel cooler by opening of the flaps to generate more pores and enhance air flow

FIG. 46 illustrates examples of (a) Schematic structure design and composition of materials in bilayer film made of hygroscopic polyethylene glycol (PEG) mixed with less hygroscopic or hydrophobic cellulose acetate (CA) layer as the 20 um thick humidity absorbing layer. This layer is attached onto 40 um thick hydrophobic Polydimethylsiloxane (PDMS) layer above. The use of CA makes easier to minimize the stickiness of PEG and control the viscosity for easier layer casting.

FIG. 47 illustrates examples of (a) Bilayer humidity responsive polymer that can be bent up when the humidity and temperature are increased, with the hygroscopic (hydrophilic) layer material made porous for easier humidity transport. An array of cut-out flabs can be arranged for porosity generation on humidity increase. (b) The hydrophilic layer is placed above with the hydrophobic (less hygroscopic) layer underneath having an array of geometrical holes or pores to allow penetration of humidity to the upper hygroscopic polymer layer.

FIG. 48 illustrates an example of an effect of porosity in hydrophobic layer vs effect of porosity in hygroscopic layer. The extent of the curvature increase is marked by dotted line above. Increased porosity in hydrophobic layer reduces the elastic modulus and hence enhances the curvature, while the increased porosity in hygroscopic layer helps the humidity penetration kinetics to be faster to enable rapid response to humidity. The reduced elastic modulus in the hygroscopic layer decreases the curvature though.

FIG. 49 illustrates an example of bending behavior of humidity-responsive polymer fabric vs humidity and temperature change. (a) a flap opening image at each condition of temperature and relative humidity (provided by a warm water beaker underneath with a metal mesh screen support), (b) height of an opened flap at each condition, (c) height of an opened flap as a function of absolute humidity. The polymer layer (and the flap array structure within) is composed of 150 um thick 100% polyester woven fabric+synthesized humidity-responsive polymer made of 30 um PET+60 um thick (CA-10% PEG).

FIG. 50 illustrates an example of an emulsion method to stabilize hydrophilic monomers in hydrophobic monomers. Selected monomers of at least one hydrophobic monomer (such as Polydihexylsilane (PDHS), vinyl PDMS, etc) and one hydrophilic monomer (selected from various monomers of PEG dimethacrylate, PEG methacrylate, PEG diacrylate), are vigorously mixed to produce a small particle emulsion which can improve the stability of e.g., PEG monomers in the PDMS elastomer.

FIG. 51 illustrates an example of a well-mixed hydrophobic/hydrophilic polymer structure, with different MW PEGs combined. PEG with higher molecular weight (e.g., MW=2000 vs MW=350) is more hygroscopic. A proper mix of higher MW and lower MW PEG can be utilized to control the degree of hygroscopic properties (and responsiveness to humidity and water). These PDMS based humidity-responsive materials are also highly elastic, enabling more than 100% stretchability if desired.

FIG. 52 illustrates an example of a hydrophobic/hydrophilic polymer structure paired with PDMS upper layer, which responds to humidity and creates a curvature.

FIG. 53(A) illustrates an example relationship between the height of the opened flap vs absolute humidity in the humidity responsive flap openable textile.

FIG. 53(B) illustrates an example relationship between time dependent relative humidity and temperature inside the insulated box with the top covered with the humidity responsive flap openable textile (thermally adaptive textile, TAT) and the normal non-TAT textile with no humidity-responsive flaps on it. 100 ul of water was injected at 50 seconds, relative humidity was stabilized and the flaps started to open at 90 seconds. When the humidity was reduced, the flaps started to close at 900 seconds. The ambient temperature was 26° and the ambient humidity was 65%.

FIG. 53(C) illustrates an example of the time dependent apparent temperature difference between the humidity responsive flap openable textile and the normal textile with no flaps on it. The minus value of ΔT indicates the humidity responsive flap openable textile has more cooling effect than the normal textile.

FIG. 54(A) illustrates an example method of assembly for humidity responsive fabric comprising hygroscopic layer and hydrophobic regular fabric layer, using contact printing of wet, uncured polymer placed on a flat surface using spray coat, spin coat, dip coat or ink-jet printing.

FIG. 54(B) illustrates an example method of assembly for humidity responsive fabric comprising first forming a two-layer composite made of hygroscopic layer and hydrophobic layer using contact printing of wet, uncured polymer placed on a flat surface using spray coat, spin coat or dip coat, or ink-jet printing, with the composite then attached onto the top regular fabric (which is hydrophobic) by using contact imprinting.

FIG. 55 illustrates an example of a spray coating method of assembling a humidity responsive fabric by spray depositing an uncured hygroscopic polymer onto the regular hydrophobic fabric.

FIG. 56 illustrates an example of two steps of spray coating for assembly of a humidity responsive fabric by separately spray depositing an uncured hydrophobic layer and then uncured hygroscopic polymer layer onto the regular hydrophobic fabric.

FIG. 57 illustrates an example of an oblique incident angle spray coating method of assembling a humidity responsive fabric by spray depositing an uncured hygroscopic polymer onto the regular hydrophobic fabric.

FIG. 58 illustrates an example of an oblique incident angle, two steps of spray coating for assembly of a humidity responsive fabric by separately spray depositing an uncured hydrophobic layer and then uncured hygroscopic polymer layer onto the regular hydrophobic fabric.

FIG. 59 illustrates an example of a multilayer formation method for humidity responsive fabrics using bed-of-nail template technique

FIG. 60. illustrates an example of a hygroscopic layer lamination approach to form humidity responsive fabrics.

FIG. 61 illustrates an example of a two layer (hydrophobic layer and hygroscopic layer) sequential lamination approach to form humidity responsive fabrics

FIG. 62 shows examples of different flat geometry that can be used (left), and flap arrangements to reduce friction and uncomfortable feeling by the apparel wearer (right).

FIG. 63 illustrates an example of an active functional device array or functional coating layer added on the surface of humidity responsive pore-generating fabric for augmented comfort or luxurious feeling (e.g., solar cell array, UV or IR or NIR reflective layer, UV or IR or NIR absorbing layer, UV or IR or NIR transmitting layer, superhydrophobic non-wettable layer, water evaporation cooling device, batteries for heating, thermoelectrics for cooling/heating, ultrasonic device for vibration for easier air transport through fabric, de-ordorant device or layer, color-changing device or layer, scent-generating device, acoustic or radio type device, display device, camera, sensors (for temperature, humidity, UV light, gas, human pulse, noise, etc) Wi-Fi receiving or transmitting device, etc.

FIG. 64 illustrates an example of a pore-generating smart fabric with active functional device array or functional coating layer added on the surface with the base fabric material modified to exhibit IR transmitting and body heat releasing properties, or with applied IR reflecting coating on the inside surface to further enhance retaining of body heat.

FIG. 65 illustrates an example of an active functional device array or functional coating layer added on the surface of thickness-changeable fabric for augmented comfort or luxurious feeling (e.g., solar cell array, UV or NIR or IR reflective layer, UV or NIR or IR absorbing layer, UV or NIR or IR transmitting layer, superhydrophobic non-wettable layer, water evaporation cooling device, batteries for heating, thermoelectrics for cooling/heating, ultrasonic device for vibration for easier air transport through fabric, de-odorant device or layer, color-changing device or layer, scent-generating device, acoustic or radio type device, display device, camera, sensors (for temperature, humidity, UV light, gas, human pulse, noise, etc.) Wi-Fi receiving or transmitting device, etc.

FIG. 66 illustrates an example of a thickness changeable smart fabric with active functional device array or functional coating layer added on the surface with the base fabric material modified to exhibit IR transmitting and body heat releasing properties, or with applied IR reflecting coating on the inside surface to further enhance retaining of body heat.

FIG. 67 illustrates an example of a functional device layer attached onto the fabric using magnetic, velcro, zipper or button attachment mechanism, with color change or shape change induced by CTE mismatched bilayer material. Such an attachment/detachment mechanism allows the devices to be utilized without having to be washed or dried in a laundry process.

FIG. 68 illustrates an example of a combined thickness-changeable or porosity-generating textile with functional device array placed on a porous and compliant electric wiring mesh matrix.

It is to be understood that the drawings are for purposes of illustrating the concepts of the embodiments and are not necessarily to scale.

### DETAILED DESCRIPTION

With the noticeable global warming trends, it is desirable to dramatically reduce the energy consumption. The disclosed technology describes adaptive smart textiles and clothing for personal thermoregulation. The energy consumption in building heating, ventilation, and air-conditioning (HVAC) systems can be reduced significantly if the set-points of the indoor temperature are extended in either direction, so that less energy (electricity or gas) is used for air-conditioning and heating.

Compared to traditional textiles, it is desirable to provide advanced textiles that can change shape, color, thermal properties and other physical characteristics. Also, it is highly desirable to significantly reduce the energy consumption as the use of fossil fuels adds to the global warming trends. Examples of the disclosed technology include adaptive smart textiles useful for personal thermoregulation. For example, the energy consumption in building heating, ventilation, and air-conditioning (HVAC) systems can be reduced by at least 15% if the set-points of the indoor temperature are extended by 4° F. in either direction, namely from the current 70-75° F. comfort range to between 66 and 79° F. If widely implemented, this energy saving would result in 2% savings in US domestic energy (about ˜1.8 QBtu/YR) and greenhouse gas (GHG) emissions savings equivalent to ˜100 MT CO₂/yr. To reduce the energy consumption, especially for building indoor comfort, the disclosed technology provides for various approaches including introduction of smart and adaptive textiles that make a person indoors to feel cooler or warmer as such need arises, so that the use of energy (electricity) for air-conditioning and heating is reduced. The disclosed technology also provides useful smart textiles for outdoor activities, as well as aesthetically enhanced textiles with improved design features and functionalities.

As is well known, the power consumption of the air conditioning will increase 5-8% as we change the indoor temperature setting for just one degree. Instead of solely depending on one of the most extravagant energy consumers, air conditioner or heater, smart textiles can help people adjust the body temperature without extra energy consumption. With efficient thermally adaptive textiles, people may not have to turn on the air conditioner when the room temperature is out of the range of 70-75° F.

To realize a substantially thermally adaptive feature of textiles, this patent document demonstrates design and construction of temperature-responsive noble composite materials structures to enable smart fabric structures which can be configured to be responsive to the ambient temperature or humidity change in a desirable way to make the wearer or the environment near the person more comfortable, as well as to save energy.

The concepts, various embodiments, practical and beneficial aspects, and potential applications of new and unique structured, thermally adaptive textile with adjustable air-gaps are disclosed. In the case of dual-pane structures, one or multiple stacks of a sandwich-like structure, each space between neighboring ordinary cloth fabric layers containing one of more array of temperature responsive inserts which can change the thickness of the air gap in responsive to ambient temperature to adjust the thermal resistance and skin temperature, or which can open the flap array to let fresh air come in and upon temperature rise or humidity rise. When the dual-pane smart textile becomes thicker, more air trapping will make the textile to be warmer, and when it becomes thinner, the person will feel cooler, thus making the use of air-conditioner or heater less needed, saving electricity of other cooling/heating energy. Section headings are used throughout the document only to facilitate understanding and do not limit the scope of the technology to each particular section.

This document discloses noble composite structures and method of fabricating them so as to enable dimensional changes in fabrics for human comfort control. The composites are preferably layered materials with different physical properties in terms of temperature responses or humidity responses. A single layer composite structures are also enabled. Various embodiments can be with at least five different types of thermal regulation approaches and embodiments as follows.

(A) Thermal-insulation-changeable smart fabrics, which can comprise of either (i) metal-metal-coupled, layer structured temperature-responsive composite materials, or (ii) metal-polymer-coupled, layer structured temperature-responsive composite materials, or (iii) polymer-polymer-coupled, layer structured composite materials,

(B) Porosity changeable and air-flow adjustable smart fabrics activated solely by environmental temperature changes,

(C) Smart fabrics having a combination of thermal-insulation changeable and through-fabric air flow changeable characteristics,

(D) Smart fabrics having a porosity-changeable and through-fabric air flow changeable characteristic activated solely by environmental humidity changes,

(E) passive or active control of optical, thermal, acoustic, display, aesthetic and electronic characteristics either activated by temperature changes or powered by electrical energy supplied by energy storage devices, energy generating devices or provided by self-sufficient solar cell devices.

The description below provides additional details of the various approaches listed above.

(A). Thermal-Insulation-Changeable Smart Fabrics.

Thermal-insulation-changeable smart fabrics can comprise of the following three embodiments. (i) metal-metal-coupled, layer structured temperature-responsive composite materials, or (ii) metal-polymer-coupled, layer structured temperature-responsive composite materials, or (iii) polymer-polymer-coupled, layer structured composite materials,

A-1. Metal-Metal-Coupled, Layer Structured Temperature-Responsive Composite Materials.

In the disclosed technology, the concepts, experimental embodiments and potential applications of new and unique structured, thermally adaptive textile with adjustable air-gaps and porosities are disclosed. Several example embodiments of smart thermally adaptive textiles and associated materials design and processing are described below.

The structural design and embodiments of the metal-metal-coupled, layer structured temperature-responsive composite materials for thermally adaptive textile (TAT) are described as follows. Controlling the thickness or porosity of the clothes is a convenient way to adjust their warmth-keeping function. According to the disclosed technology, either dual-pane structures or single-pane structures are designed and fabricated.

In the case of dual-pane structures, one or multiple stack of a sandwich-like structure is utilized. Each stack consists of two outer, ordinary cloth layers and one thermally adaptive interlayer insert which can change the thickness of the air gap responsive to ambient temperature to adjust the thermal resistance and skin temperature. When the dual-pane smart textile becomes thicker, more air trapping will make the textile to be warmer, and when it becomes thinner, the person will feel cooler, thus making the use of air-conditioner or heater less needed, saving electricity or other cooling/heating energy.

In the case of single-pane structures which are simpler to construct, the textile is made to respond to temperature change or humidity change (such as when a person wearing the clothing sweats) and its porosity or air-permeability is altered, so as to make the person feel cooler of warmed. This aspect will be discussed in a separate section later.

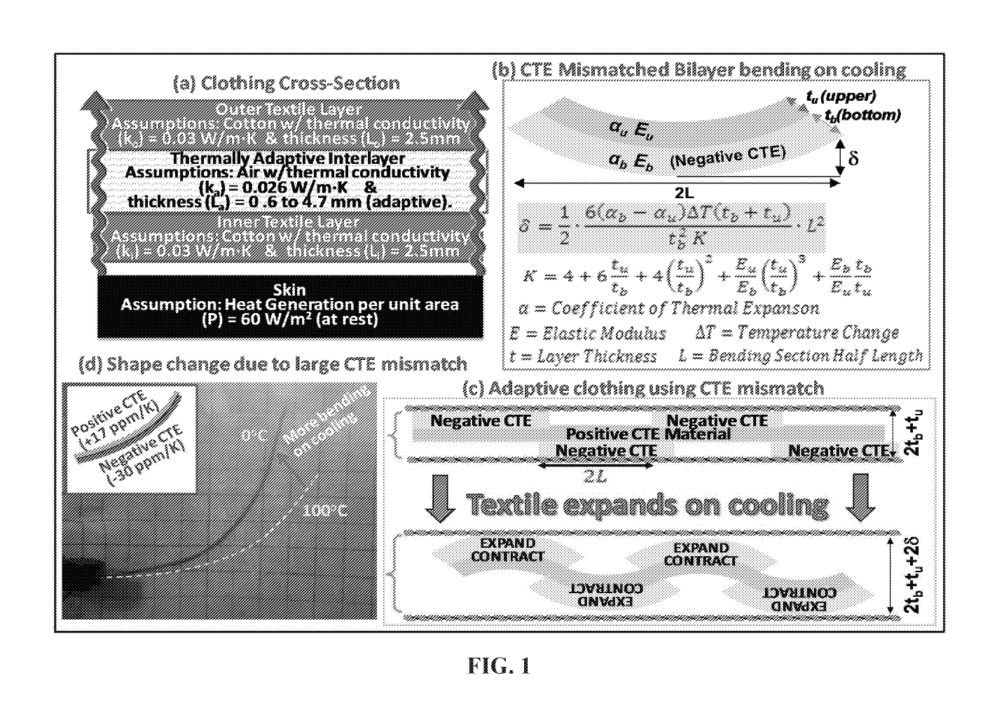

FIG. 1 shows an exemplary dual-pane structure of thermally adaptive interlayer, according to the disclosed technology. When two well adhered layers of different materials having different coefficient of thermal expansion (CTE), a change in environmental temperature causes the two layers to thermally expand or contract with a different extent, which induces the double layer to curve upward or downward. The degree of curvature so induced will depend on the difference in thermal expansion mismatch between the two layers (and the temperature change span). Most of the available materials in nature exhibit positive CTE values. If one of the bilayer materials is made to exhibit a negative CTE, the overall CTE difference and the extent of bending can be increased as compared to the case of both layers having positive CTE values. Such mechanical bending deformation can be structured to make a dual-pane fabric to become thicker or thinner as the environment temperature is altered. If the structuring of the fabric comprising such temperature-responsive bilayer is designed so that the dual-pane fabric becomes thicker (more air trapping and hence increased thermal insulation) when the temperature gets colder, such fabric will make the person feel warmer to be feel comfortable on cold environment. On the other hand, if such temperature-responsive bilayer becomes flatter to make the dual-pane fabric thinner (less air trapping and hence reduced thermal insulation) when the temperature gets hotter, the person will also feel cooler as is desired. Such desirable temperature responses of the self-adjustable smart fabric will then reduce the need to use an air conditioner or a heater inside a building, and hence will lead to energy savings.

FIGS. 1(a), 1(b), 1(c) and 1(d) show an exemplary structure of thermally adaptive, adjustable-gap-textile based on thermal expansion mismatch behavior utilizing the desirable negative CTE property of one of the components : (FIG. 1(a)) Structural descriptions; (FIG. 1(b)) CTE mismatch bilayer stress and strain analysis; (FIG. 1(c)) Dimensional change if dual-pane (or multiple pane) sandwich structure responding to temperature change; and (FIG. 1(d)) Example curvature change of bimetal consisting of a flat-dimensioned, negative CTE Ni—Ti alloy ribbon laminated with a positive CTE 304 stainless steel ribbon, both 50 μm thick.

Referring to FIG. 1(a), the adaptive middle layer is structured as two flat layers intimately bonded, comprising a negative CTE (coefficient of thermal expansion) alloy and a positive CTE alloy. In some embodiments, a Ni—Ti alloy is processed in a unique way so as to exhibit a large negative thermal expansion coefficient responding to the ambient temperature change and alter its thickness. The negative thermal expansion is desirable, since the natural materials always expand when heated, but in the design of smart adaptive textiles, one would benefit from having an opposite phenomenon, i.e., the textile has to contract and become thinner when heated, rather than expanding. When the temperature rises, the adaptive layer becomes less corrugated toward a flat geometry to decrease the thickness of the double-pane sandwich structure, which reduces thermal insulation and allows better heat dissipation from the skin. On the contrary, when the ambient temperature decreases, the adaptive layer expands to make the insulation layer thicker to keep the person warmer.

Thermal insulance (R value) is proportional to layer thickness (L) and varies inversely with material thermal conductivity (κ), i.e., R=L/κ. In the disclosed example smart fabric of FIG. 1, a thermally adaptive textile (TAT) structure is constructed with an inner and outer layer of a thin (0.5 mm) material such as nylon (κ˜0.25 W/m·K) and an air-filled (κ˜0.026 W/m·K) interlayer whose thickness is thermally adaptive (between 2 and 14 mm). For analysis purpose, the clothing is assumed to trap on average 9 mm of air near the body at equilibrium temperature (72.5° F.). By assuming a metabolic heat generation per unit area skin typical for resting (˜58.2 W/m²) and no wind chill factor for an indoor environment, the skin temperature of thermal equilibrium for varying intermediate layer thicknesses using the thermal model can be evaluated.

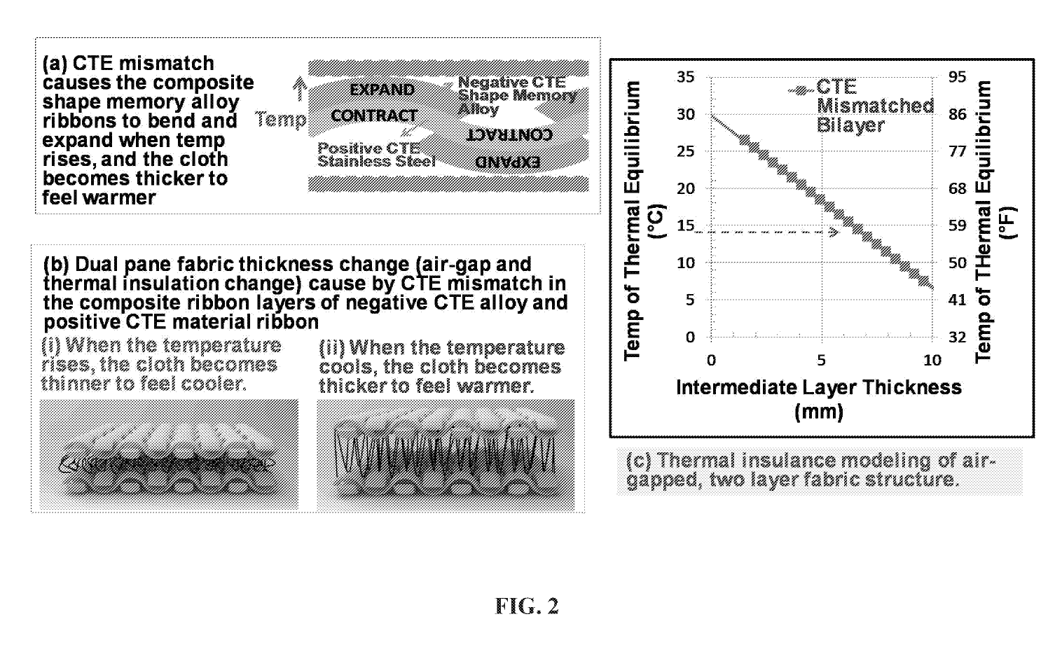

To make the thermally adaptive textile (TAT) structure shown in FIG. 1 and FIG. 2, negative CTE (coefficient of thermal expansion) alloys are utilized according to one embodiment of the disclosed technology. The use of negative coefficient of thermal expansion (CTE) facilitates the CTE-mismatch-induced bilayer ribbon bending on cooling, as experimentally demonstrated in FIG. 1(d).

Materials having near room temperature phase transformations can also be utilized for the structures. For example, some of the alloys known as the shape memory alloys such as Cu—Al—Zn, Cu—Al—Mn, Ni—Ti can exhibit a large strain and dimensional change on phase transformation. The reversible strain can be greater than 5% (50,000 ppm over 20° C. span) in some of these alloys. However, these materials, sometimes called “shape memory alloys,” are not typically useful for the smart fabric applications because of rather abrupt phase transition and hysteresis, which do not allow reproducible and dependable dimension-changeable behavior.

Spreading out the strain over much wider temperature range, for example, by gradient deformation and gradient phase transition temperatures, can introduce a hysteresis-free and negative CTE in excess of minus 20 ppm/K, and as much as minus 500 ppm/K. An adaptive intermediate layer of FIG. 1(a)-(d) can be constructed using a CTE (coefficient of thermal expansion) mismatched bilayer with carefully chosen design parameters. By joining a thin strip of stainless steel (thickness 0.05 mm, modulus 193 GPa, CTE=+17 ppm/K) to a thin strip of Ni—Ti alloy (similar to the Nitinol type shape memory alloy) but has been uniaxially processed and altered into a flat geometry of ribbon configuration, a consistent bending performance is obtained. The Ni—Ti negative CTE strip has a thickness 0.05 mm, modulus 83 GPa, CTE of minus 25 to minus 50 ppm/K. A lamination of an array of FIG. 1(c) structure, about 5-10 cm long, can result in an undulating strip designed to match the intermediate layer thickness for the temperature of thermal equilibrium.

FIG. 2 describes the thermally adaptive (passive) clothing with temperature-dependent, self-adjusted fabric thickness. FIG. 2(a) schematically illustrates the temperature induced bending of negative CTE-positive CTE bonded ribbons within a dual pane fabric for thickness change. FIG. 2(b) describes altered fabric thickness change and associated air-gap and thermal insulance change to make a person feel cooler or warmer. The plot in FIG. 2(c) shows a thermal insulance estimation of air-gapped, dual-pane fabric structure, which indicates that the air-gap spacing required to make the skin feel at 30° C. for the given room temperature. For example, for Room Temp=16° C., one needs ˜6 mm air-gap to make the skin feel at 30° C. If a 2 mm gap is produced, this will be equivalent to ΔT (the effective temperature change)=˜4° C. worth of energy savings.

The innovative adaptive textile clothings as described in FIG. 1 and FIG. 2 are washable, but it can also be made detachable (e.g., by using Velcro, zipper or button type mechanisms) so that they do not need to be washed often. The negative CTE Ni—Ti alloy is a metallic heat conductor, so if this passive controller can be combined with an active controller such as thermoelectric cooling or heating, so that the dumped/relayed heat can be utilized to raise the temperature of the dual-pane shrinkable fabric so that the adaptive clothing becomes thinner or flaps getting activated to open for air flow in and out for additional cooler feeling.

FIG. 2(c) also shows the expected thermal performance modeled based on the design of adaptive textiles. As the thermally adaptive interlayer expands from 0 mm to 10 mm, the ambient temperature at thermal equilibrium decreases linearly from 29.8° C. (85.6° F.) to 6.7° C. (44° F.) for the same skin temperature of 93° F. (i.e., even at 6.7° C., the human body would feel like 30° C. due to the metabolic skin heat generation combined with the 10 mm thick insulation of expanded layer). Thus, the wearer of the thermally adaptive textile (TAT), with an intermediate layer thickness that expands to match the equilibrium level at each temperature, would feel comfortable over this entire range of temperatures.

Negative CTE materials such as ZrW₂O₈ and ZrV₂O₇ type ceramics received much attention because they exhibited unnatural behavior of contracting when heated (e.g., −11 ppm/° K). For thermally adaptive textiles, a ductile material such as metallic alloys with negative CTE are required, not a brittle ceramic material with a negative CTE. According to the disclosed technology, uniaxially deformed Ni—Ti alloys exhibit large negative CTE values from −10 to −500 ppm/° K. The very large negative CTE appears to result from the gradient plastic deformation (such as a uniaxial deformation using wire drawing or swaging) which is augmented by flattening deformation (such as cold rolling or pressure compression deformation). Both the uniaxial deformation by wire drawing or swaging dies and the flattening deformation tend to deform the surface regions more than the interior, thus a gradient plastic deformation is applied, with a resultant distribution of phase transformation temperatures (such as the martensite or austenite start and finish phase transformation temperatures of Mₛ, M_{f}, Aₛ, A_{f}). These distributed phase transition temperatures induced by the non-uniform plastic deformation cause the phase-transition-induced volume change to be distributed over a desirably broad range of temperatures of e.g., 0 to 100° C. span, rather than somewhat abrupt phase transition typically seen in martensitic or reverse martensitic phase transformation within a narrow range of about 10-20° C. span. The undesirable hysteresis of dimensional change vs temperature typically observed in a martensitic phase transformation is also mostly alleviated by the gradient/distributed plastic deformation imparted by the disclosed technology.

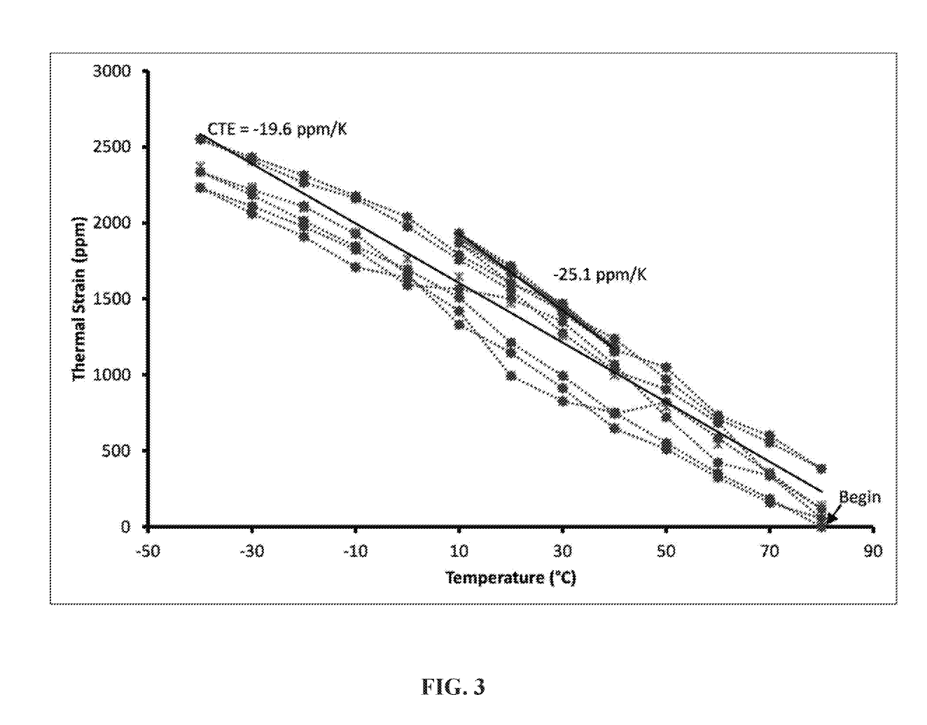

If the temperature excursion is limited within the linear regime of the negative CTE curve, the phase transformation can proceed by growth of existing phase regions, rather than the need to nucleate the new phase (need to overcome the energy barrier), thus minimizing the hysteresis. According to the disclosed technology, FIG. 3, a negative CTE of −20 to −30 ppm/° K over a fairly broad temperature range is obtained, with the essentially linear behavior often extending from 0° C. to 100° C., a typical temperature range for which a fabric/clothing will be subjected to during service and during washing/drying operations. A negative CTE as large as −80 ppm/K can be achieved for optimized processing and composition of this type of alloys.

### EXAMPLE 1

### Negative CTE Metal-Positive CTE Metal Composite

For adaptive textile shown in FIG. 1 and FIG. 2, the negative CTE alloy flattened ribbon (e.g., with a CTE=−25 ppm/° K) is paired with positive CTE metal such as stainless steel ribbon (CTE=+17 ppm/° K) by lamination, cold welding or other bonding means. See the curvature change experimentally measured and shown in FIG. 1(c). The negative CTE-positive CTE pair will introduce a desirable curvature when temperature is changed, thus making the dual pane textile housing the pair to be thicker when the temperature is cooled, or make it thinner when the temperature gets warmer, as illustrated in FIGS. 1 and 2. To fabricate the negative CTE component of the insert for thickness-changeable fabric, a Ni—Ti alloy ribbon was formed by using a nickel-titanium alloy wire containing nominally 56 weight percent nickel and 44 weight % Ti having an initial diameter of 120-750 μm. This was processed to produce a hysteresis-free negative CTE response of minus 20-minus 30 ppm/° K between room temperature and +100° C. A repetitive wire drawing of about 50-90% of initial cross-sectional area followed by repetitive rolling to between 5-30% of initial diameter was employed to produce the alloy in the desired ribbon geometry. Thermal cycling in the 10-40° C. range appears repeatable with essentially identical slope of negative CTE maintained as shown in FIG. 3. No substantial hysteresis was observed, which is highly desirable for long term reliable usage. This use of gradient or non-uniform plastic deformation (and resultant gradient phase transformation temperature) allows one to overcome the common issue of hysteresis in phase transformation and associated uncontrollable volume change for repeated and reproducible use.

To produce an effective dimension-changeable smart fabrics, it is useful that i) the two layers comprising the temperature responsive bilayer ribbon possess i) as large a CTE difference between the two layers as possible, ii) the two layers need to be very closely and tightly coupled with strong adhesion, iii) any bonding or adhesive layer utilized between the two layers need to be as thin as possible to minimize interference or undesirable creep effect, and iv) the assembled bilayer is resistant to mechanical fracture or fatigue failure along the length or interfacial delamination type failures, or resistant to creep-induced deterioration in the extent or behavior of the temperature-induced dimension changes.

The CTE difference between the two layers is at least 10 ppm/K, preferably at least 25 ppm/K, even more preferably at least 50 ppm/K. While it is preferred to employ a negative CTE material in order to achieve a large CTE difference in the two layer composite, a near zero or small CTE metal or polymer ribbon material can also be utilized for efficient dimension-changeable smart fabric, as will be described later.

The coupling between the two layers is preferably provided for as much contact area as possible, with the closely coupled area (physically bonded area) being at least 60% of the total theoretical interfacial area, preferably at least 80%, even more preferably at least 95% of the total interface area.

The desirable thickness of the polymer adhesive film between the two layers is at most 100 um, preferably less than 20 um, even more preferably less than 5 um. Also in the case of solder or braze adhesion bonding layer, the desirable thickness of the bond layer is also at most 100 um, preferably less than 20 um, even more preferably less than 5 um.

It is advantageous to have mechanical durability and robustness of the elastic bending behavior during repeated temperature cycling, so that the decrease of the bending amplitude upon repeated cycling is limited to less than 10%, preferably less than 30% for at least 10 cycles, preferably at least 100 cycles, even more preferably at least 1,000 cycles of temperature cycle over 30° C. temperature span.

The two layer composite material can be made of metal-metal combination, metal-polymer combination, metal-composite combination or polymer-polymer combination. The composite layer can be made of metal-carbon composite, metal-ceramic composite, metal-glass fiber composite, or polymer-ceramic composite.

For validating a further reduction to practice of the FIG. 1 and FIG. 2 approaches, the following additional experimental demonstration were carried out.

### EXAMPLE 2

### Near-Zero CTE-Positive CTE Temperature Responsive Bilayers

Thermally actuated bilayer beams consisting of a positive coefficient of thermal expansion part and a near-zero coefficient of thermal expansion part have been experimentally reduced to practice within a range of parameters including material compositions, material processing techniques, thicknesses, bonding materials, beam lengths, assembly processes outlined as follows.

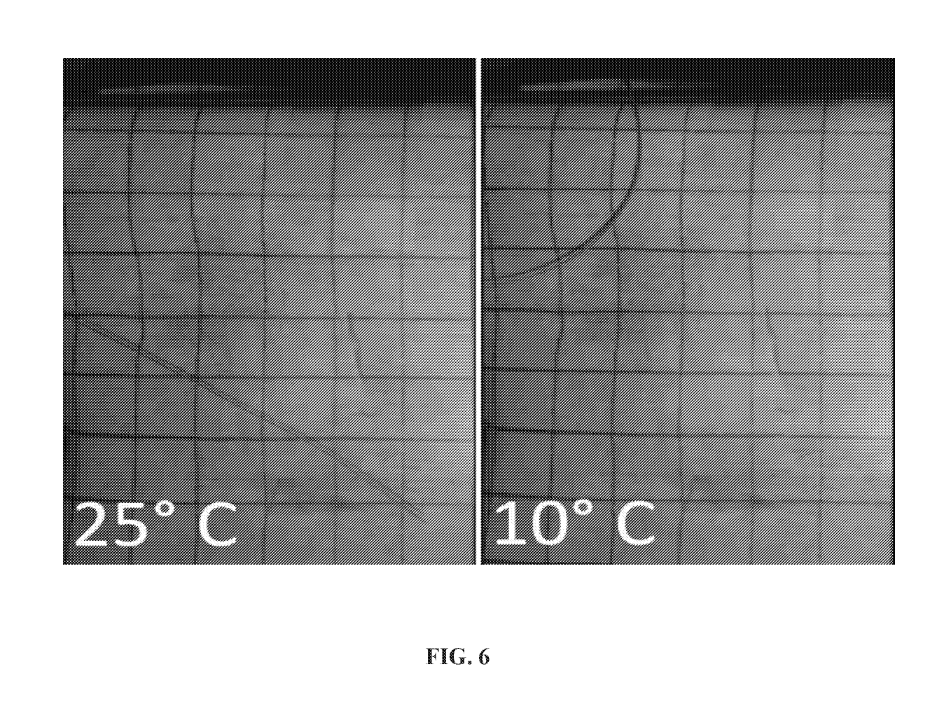

The near-zero CTE material consists of Invar nickel-iron alloy foil containing nominally 36 weight percent nickel with an initial thickness of 20-40 μm and CTE of 0.5-2.5 ppm/K. Positive CTE layer to be paired with near-zero CTE layer can be metallic ribbon such as aluminum alloys or austenitic stainless steel such as 304 stainless steel, or can be a polymer layer. One example metallic positive CTE material selected to construct a temperature responsive structure for thermally adaptive textiles was aluminum alloy 1100 foils with initial thicknesses between 10-50 μm and CTE of 21-23 ppm/K. The structure responded well to the temperature change, exhibiting substantial dimension change as shown in FIG. 6, and a dual pane fabric containing the bilayer changed thickness accordingly altered as exhibiting desired temperature responsive thickness changes.

These Invar ribbon-aluminum alloy ribbon were joined into a bilayer structure. The surfaces were cleaned first by optional but preferable plasma cleaning for activation of joining surfaces, which enables a strong coupling of the two layers. This is followed by the application of a low-viscosity adhesive to one or both joining surfaces. Layers were joined and passed through a rolling mill during room temperature curing to promote tight adhesion and a cold welding or to enable a use of a minimally thin adhesion layer. This is to ensure a minimally thin adhesion layer, as a thicker bonding layer tends to introduce undesirable thermal expansion behavior by itself and interferes with a desirable bilayer behavior. A thinner interfacial bonding film is also desirable for maximizing the bending performance. The desirable thickness of the adhesive layer is at most 100 um, preferably less than 20 um, even more preferably less than 5 um.

Alternatively, all-metal structures were joined either by cold welding through plastic deformation (such as through cold rolling by at least 20% reduction in cross-sectional area), spot welding at multiple locations, or by a solder or brazing thin layer applied between the near-zero CTE and positive CTE layers and heating to bond. Following joining, the layers were sectioned into strips 0.5-5 mm in width and 2.5-10 cm in length. In the case of solder or brazing bonding, a too thick bond layer tends to interfere with a desirable bilayer behavior. Therefore, the desirable thickness of the metallic bond layer utilized is at most 100 um, preferably less than 20 um, even more preferably less than 5 um.

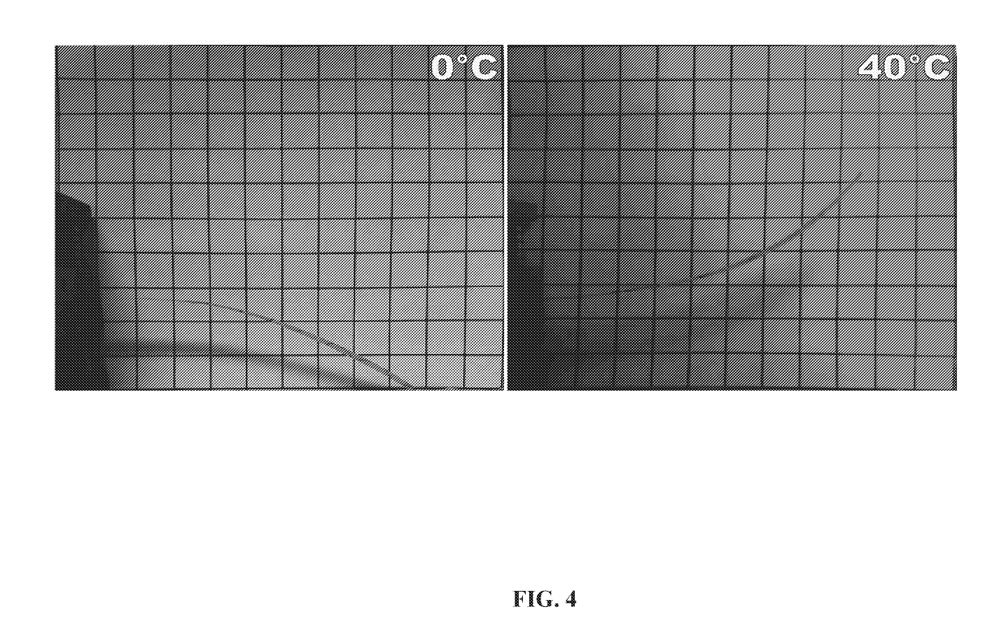

FIG. 4 shows one representative example of a thermally responsive bilayer consisting of a near-zero CTE Invar 36 (Fe-36 wt % Ni alloy, with a 25 μm thickness) and positive CTE aluminum alloy 1100 (Al base alloy with less than 1% Fe, with a 25 μm thickness) joined by a low-viscosity adhesive and passed through a rolling mill during curing. The grid size in the figure is 1 cm per division. At 0° C. the bilayer exhibits a significant dimension change on temperature change, curving downward 3 cm over a 10 cm length, which is a very impressive bending performance. At 40° C. the bilayer curves upward a much as 4 cm. For thermal management of apparels, thickening or thinning by this level of magnitude can be quite effective.

### EXAMPLE 3

### All-Metal Positive CTE Mismatch Temperature-Responsive Bilayers

All-metal thermally actuated bilayer beams consisting of a positive low-CTE part and a positive high-CTE part have been experimentally reduced to practice within a range of parameters including material compositions, material processing techniques, thicknesses, bonding materials, beam lengths, assembly processes outlined as follows.

The low-CTE materials consist of ferritic stainless steel 410 alloy foils with CTE of 9-11 ppm/K or low-carbon steel foils with CTE of 10-13 ppm/K Low-CTE foils had an initial thickness of 20-50 μm. Other low CTE materials, e.g., with a CTE value of less than 10 ppm/K, preferably less than 6 ppm/K can be utilized. For example, such low CTE alloys can be selected from refractory metals/alloy type materials such as Mo (CTE=4.9 ppm/K), Nb (CTE=7.31 ppm/K), W (CTE=4.6 ppm/K), Ta (CTE=6.5 ppm/K), Zr (CTE=5.85 ppm/K), Hf (CTE=5.90 ppm/K), Re (CTE=6.70 ppm/K), etc. and their alloys. The mating, high-CTE material can be selected from metals or alloys with a high positive CTE such as Al alloys (CTE=23.6 ppm/K), Mg alloys (CTE=27.1 ppm/K), Cu alloys (CTE=16.5 ppm/° C.K), austenitic 304 type stainless steel (CTE=16.5 ppm/K). It is preferred that these alloy strips are work hardened (e.g., by cold rolling) or precipitation hardening aged without much sacrifice to their CTE values to increase the mechanical strength and elastic stiffness to provide enhanced mechanical robustness and reliability over long time thermal and strain cycling during use as a part of smart textiles. Creep deformation of the curved bilayer is undesirable as the obtained dimensional change of textiles will be gradually reduced. According to the invention, the metals or alloys utilized for the bilayer formation are preferably plastically deformed for higher strength prior to the bilayer construction, such as by using wire drawing or cold rolling, so as to make the yield strength to be increased by at least 30%, preferably at least 100% as compared to the metals or alloys without plastic deformation. Alternatively, the metals or alloys for the bilayer can be strengthened by utilizing precipitation hardening, so as to make the yield strength to be increased by at least 30%, preferably at least 100% as compared to the metals or alloys without precipitation hardening.

The high-CTE materials were selected from aluminum alloy 1100 foils with initial thicknesses between 10-50 μm.

Bilayers were joined by optional but preferable plasma cleaning which enables a strong bonding of two layers and activation of joining surfaces followed by the application of a low-viscosity adhesive polymer layer to one or both joining surfaces. Layers were joined and passed through a rolling mill during room temperature curing to promote tight adhesion and a minimally thin adhesion layer. This is to ensure to minimize the adhesion layer thickness, as a thicker bonding layer tends to introduce undesirable thermal expansion behavior by itself and interferes with a desirable bilayer behavior. The desirable thickness of the polymer adhesive layer is at most 100 um, preferably less than 20 um, even more preferably less than 5 um.

Alternatively, all-metal structures were joined either by cold welding through plastic deformation (such as through cold rolling by at least 20% reduction in cross-sectional area), spot welding at multiple locations, spot welding at multiple locations along the length of the ribbon, or by a solder or brazing thin layer applied between the low-CTE and high-CTE layers and heating to bond. Following joining layers were sectioned into strips 0.5-5 mm in width and 4-10 cm in length. In the case of solder or brazing bonding, a too thick bond layer tends to interfere with a desirable bilayer behavior. Therefore, the desirable thickness of the metallic bond layer is at most 100 um, preferably less than 20 um, even more preferably less than 5 um.

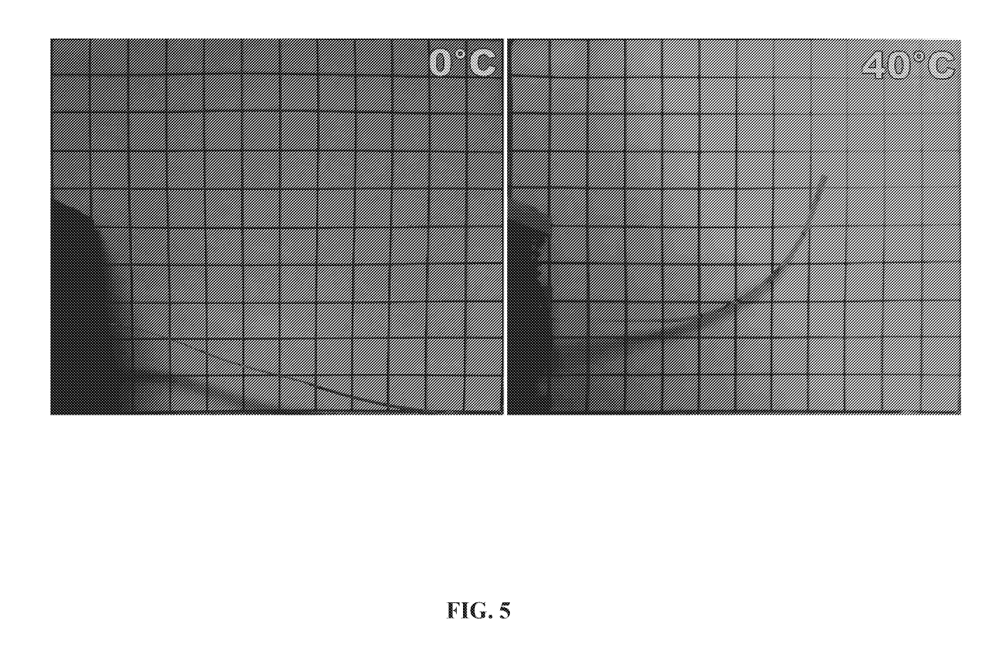

FIG. 5 presents one representative example of an all-metal thermally responsive bilayer consisting of a low-CTE low-carbon steel foil (25 μm thick) and high-CTE aluminum alloy 1100 (25 μm thick) joined by a low-viscosity adhesive and passed through a rolling mill during curing. At 0° C. the bilayer has little curvature. At 40° C. the bilayer curves upward as much as 4 cm over its 10 cm length. Dual-pane fabrics that can be thickened or thinned by this level of magnitude can be quite useful for thermal management of apparels.

The flat ribbon configuration allows it to be physically in close contact with a flat positive CTE material ribbon. The flat positive CTE ribbon can be a metallic alloy ribbon (such as 304 stainless steel ribbon) or a positive polymer ribbon (such as cellulose acetate, acrylate polymer, or polyester) or a positive composite ribbon material (such as polymer-metal or polymer-glass fiber layer).

A-2. Metal-Polymer-Coupled, Layer Structured Temperature-Responsive Composite Materials.

### EXAMPLE 4

### Negative CTE Metal-Positive CTE Polymer Combination Ribbon

Thermally actuated bilayer beams consisting of a metallic negative coefficient of thermal expansion (CTE) layer paired with a polymer based positive CTE layer have been constructed experimentally as a reduction to practice within a range of parameters including material compositions, material processing techniques, thicknesses, bonding materials, beam lengths, assembly processes outlined as follows.

To fabricate the negative CTE component of the insert for thickness-changeable fabric, a Ni—Ti alloy ribbon was formed by using a nickel-titanium alloy wire containing nominally 56 weight percent nickel and 44 weight % Ti having an initial diameter of 120-750 μm. This was uniaxially plastically deformed and cold rolled to produce an essentially hysteresis-free negative CTE response of minus 20-25 ppm/° C. between room temperature and +100° C. A repetitive wire drawing of about 50-90% of initial cross-sectional area followed by repetitive rolling to between 5-30% of initial diameter were utilized to produce the alloy in the desired ribbon geometry.

The positive CTE component of the bilayer was selected to be a positive CTE cellulose acetate ribbon (˜80 μm thickness) which was joined by a sprayable adhesive and cured in a pre-flexed state. At 25° C. the bilayer is straight with little curvature. At 10° C. the bilayer achieves a significant bending with a radius of curvature of approximately 2 cm. This level of dimensional change in double-pane textiles can be quite effective way of altering thermal insulation.

Bilayers were joined by optional but preferable plasma cleaning of both the metallic layer surface and the polymer layer surface for activation of joining surfaces, which enables a strong coupling of the two layers. If a strong coupling of the two layers is not ensured, delamination or irregular deformation can occur during the temperature changes or thermal cycling service environment. The surface cleaning is followed by the application of a low-viscosity adhesive to one or both joining surfaces. Layers were joined and then either held flat or at a predetermined curvature during curing at room or elevated temperature. Alternatively, layers were joined and passed through a rolling mill during room temperature curing to promote tight adhesion and a minimally thin adhesion layer. This is to ensure a thin adhesion layer, as a thicker bonding layer tends to introduce undesirable thermal expansion behavior by itself and interferes with the desirable bilayer behavior, and can contribute to undesirable creep and loss of dimension change during temperature change. The desirable thickness of the adhesive layer between the metallic layer and the polymer layer is at most 100 um, preferably less than 20 um, even more preferably less than 5 um.

The data in FIG. 6 presents one representative example of a thermally responsive bilayer consisting of a negative CTE nitinol (125 μm diameter drawn to 100 μm and rolled to 35 μm) and positive CTE cellulose acetate (˜80 μm having a CTE of ˜130 ppm/K) joined by a sprayable adhesive and cured in a pre-flexed state. At 25° C. the bilayer is straight with little curvature. At 10° C. the bilayer achieves a significant bending with a radius of curvature of approximately 2 cm. When placed between two fabrics, the dual-pane composite structure comprising an array of 4 paired ribbon structures exhibited an increased dual-pane fabric thickness of at least 1 cm upon environmental temperature cooling of 10° C. A reverse temperature change of environmental temperature heating by the same temperature span 10° C. caused the dual pane thickness to return to the original thickness by decrease of the fabric thickness by identical >1 cm.

### EXAMPLE 5

### Another Example of Negative CTE Metal-Positive CTE Polymer Combination Ribbon

Alternatively, the temperature responsive fabric was produced with negative CTE Ni—Ti ribbon and positive CTE acrylonitrile butadiene styrene (ABS) films with CTE of 70-80 ppm/K, with the ABS polymer layer thicknesses varied between 75-250 μm and sectioned into strips with width between 1-5 mm and lengths of 1-15 cm. The paired Ni—Ti and ABS layer exhibited large curvature behavior on temperature change, and a change in the thickness of dual pane fabric, similarly as for the case of cellulose acetate based paired layer.

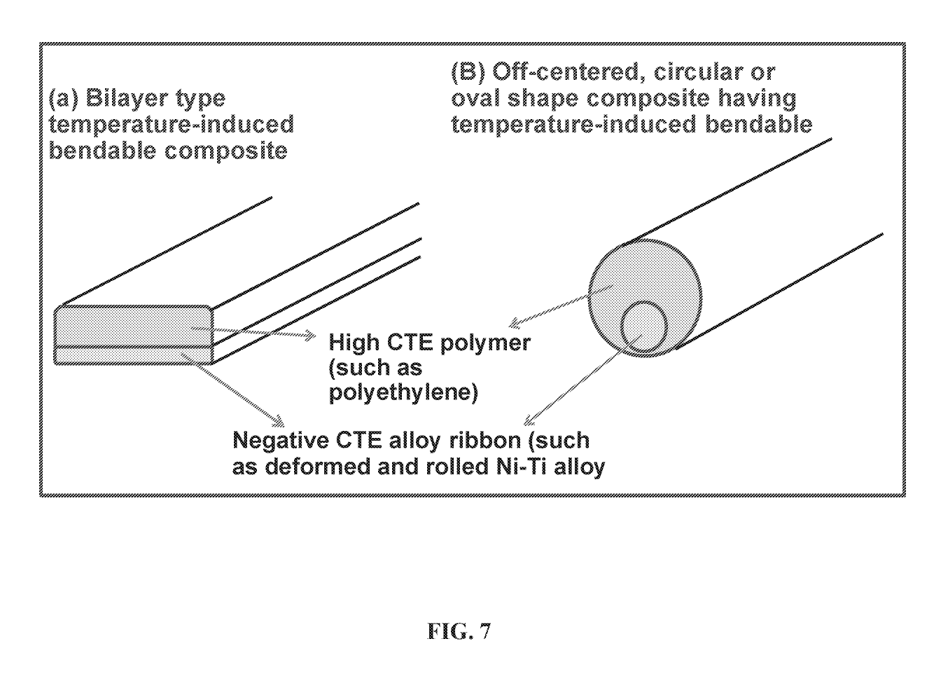

Schematically shown in FIG. 7 are example embodiments of a metal-metal, metal-polymer, polymer-polymer, polymer-reinforced-composite bilayer composite. The configuration in FIG. 7(a) is a ribbon-shaped composite structure while the FIG. 7(b) composite structure represents a different geometry of embedded composite with fiber-shaped geometry, capable of large bending and associated thickness change of dual-pane fabric when used as an insert array structure. The FIG. 7(b) configuration can be used for metal-metal combination, metal-polymer combination or polymer-polymer combination. In the bilayer structure of FIG. 7(a), an additional thin polymer layer can optionally be added to the underneath of the Ni—Ti type negative CTE metal alloy ribbon for protection if desired (to minimize the physical contact of metal to the human skin). The off-centered configuration in FIG. 7(b) is essential for introducing the bending and geometry change. When inserted as filaments or as a part of short length fabrics, the CTE-induced dimensional change will make the fiber wrinkle so as to increase the thickness of the dual pane fabric and enhance the thermal insulation. The fiber shape composite material in FIG. 7(b) provides the following structural characteristics as an insert layer that causes the thickness of the intra-layer gap to change due to changes in the ambient temperature;

With a repeatable shape memory structure that wrinkles on temperature change, with reproducible thermal cycling behavior,

With the shape memory structure comprising an array of circular shaped, oval shaped, trilobal shaped, ribbon shaped or random shaped fibers or partially flattened fibers with an off-centered relative arrangement of the two elongated materials having substantially different coefficient of thermal expansion,

With the two types of materials having a structure comprising metal-metal, metal polymer, polymer-polymer, or polymer-composite combination,

With the dimension of the overall diameter or equivalent diameter being in the range of 5-5,000 um, preferably 20-1,000 um, even more preferably 50-500 um, with the fiber wrinkling causing dimensional change along the thickness direction to cause the dual pane fabric thickness to expand and increase thermal insulation,

With the thickness change of dual-pane fabric being at least 1 mm, preferably at least 5 mm over a temperature change of 10° C.

### EXAMPLE 6

### Construction of CTE Mismatch, Thickness-Changeable, Temperature-Responsive Smart Fabric

Any of the thermally actuated bilayers from the previous experimental examples can be used to construct thickness-changeable smart fabrics which adaptively alter textile insulation in response to environmental changes. Such fabrics have been reduced to practice with negative CTE-positive CTE temperature-responsive bilayers, near-zero CTE-positive CTE temperature-responsive bilayers, all-metal positive CTE mismatch temperature-responsive bilayers, and all-polymer positive CTE mismatch temperature-responsive bilayers, with the cooler feeling effect or warming feeling effect, respectively, demonstrated on environmental temperature rise or decrease.

Thermally responsive insert structures were formed by assembling bilayers into bow structures which are hinged at each end such that the contact points with the upper and lower textiles may be vertically aligned. By including multiple bow structures rotated about the axis of vertical alignment, the structure may be prevented from possibly tipping over when expanded. For application as an interlayer the half-length may be tailored to produce the required out of plane deflection. Star and X insert structures were inserted between textiles of e.g., nylon, cotton, wool, acrylic, rayon, polyester, polypropylene, and spandex by affixing the upper and lower contact points to the fabric by adhesive or stitching such that the interlayer would expand with decreasing temperature to prevent (or minimize) heat transfer through the smart fabric.

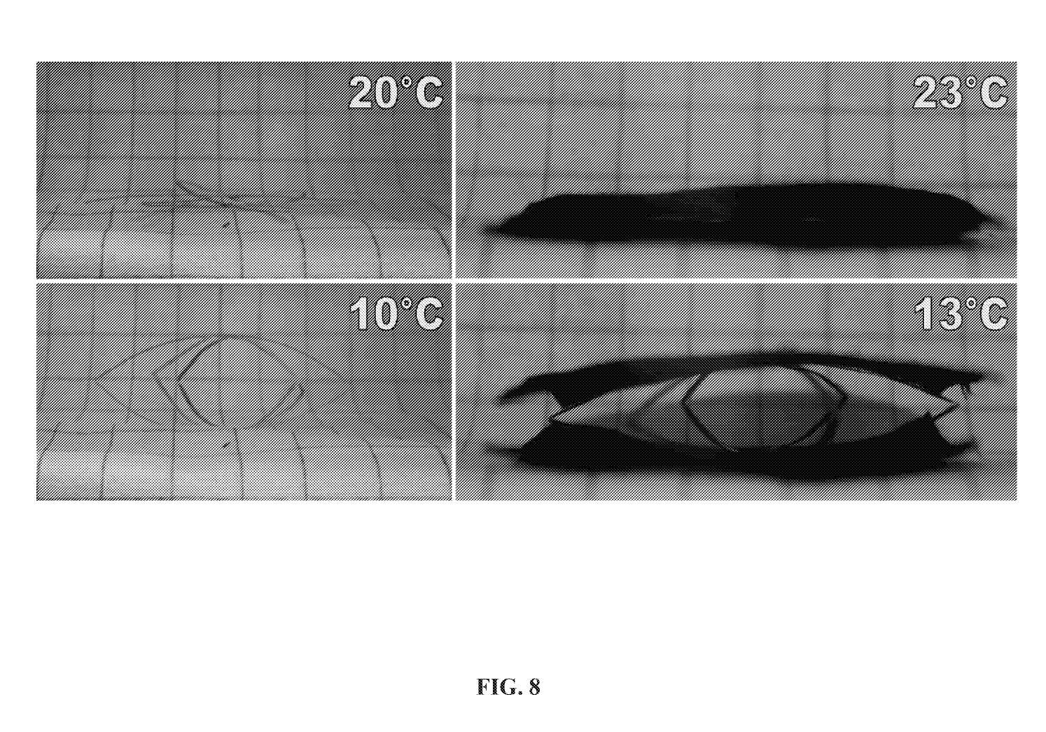

FIG. 8 presents one representative example of a temperature-responsive thickness-changeable smart fabric consisting of a star-structure insert constructed from a CTE mismatched bilayer composite consisting negative CTE Ni—Ti alloy ribbon (125 μm wire rawn to 100 μm and rolled to 35 μm thickness) and positive CTE cellulose acetate (˜80 μm) joined by a sprayable adhesive and cured in a pre-flexed state. The temperature responsive star structure is inserted between two textiles consisting of woven 65% polyester and 35% cotton and attached by a low viscosity adhesive at the lowermost and topmost points. As the temperature decreases, the thermally adaptive interlayer expands, increasing the overall insulation of the textile. These star-structured insert made of CTE mismatched bilayer composite material represents a “Shape-Memory Structure” which exhibits very reproducible expansion and contraction behavior. According to the invention, the desirable degree of thickness expansion or contraction in the “Shape-Memory Structure” is typically more than 0.2 cm height change for 10 cm length leg horizontal dimension of the structure (equivalent to 2% height change relative to the horizontal length dimension) when the environment temperature is altered by 10° C. Therefore, the disclosed “Shape-Memory Structure” exhibits a ratio of vertical height change to the horizontal dimension, of at least 2%, preferably at least 5%, even more preferably at least 10% per 10° C. temperature change.

The insulative behavior of the structure was evaluated using a guarded hot plate technique and a larger 10 cm×10 cm area thickness-changeable temperature-responsive smart fabric with a woven 65% polyester and 35% cotton lower layer and a 100% polyester upper layer. Insert structures consisted of Invar 36—Aluminum Alloy 1100 bilayers. Temperature was monitored by thermocouple sensors positioned underneath the sample and above the sample in the convection chamber. Hotplate was powered at 1.6 watt for the duration of all testing to maintain a constant temperature environment. To prevent excessive heat loss through the sides and bottom of the setup, the insulated hotplate was seated in additional foam insulation and suspended within the convection oven chamber.

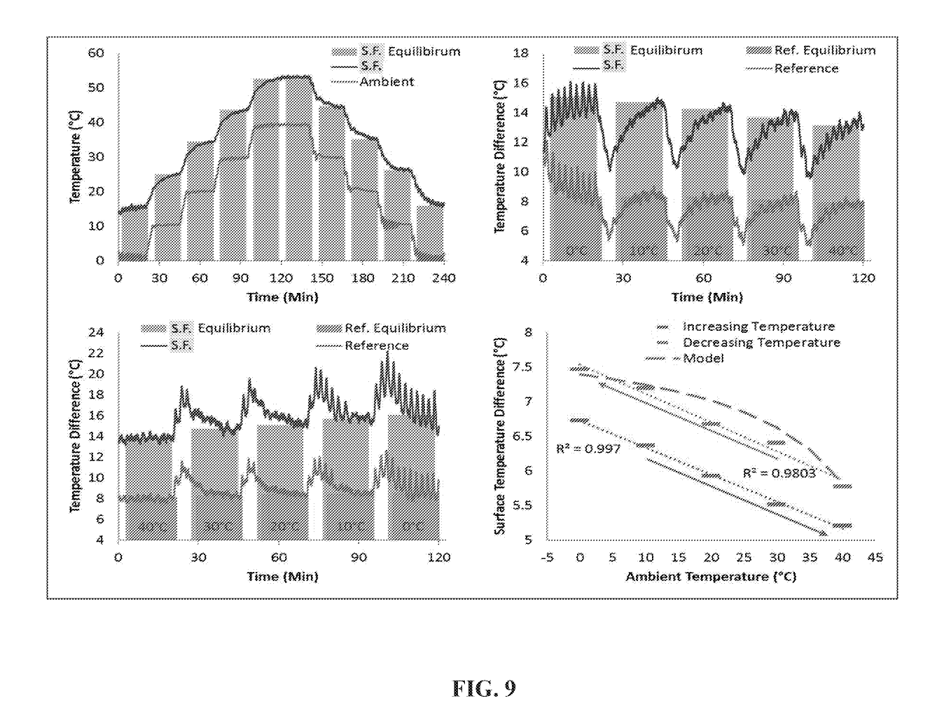

Ambient and bottom surface temperature was monitored as chamber temperature was increased from 0° C. to 40° C. (10° C. steps, 5 min ramps, 20 min holds) and decreased similarly. As presented in FIG. 9, the thickness-changeable smart fabric structure provided an adaptive insulation with the difference between adaptive fabric and an un-adaptive flat reference sample approaching 2° C. over the 0-40° C. test, both in the increasing and decreasing directions. This data indicates that the adaptive air layer introduced by the smart fabric provides for increased or decreased heat transfer as a function of thickness. As the temperature increases and the interlayer collapses, the difference between the thickness-changeable smart fabric and the totally flat reference sample trends towards zero. Conversely, as the temperature decreases and the insulative layer expands the difference increases as expected.

A-3. Polymer-Polymer-Coupled, Layer Structured Composite Materials.

The temperature responsive thickness-changeable smart fabric structure can also be constructed as an all-polymer structure, i.e., by using a combination of low CTE polymer-high CTE polymer layers. The use of polymer based structures is convenient in some sense as the ordinary fabrics themselves are usually made of polymer material which is soft and pliable. Accordingly some all-polymer based structures were constructed using a low CTE polymer such as polyimide and a high CTE polymer such as cellulose acetate. However, such polymer based bilayer, when curvatured by temperature activation and CTE mismatch induced bending stress, the curvature so obtained did not have the desirable robustness because of the time-dependent creep. See Example 7 below.

### EXAMPLE 7

### All-Polymer, CTE Mismatch Temperature-Responsive Bilayers Which Exhibited Undesirable Creep Behavior

The polymer-polymer crossing beam X-structure consisted of bilayer ribbons of Kapton polyimide (60 um thick, 2.5 GPa modulus, CTE=˜20 ppm/K) and cellulose acetate (100 um, 1.1 GPa modulus, CTE=˜130 ppm/K). Bilayers were made by adhering Kapton polyimide tape with one-sided pressure-sensitive adhesive (PSA) to cellulose acetate film and repetitively passing through a rolling mill to apply pressure. Bilayers were then assembled into a bow-structure such that the cellulose acetate side faced inward and the Kapton side outward with joining at the beam ends. Two bow structures were then joined at the uppermost and lower most point of the bows to create the X-structure. The structures temperature response is on the order of 1 mm/K overall thickness change but the separating force is over an order of magnitude less than the metal-metal version, with an observation of just 10 mN force fully collapsing the expanded X-structure. Furthermore, even as the structure is left alone, the structure rapidly collapses with time by creep, going from an expanded state at ambient temperature to totally collapsed flat state within an hour.

A-4. Creep-Resistant, Dispersoid Hardened Polymer Layers for Robust Thermally Dimension Changeable and Thermally Adaptive Fabrics

One of the serious disadvantages of the polymer-based bilayers is that they tend to creep under stressed condition to lose the intended, programmed dimensional changes. As internal stress accumulation in the bilayer structures is often required to make the structure curve up or down to change fabric or apparel dimensions and make the wearer to feel cooler or warmer, it is highly desirable and essential to make the bilayer configuration resistant to creep and lose a part or all of the intended dimensional changes.

Therefore various embodiments utilize selective high strength polymers with desirable low CTE and high CTE to form a creep resistant thermally adaptive textiles. An example high strength polymer with a low-CTE is 50 um thick PEEK (polyethyl ether keytone with CTE of 25 ppm/K if reinforced with 30% of glass or carbon fiber) and an example high strength polymer with high CTE is UHMWPE (ultra high molecular weight polyethylene layer with a CTE value of 200 ppm/K), which can be bonded with a thin adhesive layer. As higher strength and higher stiffness polymer is essential for creep resistance, the desirable mechanical property in terms of elastic modulus for either bilayer material is at least 0.2 GPa, preferably at least 0.6 GPa, even more preferably at least 1 GPa.

This document also discloses additional structures and methods to impart creep-resistant characteristics to any polymer materials to convert them into creep resistant and robust polymer bilayer or trilayer materials as described below. The assembled structures and fabrication techniques are also disclosed.

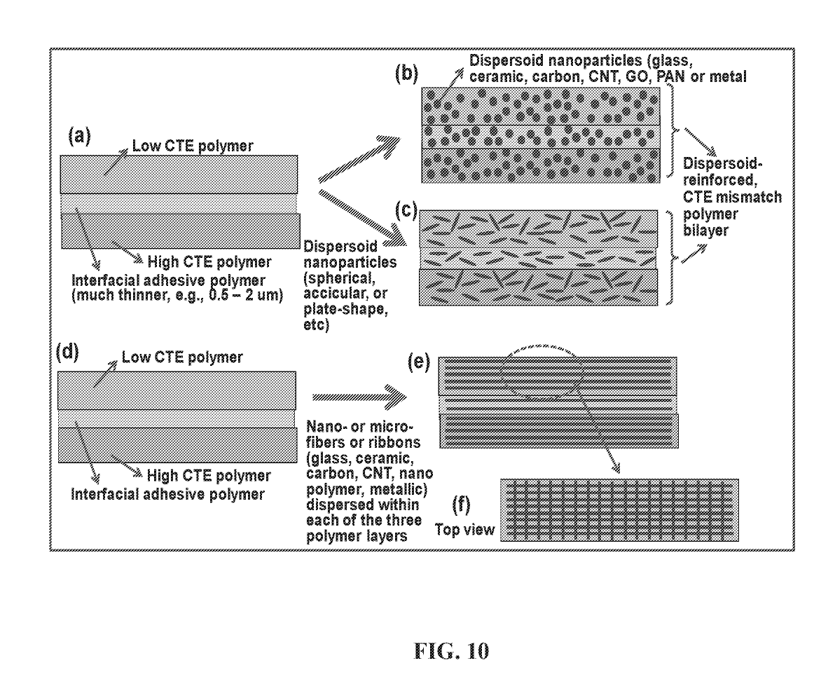

Several different approaches have been employed to impart creep-resistant properties to the polymer layers, as described in FIG. 10.

As described in FIG. 10, the polymer layers, including the low CTE layer, paired high CTE layer, as well as the interface bonding layer polymer are all mechanically strengthened so as to minimize the creep deformation and loss of intended dimensional change. Shown in FIG. 10(a) is a schematic cross-sectional view of CTE-mismatch polymer bilayer (the adhesive middle layer is very thin), while FIG. 10(b) and FIG. 10(c) represent cross-sectional views of dispersoid strengthened polymer bilayer. The dispersoid particles to be inserted to the polymer material (e.g., by introducing spherical, flake-shape or acicular shaped ceramic nanoparticles or microp (such as alumina, silica, titania, Fe-oxide, etc), metallic particles (such as Ag, W, Ni, Co), or high strength polymer chopped fibers (such as drawn and aligned polymers of nylon, Kevlar, or other high strength materials (such as carbon nanotube, graphene oxide, graphene, boron nitride, etc). The desired volume fraction of the dispersoid particles or fibers is in the range of 0.1-10 vol %, preferably 0.2-5 vol %, even more preferably 0.5-2 vol %.

It is desirable and important to have the interface adhesive layer also strengthened since the adhesive polymer, if not strengthened, will be the weak link cansuing the undesirable relaxation of the accumulated stress needed to be maintained for dimensional changes of the smart fabrics.

The schematics in FIG. 10(d)-(f) illustrates a different approach of polymer strengthening using fibrous or woven fiber type dispersoid. High strength and high modulus fibers such as carbon nanotubes (CNTs), graphene nanoribbons, woven glass fibers, metallic fibers, electrospun polyacrylonitrile (PAN) nanofibers, superdrawn ultrahigh molecular weight (UHMW) PAN microfiber, electrosprayed nylon fibers (aligned polymer molecules) and other materials with similar geometry can be utilized. The desired volume fraction of the inserted fibers is in the range of 0.2-20 vol %, preferably 0.5-10 vol %, even more preferably 1-5 vol %.

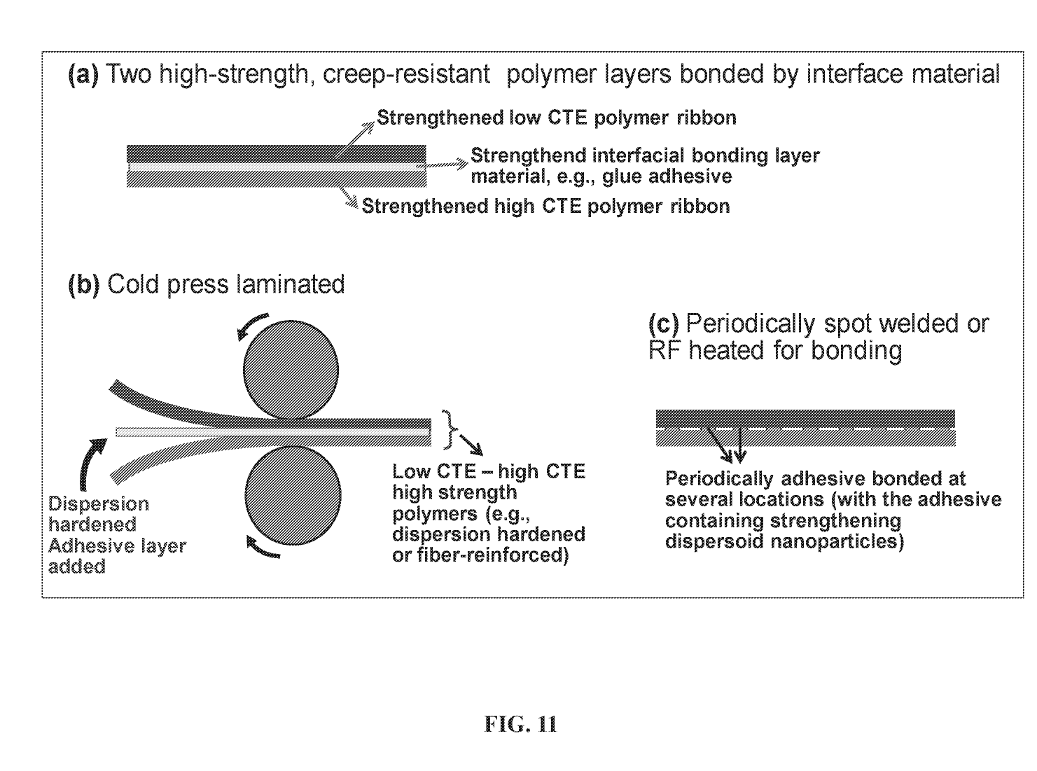

Shown in FIG. 11 are some exemplary methods of attaching a low CTE layer and a high CTE layer to form a temperature-responsive, mechanically reinforced bilayer for creep-resistance dimension-change performance. A bonding approach using an interfacial layer is shown in FIG. 11(a), while bonding via cold press lamination (or warm press lamination if adhesive curing is also obtained) is illustrated in FIG. 11(b). A bonding approach using periodic spot glueing and spreading to increase the contact area is described in FIG. 11(c).

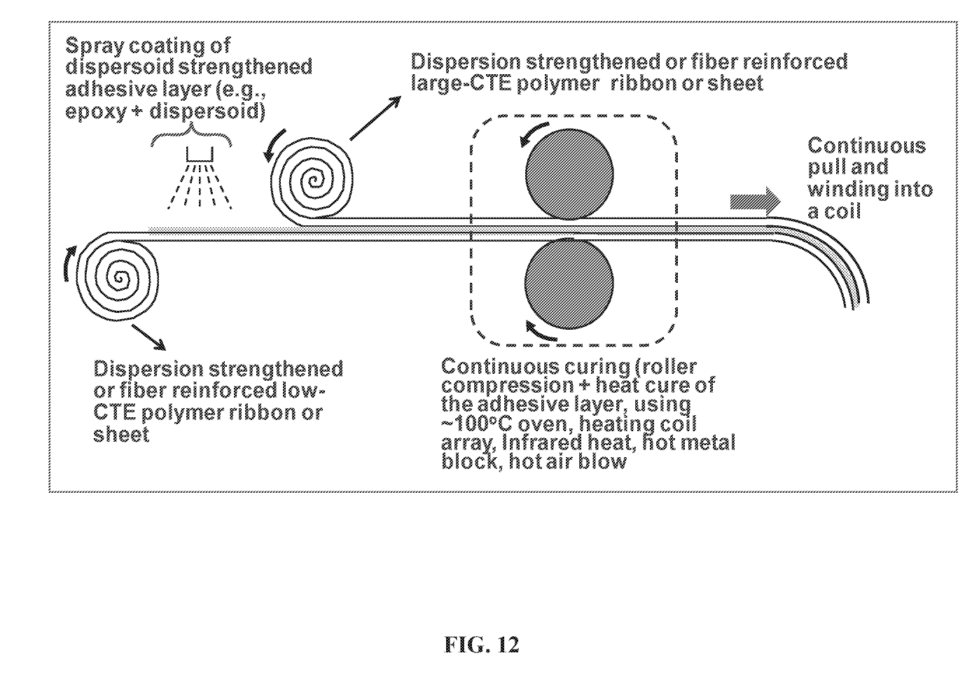

Described in FIG. 12 is an exemplary method for lamination of dispersion strengthened or fiber-reinforced, low CTE layer and high CTE layer bilayer to produce an insert material for temperature-responsive thickness changeable or flap-openable textiles. The laminated structure with adhesive bonding material at the interface is roller compression pressed for good adhesion. This method is advantageous as this can be made into a continuous manufacturing technique. The initial curvature need to be set so that the temperature to start with a flat (thinnest and least thermal insulation in the dual pane fabric) can be pre-decided. The initial curvature of the bilayer can be set by strain training, e.g., reheating to a desired temperature under bending stress, so that the bilayer can return to the flat state or expanded state as the environmental temperature is altered.

### EXAMPLE 8

### All-Polymer Positive CTE Mismatch Temperature-Responsive Bilayers

All-polymer thermally actuated bilayer beams consisting of a positive low-CTE part and a positive high-CTE part have been experimentally reduced to practice within a range of parameters including material compositions, material processing techniques, thicknesses, bonding materials, beam lengths, assembly processes outlined as follows.

The positive low-CTE materials were selected from either Kapton polyimide with an initial thickness of 10-50 μm and CTE of 20-30 ppm/K or polyether ether ketone (PEEK) with an initial thickness of 50-75 μm and CTE of 45-55 ppm/K.

The higher positive CTE materials were selected from cellulose acetate films with thicknesses between 75-250 μm and CTE of 130 ppm/K; acrylonitrile butadiene styrene (ABS) films with thicknesses between 75-250 μm and CTE of 70-80 ppm/K; ultra-high-molecular-weight polyethylene (UHMWPE) with thicknesses between 100-150 μm and CTE of 160-220 ppm/K; polyoxymethylene (POM) with thicknesses between 75-125 μm and CTE 100-120 ppm/K; and fiber-reinforced high-density polyethylene (HDPE) with thickness of 100 μm and CTE 90-100 ppm/K.

PEEK and UHMWPE are joined by an acrylic adhesive which is first applied to the PEEK film by the manufacture and then applied immediately to the UHMWPE upon removal of the backing sheet. The bilayer is then repetitively passed through the rolling mill to promote tight adhesion. The adhesive layer thickness is estimated to be under 5 um following joining. PEEK material properties: Modulus is 4.0 GPa, CTE is 45 ppm/K, Tensile Yield Strength=98 MPa. UHMWPE material properties: Modulus is 0.69 GPa, CTE is 200 ppm/K, Tensile Yield Strength is 21 MPa. Cellulose Acetate material properties: Modulus is 1.6 GPa, CTE is 110 ppm/K. Tensile Yield Strength is 40 MPa.

Bilayers were joined by optional but preferable plasma cleaning and activation of joining surfaces followed by the application of a low-viscosity adhesive to one or both joining surfaces. Layers were joined and passed through a rolling mill during room temperature curing to promote tight adhesion and to ensure a minimally thin adhesion layer, as a thicker bonding layer tends to introduce undesirable thermal expansion behavior by itself interferes with a desirable bilayer behavior. Alternatively, layers were obtained with a pre-applied adhesive layer and were joined directly. Following joining layers were sectioned into strips 0.5-5 mm in width and 2.5-10 cm in length.

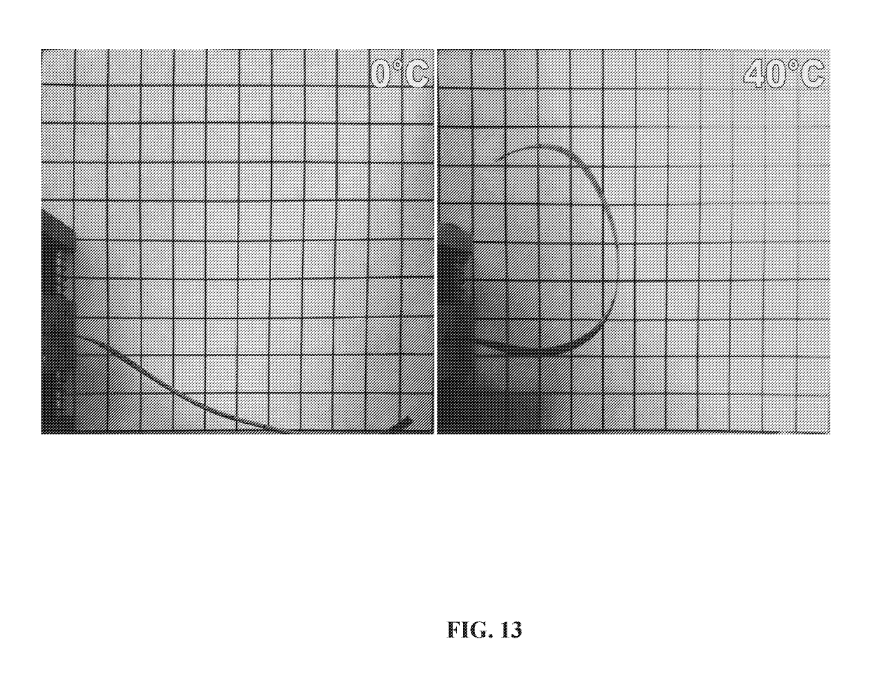

FIG. 13 presents one representative example of an all-polymer thermally responsive bilayer consisting of a low-CTE PEEK film (50 μm thick) with adhesive layer and high-CTE UHMWPE (125 μm thick) joined by direct pressure of the PEEK's adhesive face to the UHMWPE. At 0° C. the bilayer has little curvature. At 40° C. the bilayer achieves a radius of curvature of approximately 3 cm.

A-5. Assembly Methods for Thermally Adaptable Textile of Dual Pane Fabric Together with CTE Mismatched Bilayer Structure.

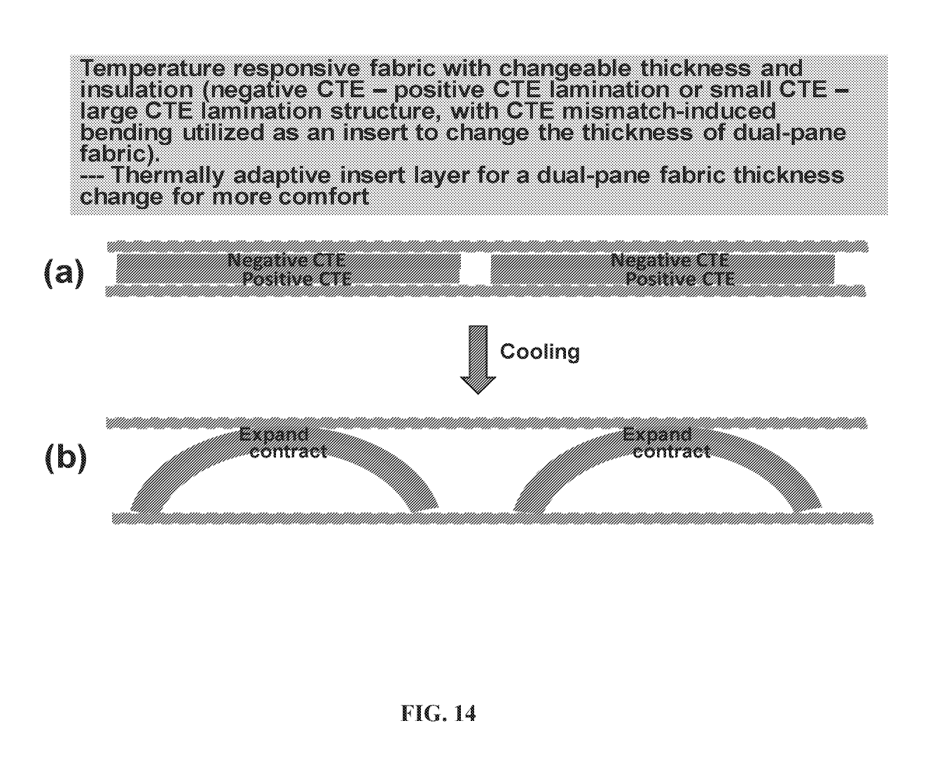

Several example embodiments of assembling dual-pane configured smart thermally adaptive textiles using the temperature-responsive composite structure as an insert are described below. Shown in FIG. 14 is one example of the structural designs and embodiments of thickness-changeable, thermally adaptive textile. The insert material in this example, is a bilayer composite made of negative CTE material (or low-CTE material) bonded unto a high-CTE material. As the ambient temperature is changed, the differential thermal expansion causes the two layers of the bilayer composite to expand or contract to a different degree, thus causing the composite layer to bend upward or downward. The insert array can be positioned horizontally as in this figure, or vertically or at any other angles. As the insert material is bent on lower temperature and flattens when the temperature gets warmer, the dual-pane fabric structure is then becoming thicker (more air and hence more insulation) if the ambient temperature gets cooler, and becoming thinner if the ambient temperature gets warmer.

Examples of negative CTE material include shape memory alloys processed into a gradient-transformation-temperature structure, alloys with their phase transition temperature (volume change temperature) adjusted so that the volume or length is reduced near room temperature. Shape memory polymers, or pre-strained polymers may also be structured to exhibit negative CTE. Examples of positive and high-CTE materials include polymer materials such as cellulose acetate, or metallic materials based on aluminum or magnesium alloys, austenitic stainless steel, or shape memory type alloys with the phase transition temperature adjusted so that the steep dimensional change with positive CTE occurs near room temperature.

For adaptive textile shown in FIG. 14 to FIG. 18, the negative CTE alloy wire (or flattened ribbon) can be paired with positive CTE metal such as stainless steel ribbon (CTE=+17 ppm/° C.) by lamination, cold welding or co-wire-drawing. Depending on which side (inside or outside) of the negative CTE metal is placed, the bilayer effect will introduce a desirable curvature when temperature is changed, e.g., making the dual pane textile to be thicker when the temperature is cooled, or make it thinner when the temperature gets warmer. While metal-based bilayer sheets or ribbons are viable materials for apparel thickness change, for some apparel applications, higher CTE mismatch is desirable so as to obtain more intensive bilayer deformation and bending for the purpose of enhanced thickness change of a dual-pane fabric. Thus in some embodiments, instead of metallic positive CTE material, polymer-based materials can be utilized as the latter exhibit much higher positive CTE, such as cellulose acetate, UHMWPE. Therefore, for bilayer construction for mechanical bending, a more preferred material is polymer based positive CTE material as illustrated in FIGS. 14-18. To minimize creep deformation and time-dependent loss of intended dimensional change, the lower CTE material can be strengthened, according to the invention, such as with a dispersion hardened polymer structure, glass-fiber or carbon-fiber reinforced polymer structure, mesh-inclusion-hardened polymer structure, with the base polymer selected from PBI (Polybenzimidazole), PAI (Polyamide-imide), PEI (Polyetherimide), mechanically stronger polymer such as PEEK (Polyetheretherketone), or glass-fiber-reinforced nylon or low CTE aromatic polyamide such as Kevlar or negative CTE Kevlar material. The higher CTE material can also be strengthened, according to the invention, such as with a dispersion hardened polymer structure of cellulose acetate, polyester, PB (Polybutylene), PE (Polyethylene), UHMWPE (ultra-high-molecular-weight polyethylene), PVDF (Polyviylidenefluoride), PTFE (Polytetrafluoroethylene), acrylic PMMA (Polymethyl methacrylate), spandex, orlon, rayon, or polycarbonate, so that the higher strength and stiffer polymer-polymer bilayer has reduced creep-induced loss of temperature induced dimension change. According to some embodiments, each of the two strengthened polymer material comprising the bilayer has a higher stiffness with the elastic modulus being at least 0.2 GPa, preferably at least 0.6 GPa, even more preferably at least 1 GPa, and the strength of the base polymer is made higher by at least 50%, preferably by at least 100%, more preferably by at least 200%.

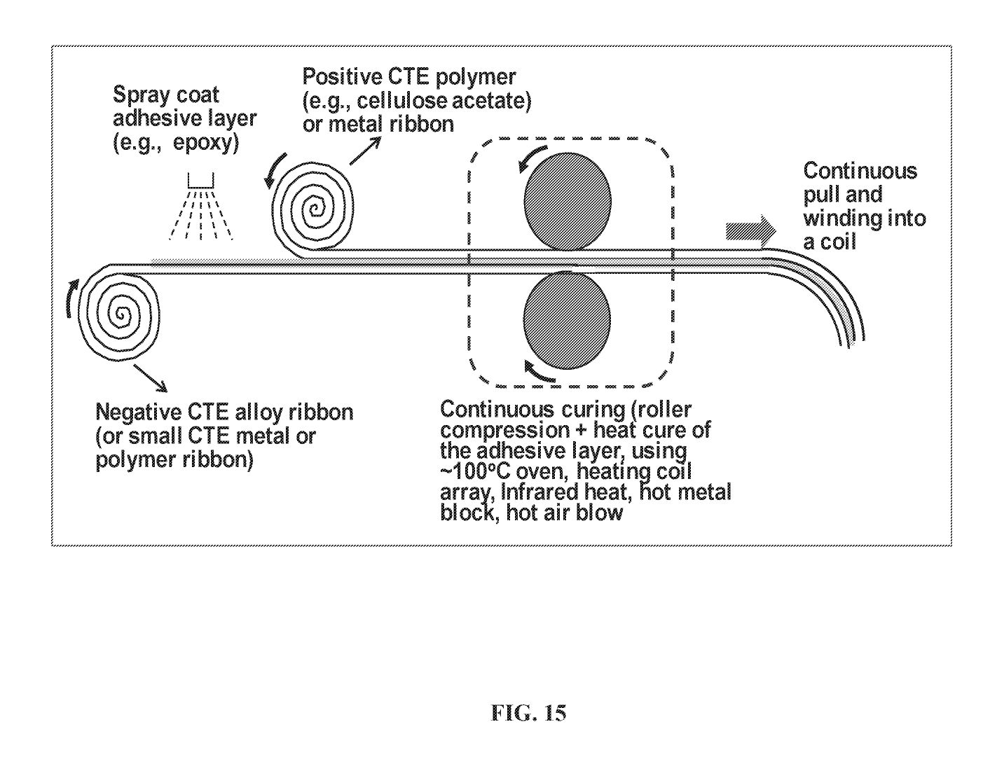

For large scale commercial applications, the lamination of the two components, (negative CTE layer and high positive CTE layer) has to be accomplished in a manufacturable and inexpensive way, preferably by using a continuous assembly process. An example of such a continuous assembly method is described in FIG. 15. The lamination of negative CTE and positive CTE layers to produce an insert material for temperature-responsive thickness changeable textiles is accomplished in a continuous process of two materials layers released and bonded using, e.g., adhesive layer. The laminated structure with adhesive bonding material at the interface is then roller compression pressed for good adhesion, for example. This approach can be made into a continuous manufacturing procedure. An optional curing station (to cure adhesive bonding material) may be added as shown in FIG. 15.

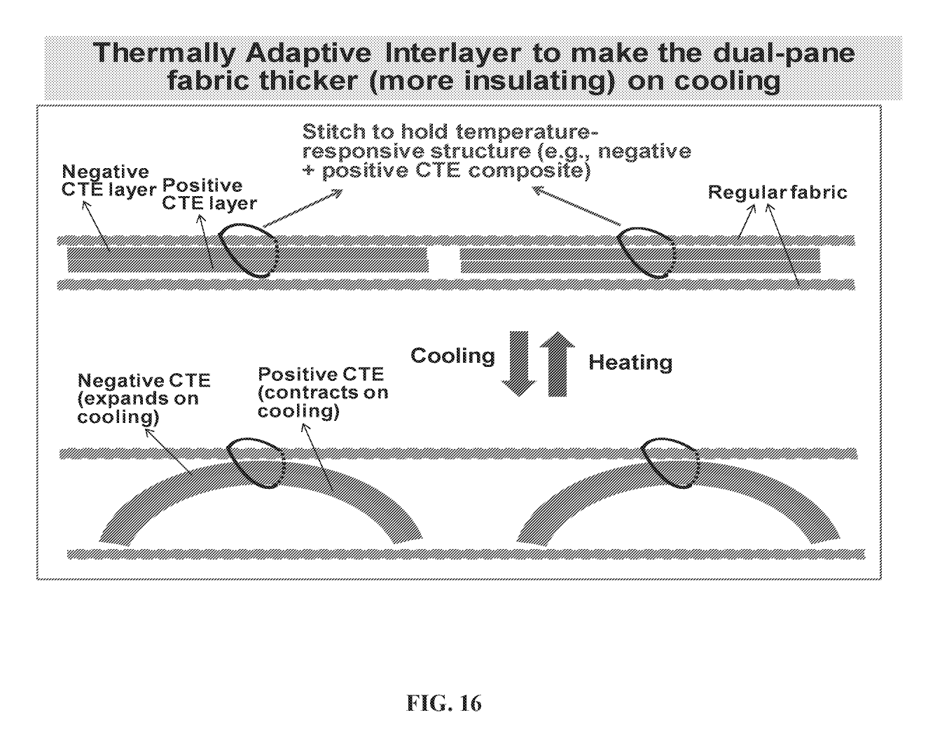

Shown in FIG. 16 is an example assembly method for attaching the inset composite layer onto the upper and lower fabric in the dual-pane configuration by using a stitching method to produce a thickness-changeable textile.

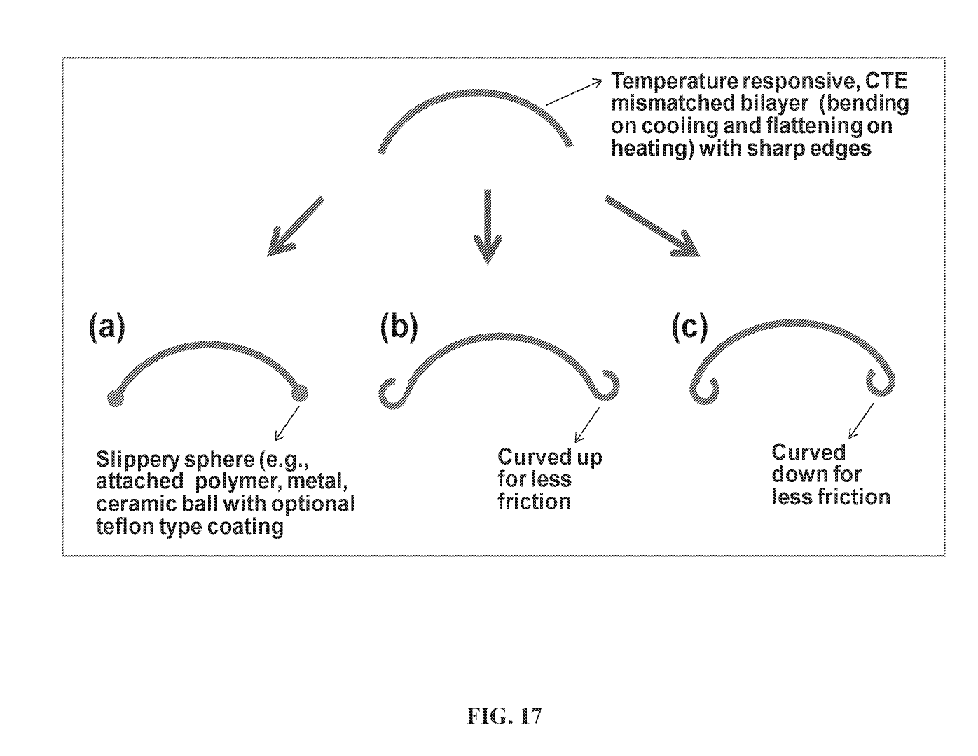

The negative CTE material can be made from the alloys such as Cu—Al—Zn, Cu—Al—Mn, Ni—Ti by using uniaxial and gradient deformation followed by cold rolling flattening into a ribbon geometry. While these metallic ribbons do not directly touch the human skin, a soft elastomer-like or gel-like coating may optionally be applied for extra protection of skin, and the ends of the ribbons may be folded-in or coated with a ball of polymer to avoid sharp edges as illustrated in FIG. 17. Such end spheres may be optionally coated with further friction-reducing material such as teflon or diamond-like carbon. By placing a series of this CTE mismatched bilayers between the inner and outer layers of thermally adaptive clothing, as the temperature drops, the bilayer flexes, pushing the inner and outer layers of textile apart and increasing the thermal insulance of the clothing.

The adaptive textile clothing is washable, but it can also be made detachable separate layer by using e.g., zippers, velcros, or buttons so that they do not need to be washed often.

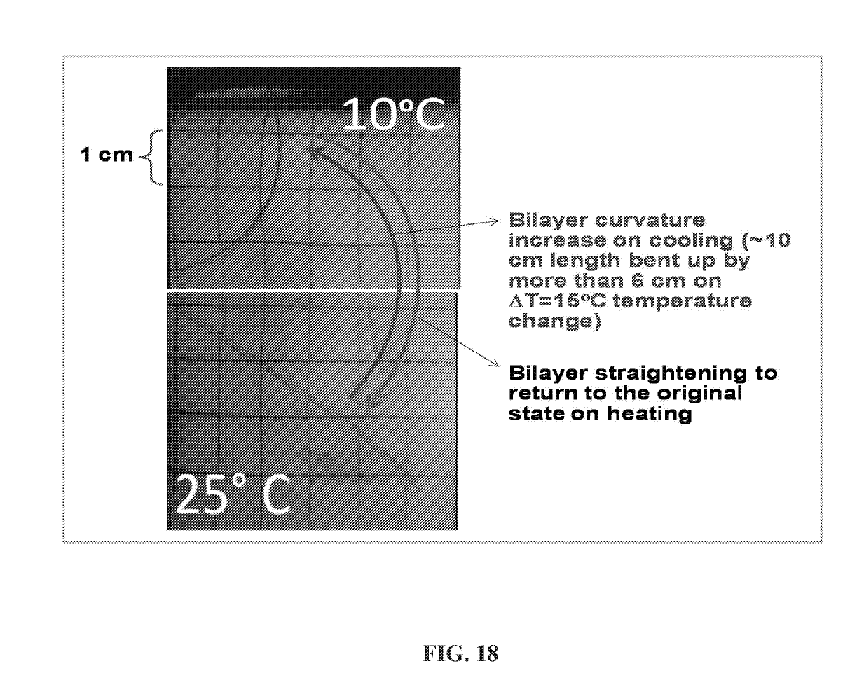

As a demonstration of substantial thickness change in a dual-pane fabric, a simple bending of the bilayer was measured on a temperature change of 25° C. to 10° C., and then back to 25° C. An example materials combination for such metal-polymer composite structures is a negative CTE Ni—Ti alloy having CTE of −20 ppm/° K together with a large CTE polymer materials such as cellulose acetate, polyethylene, PMMA (polymethyl methacrylate, polyamide, PEEK, UHMWPE, etc having a larger CTE values ranging from +50 to +200 ppm/K. The data in FIG. 18 represents a temperature-responsive bilayer deformation. The bilayer consists of Ni—Ti shape memory alloy (wire drawn from 125 μm to 100 μm diameter to introduce a gradient deformation and then cold rolled to flat ˜35 μm thick×˜200 um wide ribbon) and cellulose acetate (˜80 μm thick ribbon). The bilayers were assembled by joining using a thin adhesive layer and cured in a pre-flexed state. After cure, the bilayer returns to flat state at 25° C. As can be seen on the graph paper (1 cm grid) in FIG. 18, the bilayer curvature increased on cooling from 25° C. to 10° C. with the ˜10 cm ribbon length bent up by more than 6 cm on this ΔT=15° C. temperature change. This induces a very significant change in the thickness of a dual-pane fabrics if such FIG. 18 type inserts are utilized. On reverse temperature change (heating from 10° C. to 25° C.), the bilayer straightened out and returned to the original flat state.

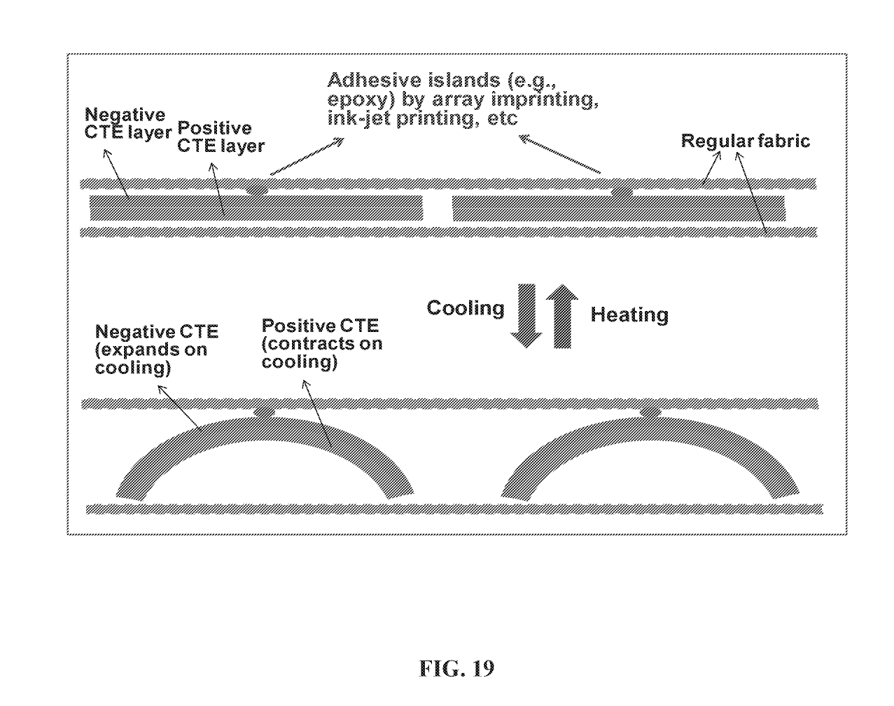

For assembly of temperature sensitive bilayer inserts, an array of adhesive islands may also be utilized as described in FIG. 19, instead of the stitching method illustrated in FIG. 16. The adhesive islands can be dispensed by e.g., multi pin array imprinting (such as dip coat, transfer and contact release on fabric), ink jet printing by using either single nozzle, high speed releasing of adhesive droplets or by using a multi-nozzle dispensing structure. The use of a random-position droplet dispensing device is not excluded.

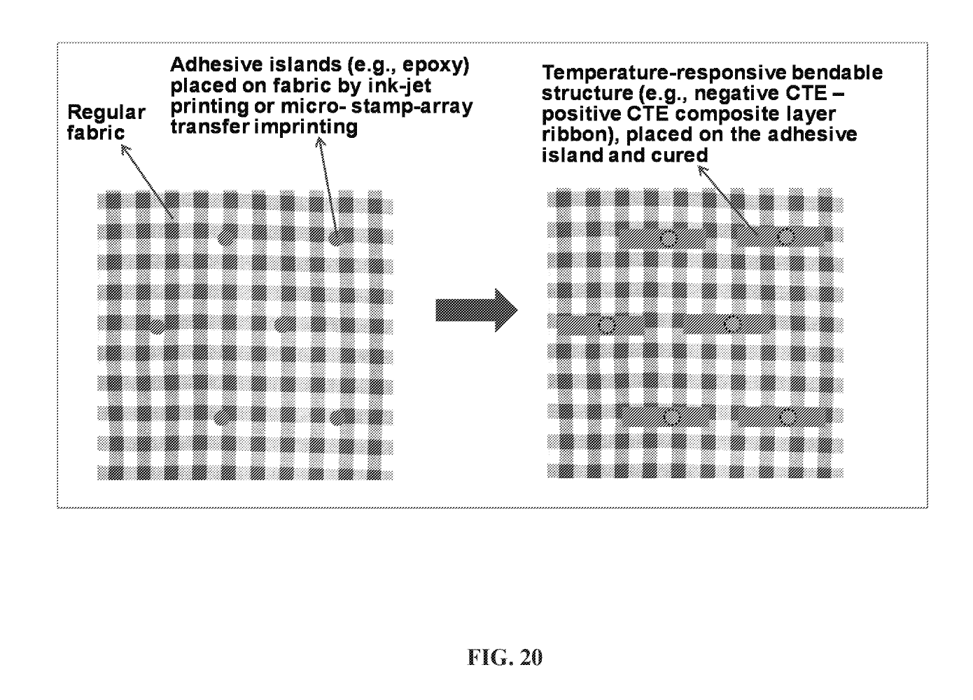

Shown in FIG. 20 is an assembly of temperature-responsive structure array on adhesive islands placed on fabric surface. Adhesive island array can optionally or additionally be placed on the mating fabric of the dual-pane textile as well. The bilayer ribbons are placed on the adhesive islands and pressed/cured by heat, by holding for a required length of time at room temperature, or by UV exposure.

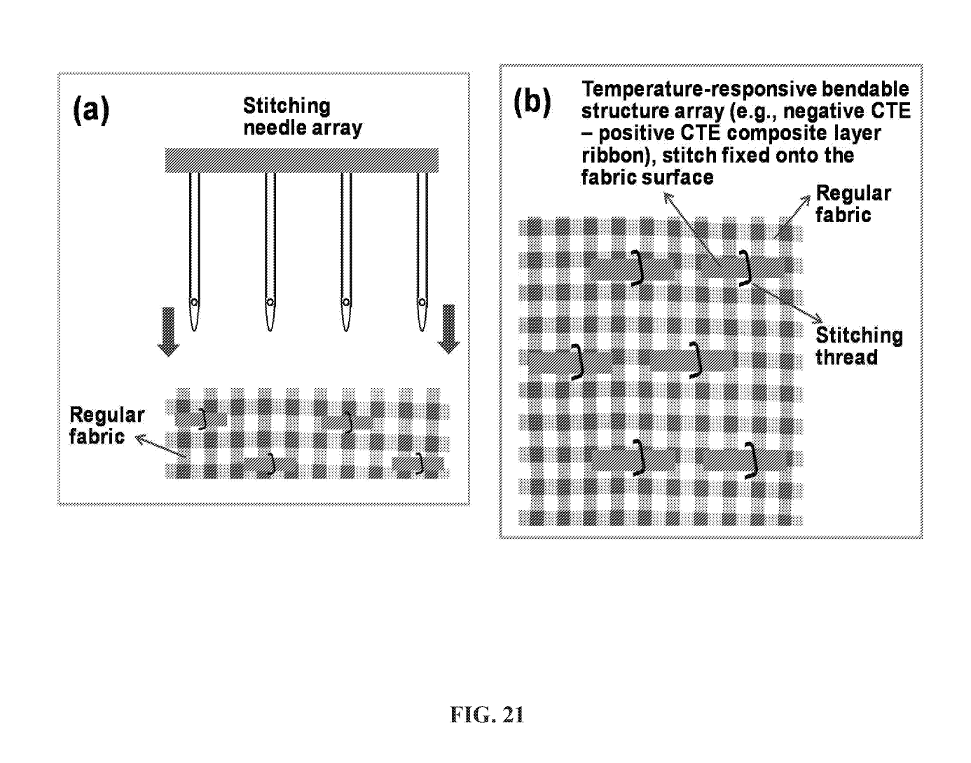

The attachment of the inserts (such as a bilayer ribbon of negative CTE Ni—Ti alloy and cellulose acetate or UHMWPE, can be performed by using an array stitching to assemble the temperature-responsive structure array on fabric surface, as described in FIG. 21. The stitch array can optionally or additionally placed on the mating fabric of the dual-pane textile as well.

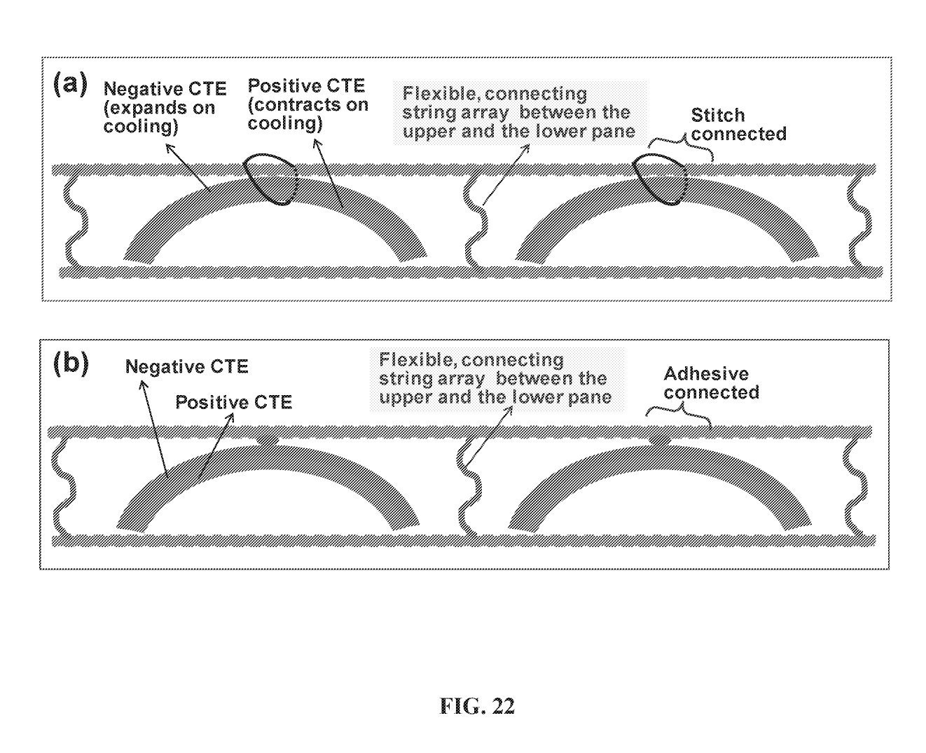

Once the temperature-responsive inserts are attached onto the upper fabric, lower fabric, or both, the two layers of fabrics need to be connected. One example method to assemble the two layers of fabrics is to utilize an array of flexible connecting strings or threads between the upper and the lower fabric pane (see FIG. 22) so that the two fabrics are kept in place during the temperature-induced expansion or contraction of the textile.

A-6. Use of Spring Configuration CTE Mismatched Bilayer Structure for Thermally Adaptive Dimension-Changeable Fabric.

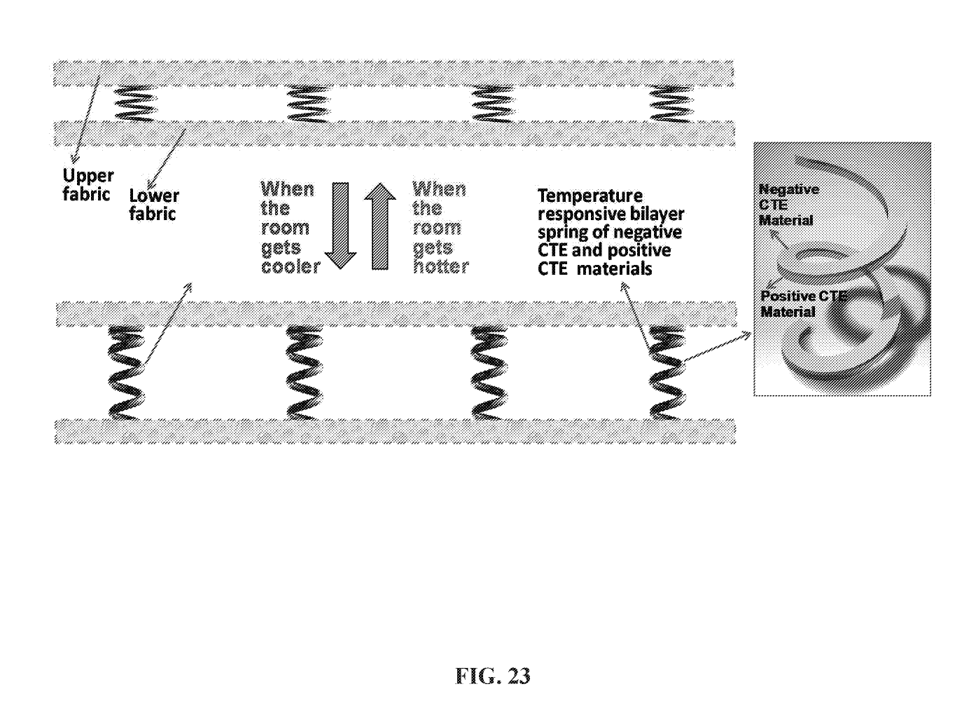

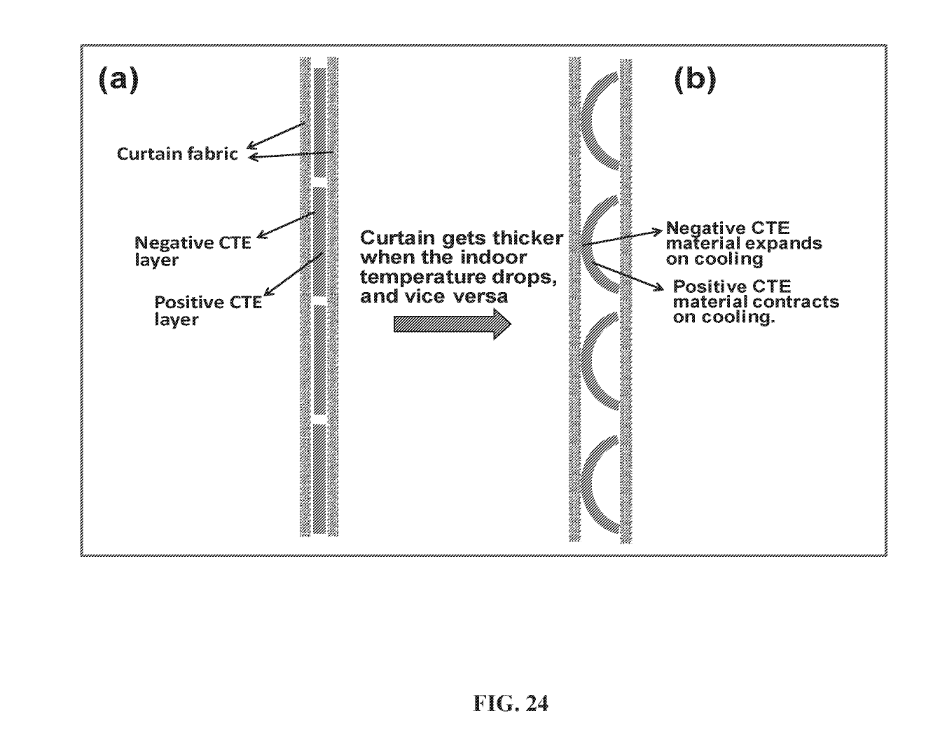

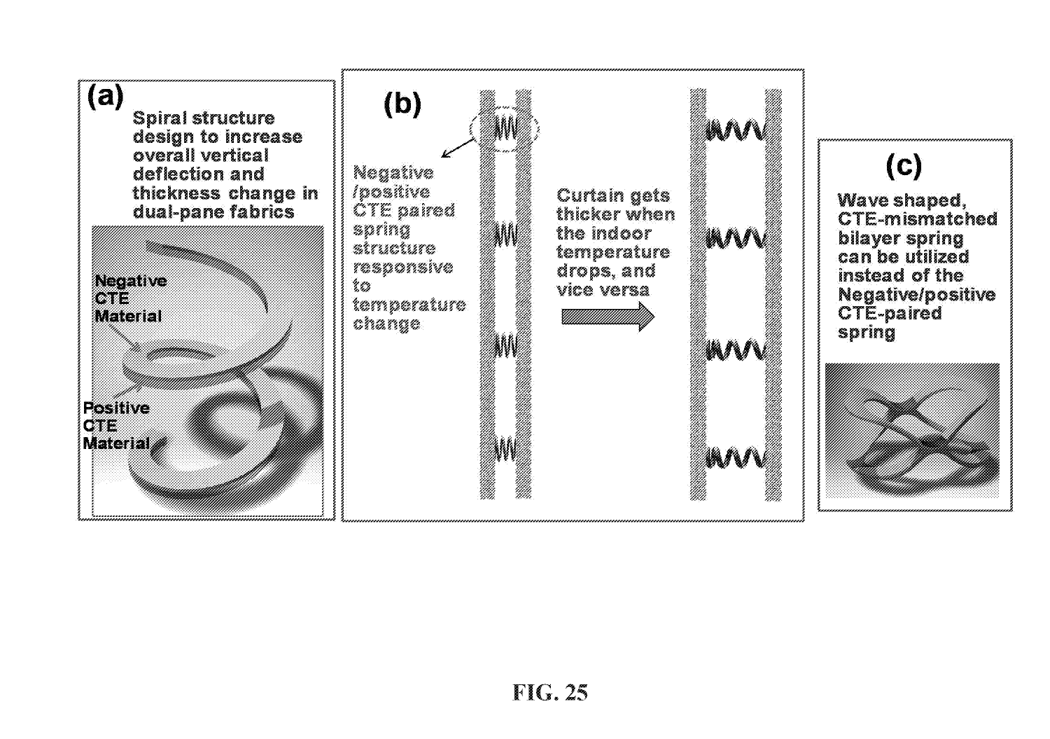

In order to further increase the extent of thickness change, the bilayer ribbon material can be configured in the form of springs as shown in FIG. 23. The bottom part of the negative coefficients of thermal expansion (CTE) alloy spring structure is coated with a positive CTE polymer layer (e.g., by lamination, electroplating, plasma spray deposition), so that the height of the temperature responsive insert is altered (taller when cold and shorter when warm). The polarity of deformation is dependent on what the curvature setting temperature is set, whether there is a pre-strain, whether the spring is left handed vs right handed, and other parameters. A dual pane fabric with a temperature responsive changeable thickness and insulation by using an array of spring inserts can help the wearer to feel more comfortable. The insert array can be positioned horizontally as in this figure, or vertically or at any other angles. Examples of negative CTE material include shape memory alloys processed into a gradient-transformation-temperature structure or shape memory polymers, or pre-strained polymers, and examples of positive CTE materials includes metallic or polymer materials such as cellulose acetate. For some applications, such as curtains and draperies, the thickness-changeable inserts of FIGS. 14, 16, 19, 22, 23 can be positioned vertically as shown in FIG. 24 and FIG. 25.

A-7. Materials and Methods for Enhanced Interfacial Bonding and Locking for CTE Mismatch Pairing.

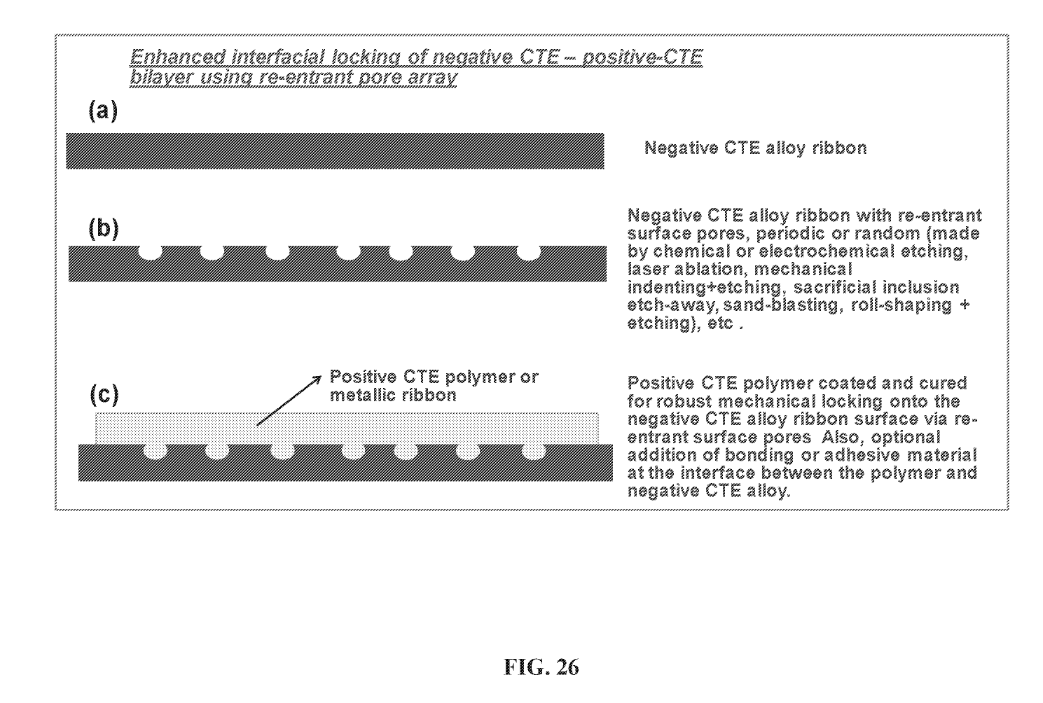

In order to maximize the CTE-mismatch-induced dimensional changes, it is important and essential to ensure excellent interfacial bonding and coupling between the two layers in contact, so as to minimize interference or undesirable creep effect, and to make the bilayer resistant to mechanical fracture, fatigue or creep failure. Some of the adhesive polymers, if made thin, can provide sufficient interfacial coupling and bond strength. As an alternative, mechanical locking structure can be utilized for such enhanced coupling as shown in FIG. 26. The figure is an exemplary design of interface structure to enhance the coupling between the two layers. The surface of one or both layers (e.g., in the case of Ni—Ti negative CTE alloy layer (CTE=−25 ppm/K) paired with a large positive CTE cellulose acetate (CTE=+130 ppm/K) or PEEK polymer layer (CTE=+50 ppm/K)) is intentionally made to contain re-entrant pores so that the polymer material before curing penetrates into the re-entrant pores and mechanically locked in after the curing of the polymer. The desired size of the re-entrant pores is in the range of 0.05 to 50 um, preferably 0.2 to 10 um, more preferably 0.5 to 2 um. Such pores can be prepared by lithographic masking and chemical etching, or ink jet printing of masking layer and chemical etching, or mechanical indentation with optional etching. For non periodic pores, simple sand blasting or emery paper polishing can be used to make the surface rough for enhanced adhesion.

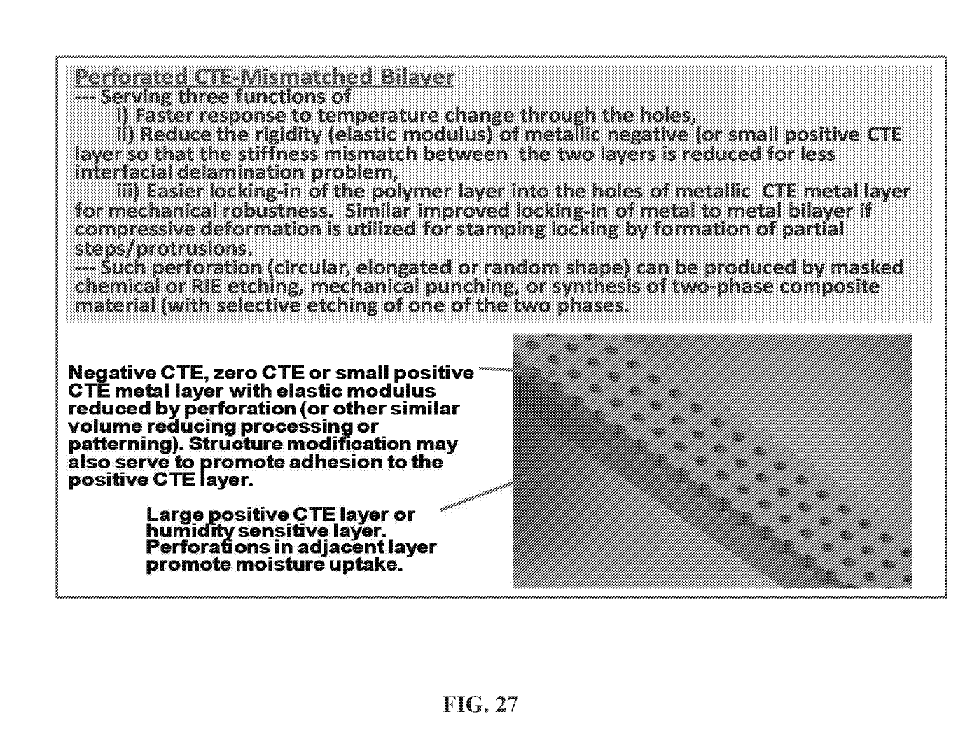

The structure of the bilayers can further be improved by various modifications of the geometry, such as by introducing an array of vertical porosity (FIG. 27) for enhanced response time to temperature change, reduced stiffness, or enhanced lock-in structure. The perforation dimension can be in the range of 0.2 to 10 um, more preferably 0.5 to 2 um.

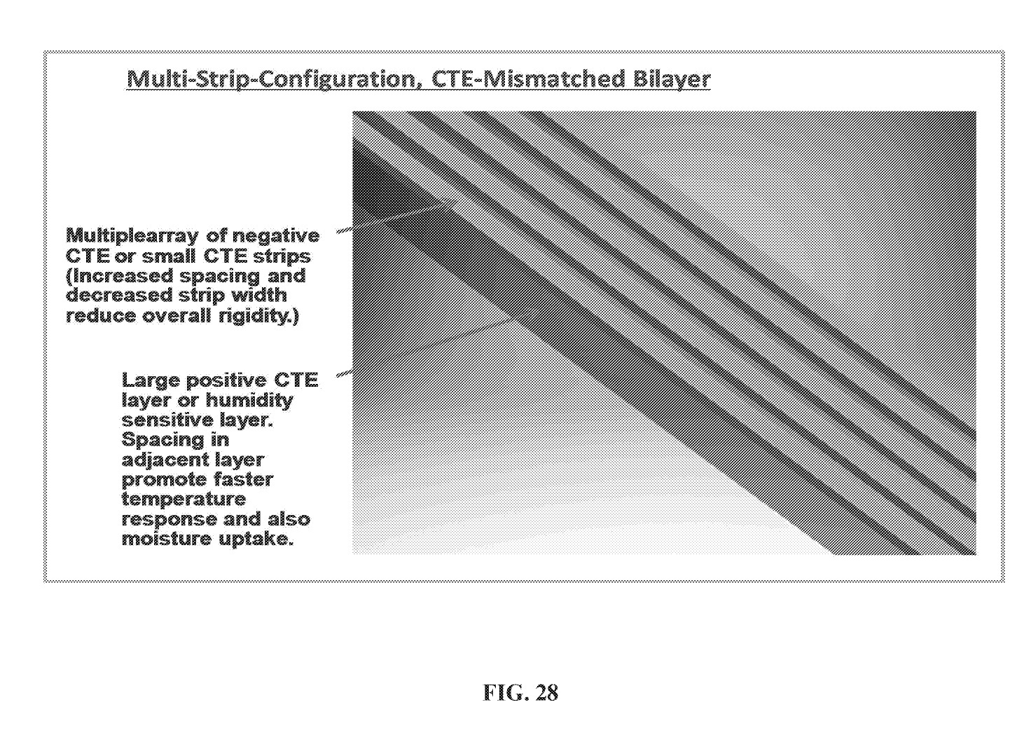

Instead of pores, a multi-strip parallel groove configuration (FIG. 28) can also be utilized for faster response of the CTE mismatched bendable layer. The desirable width of the parallel grooves is in the range of 0.2 to 10 um, more preferably 0.5 to 2 um.

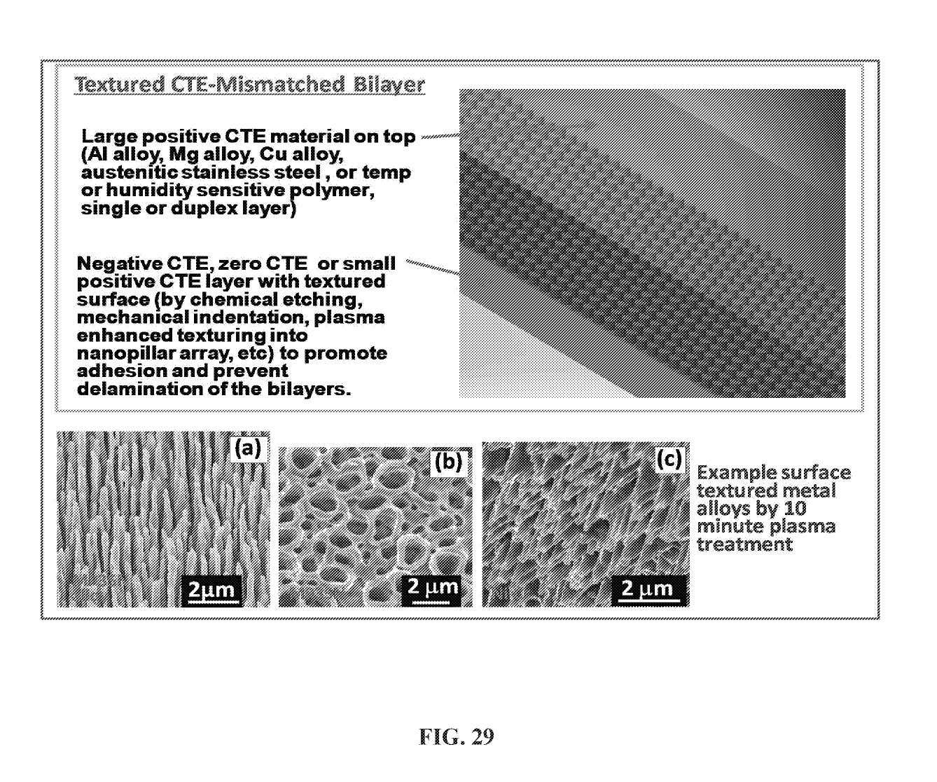

Surface nanopatterning (or micropatteming) (FIG. 29), which can be randomly distributed for ease of processing, can also be employed for roughness increase and stronger adhesion/bonding of the bilayer materials when adhesive layer is utilized for pairing of the two layers. One of the techniques to pre-pattern metal surface to introduce nanostructured texture on metal or alloy surface is to utilize microwave etching at high temperature. The nanotextured patterns in FIG. 29(a) to (c) were obtained on 35% Co-35% Ni base alloy strip surface which was exposed to 13.6 MHz RF Power for 10 minutes under partial pressure argon atmosphere. The RF power was adjusted between 100-250 watt level to produce various types of nanotexturing in FIG. 29.

A-8. Thickness-Changeable Inserts for Thermally Adaptable Textiles with Vertical Aligned Thermal Expansion and Contraction.

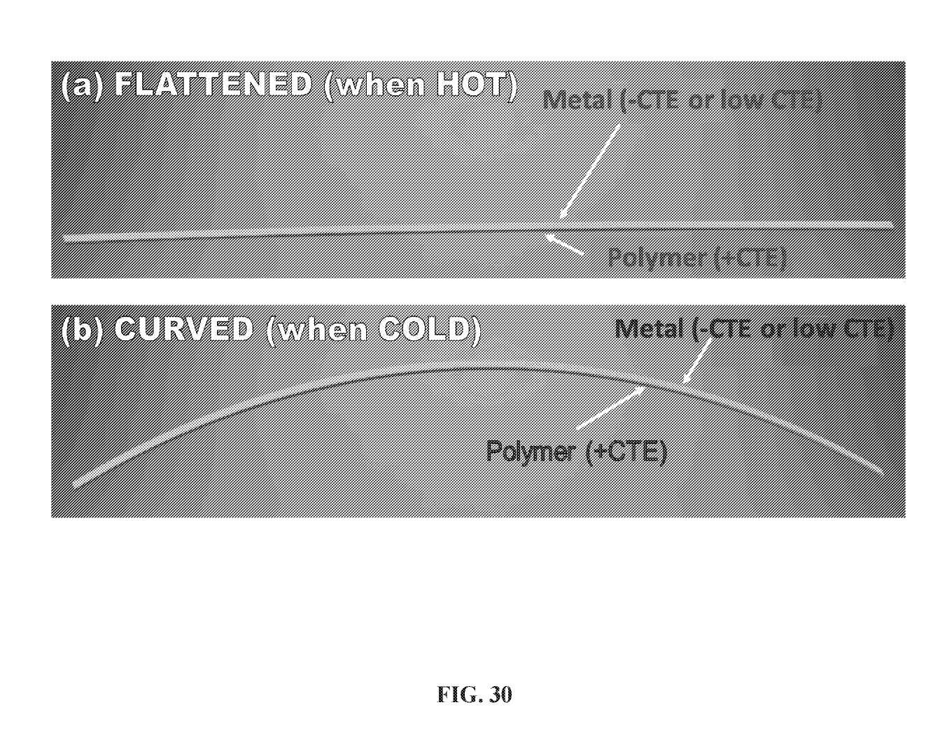

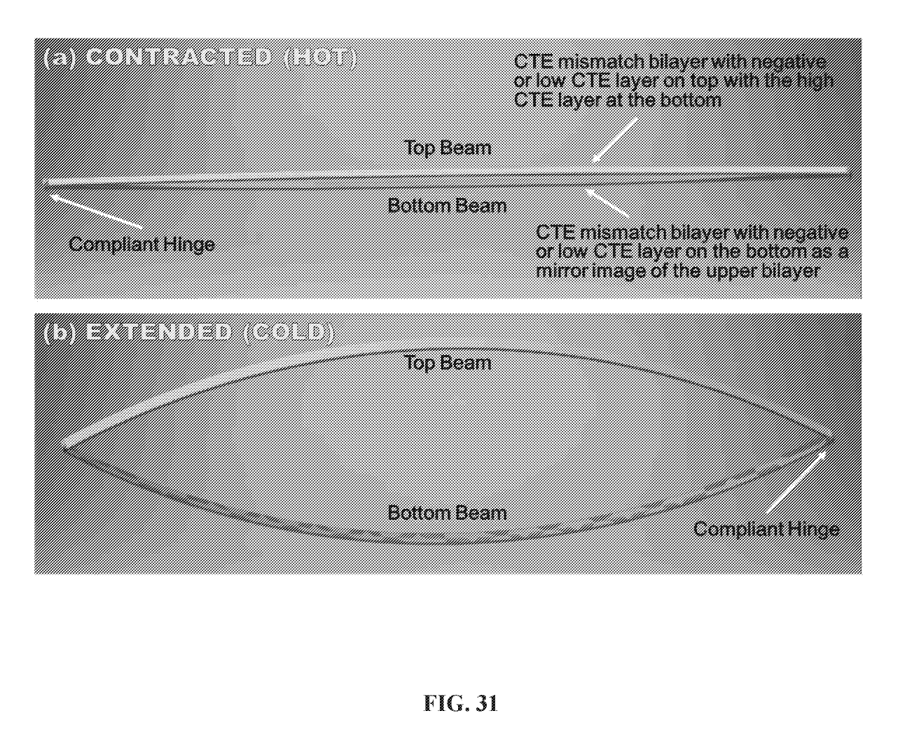

In addition to various embodiments described above for thickness-changeable dual pane fabric, other configurations are possible. For example, yet another embodiment for the thickness changeable dual pane fabric is to utilize a bow type structures as described in FIG. 30-FIG. 36. To address the issue of unequal matching of contact points in the temperature responsive bilayer tips between the upper fabric layer and the CTE mismatched bilayer, as well as between the lower fabric layer and the CTE mismatched bilayer, a bow structure may be employed. Consider a CTE mismatched bilayer as in FIG. 30. As imaged with the positive CTE polymer layer on the lower surface and the negative CTE shape memory alloy (SMA) layer on the upper surface, the beam flattens in the hot state (˜30° C.) and curves in the cold state (˜20° C.). By adding a second, mirrored beam and pinning the two CTE mismatched bilayers with compliant hinges at either end as in FIG. 31, the total deflection is doubled and the points of furthest separation on the top and bottom of the bow structure maintain vertical alignment during the temperature-driven deformation, thereby avoiding friction between fabric and beam which could restrict deflection.

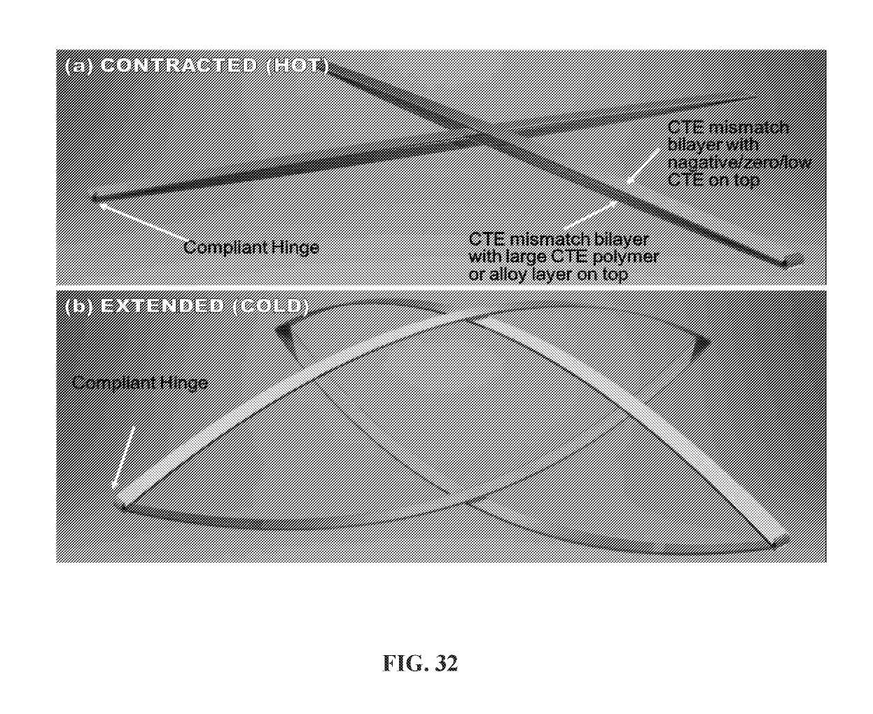

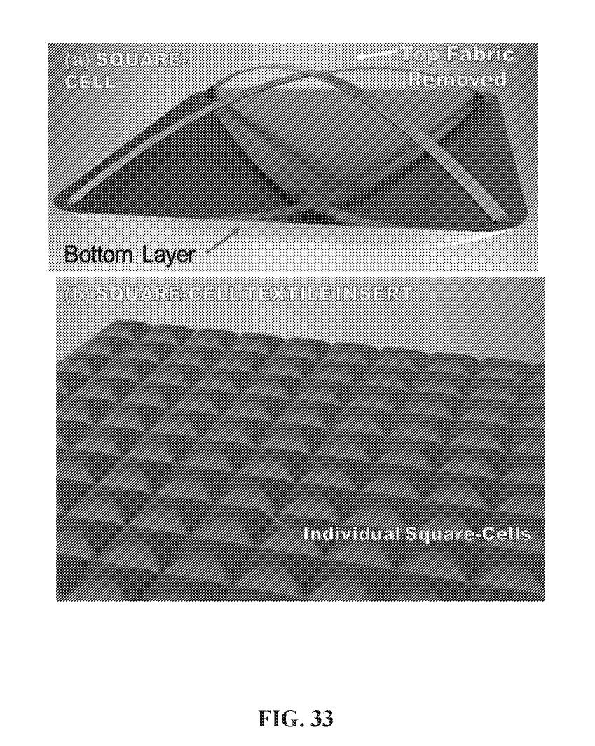

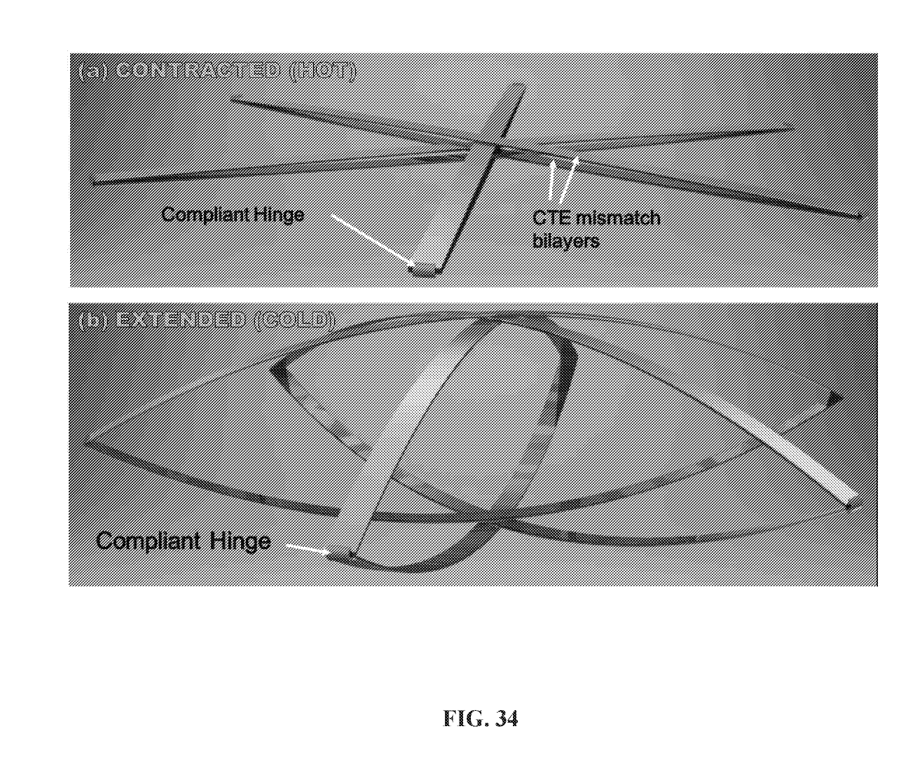

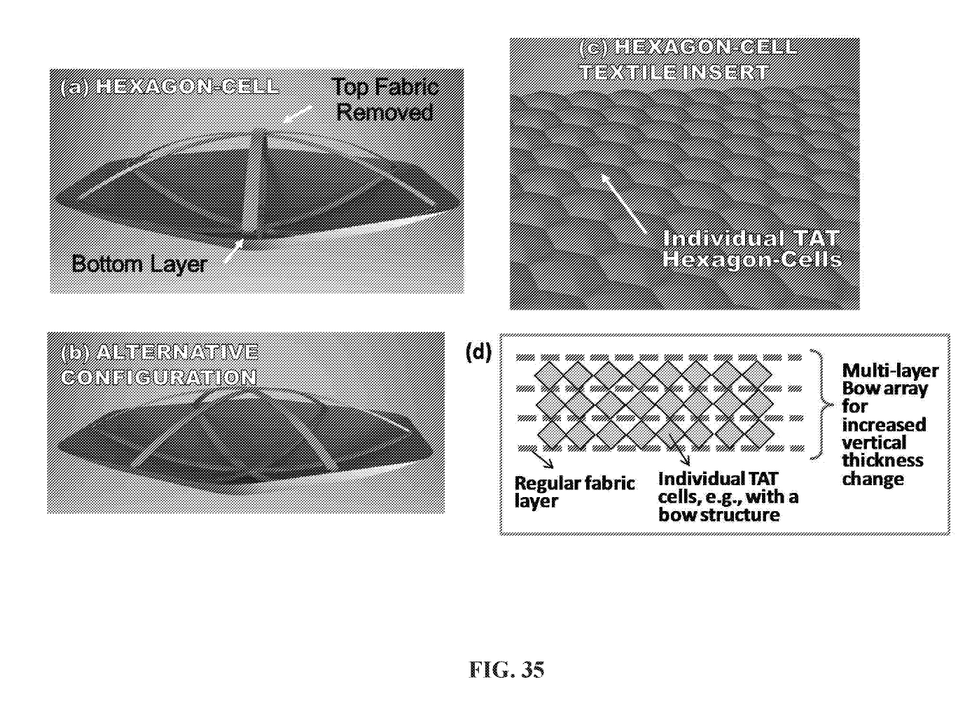

Additional bow structures rotated around the same central axis (as in the square-configuration of FIG. 32 and FIG. 33, and the hexagon-configuration of FIG. 34) may be included to increase the force of separation as the structure cools while maintaining the dual vertically-aligned contact points. Yet another embodiment of the temperature responsive fabric using the bow structure is to employ closed-cell configurations as in FIG. 33 (square-cell) or FIG. 34 and FIG. 35 (hexagon-cell).

These closed cells may be manufactured by aligned placement of bow-structures onto a lower film or fabric, followed by attachment of an upper film fabric with a connection around the edge of individual cells achieved by adhesive, melting, stitching, or other methods. The structure may then be used directly as a temperature responsive textile as an insert layer between upper and lower textiles in a consumer product, for example, for a jacket, coat, or back pack. Alternatively, the bow structures may be attached directly to upper and lower textiles via stitching, adhesive, or similar in an open-cell configuration as in FIG. 31. These bow shaped or star-structured insert made of CTE mismatched bilayer composite material, either as a single leg bilayer as in FIG. 30 or two bilayers facing each other as in FIG. 31 to FIG. 37 represents a “Shape-Memory Structure” which exhibits very reproducible expansion and contraction behavior. According to the invention, the desirable degree of thickness expansion or contraction in the “Shape-Memory Structure” is typically more than 0.2 cm height change for 10 cm length leg horizontal dimension of the structure (equivalent to 2% height change relative to the horizontal length dimension) when the environment temperature is altered by 10° C. Therefore, the disclosed “Shape-Memory Structure” exhibits a ratio of vertical height change to the horizontal dimension, of at least 2%, preferably at least 5%, even more preferably at least 10% per 10° C. temperature change.

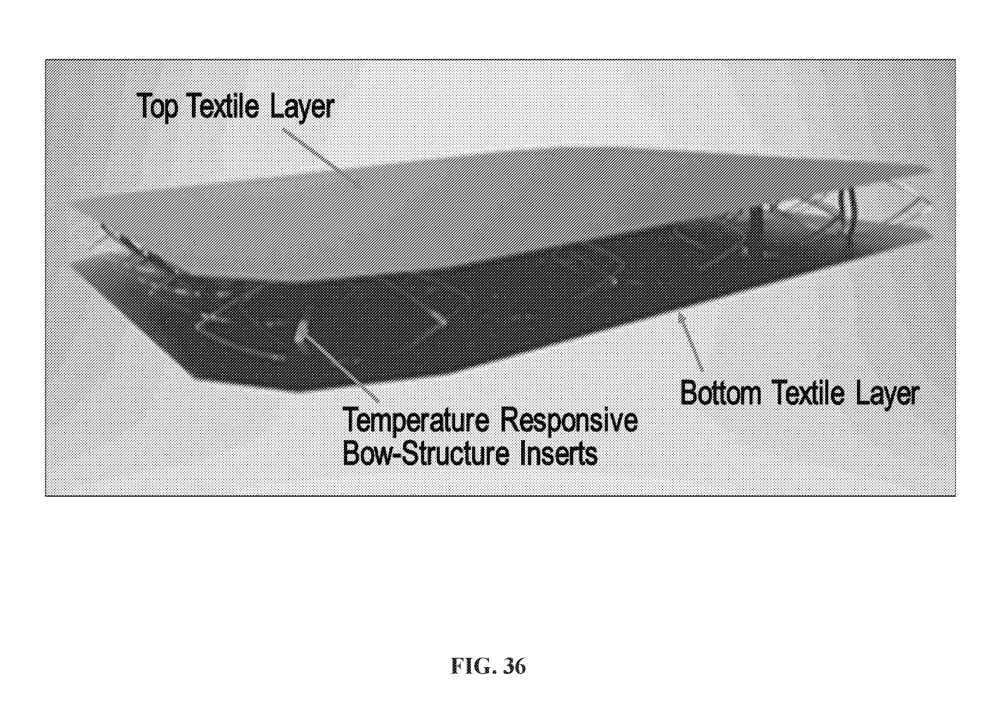

For apparel, drapery, tent, bed cover type fabrics applications, a multiplicity of the hexagon configuration temperature responsive structures (star shaped inserts) are placed between two fabrics (dual pane thermally adaptive fabric) and position fixed at the apex of the hexagon. The hexagon star structure array then expand on colder temperature for increased thermal insulation to make the person feel warmer and contract on hotter temperatures for reduced thermal insulation to make the person feel cooler, as described in FIG. 36.

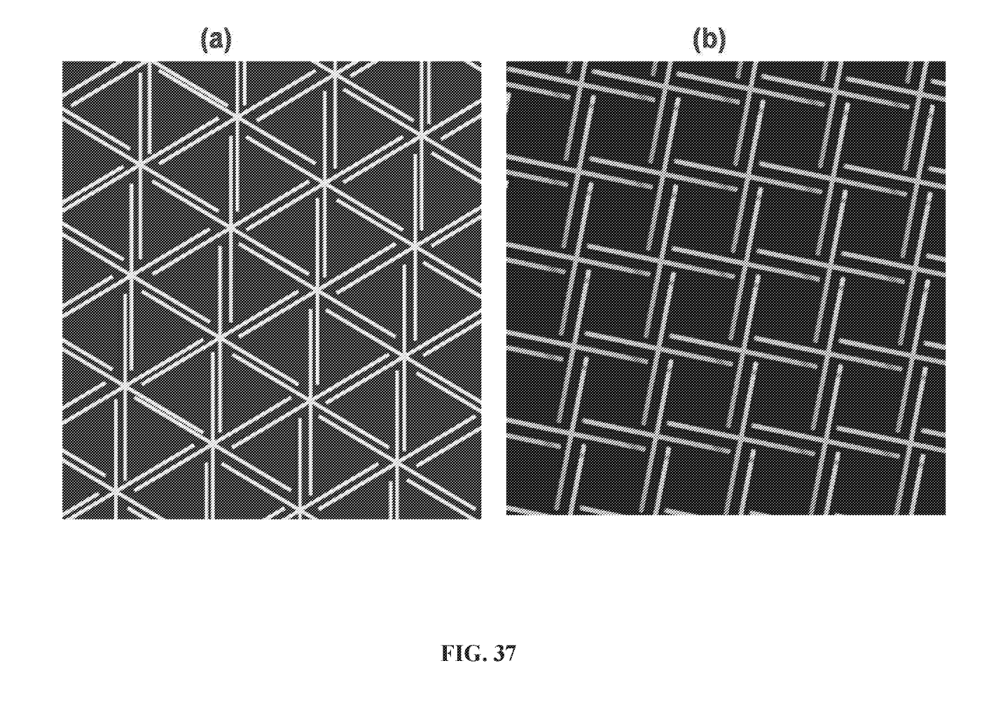

In order to provide more force to expand or contract the dual pane fabric, more dense packing of the bow type structure is highly desirable. Shown in FIG. 37 are two examples of such a higher-density packing, using a triangular or square arrangement of neighboring bow structures placed with a small spacing between them, but sufficient to prevent touching or mechanical interference. The desired spacing between neighboring bow structure elements in the dense packing arrangement is at most 2 cm, preferably at most 1 cm, more preferably at most 0.5 cm.

The hexagonal, square (cross) or other related star type configurations of the temperature responsive structure inserts are unique, with the some of the main advantages listed below.

(1) The star configuration allows a doubling of the height expansion or contraction between two adjacent fabrics in a dual pane or multiple pane textiles.

(2) As long as their top and bottom apex positions are secured and attached onto fabrics (e.g., by stitching or gluing) they are vertically aligned and the thermally activated expansion and contraction to change the airgap (and associated thermal insulance) occurs in an essentially vertical movement, thus minimizing complication of e.g., unwanted local tension or compression of fabrics or wrinkling of dual pane fabrics.

(3) These inserts or an array of inserts as a layer or inside a retaining pocket can be pre-made and can simply be inserted between ordinary fabrics for ease of assembly and manufacturing. Such a retaining pocket can be made using a loosely structured fabric so as to minimize interference in terms of thermal management related to heat flow or air flow aspects.

(4) Less friction

The desired dimension of the stars is e.g., in the range of 0.1-100 cm in overall diameter (or equivalent diameter) depending on the applications, preferably 0.2-10 cm, even more preferably 0.5-2 cm. For tent or other type of applications (e.g., for applications such as to open up a large gap in the back of the apparel or on the side of a jacket to let a fresh air flow in through a 1-10 cm level gap), the dimension can be larger, while for apparel applications, the dimension can be smaller. The desired thickness span that the star structure can change is e.g., in the range of 0.01-10 cm, preferably 0.1-5 cm, even more preferably in the range of 0.5-2 cm. The usable temperature range is typically in the range of −50° C. to +50° C. For winter sports. such as cross skiing jackets, the usable temperature range can be pre-set to extend to sub-zero temperatures. For summer jackets in hot weather, the temperature range can be extended toward higher temperature.

A-9. Methods to Impart a Preset “Bow Flat Temperature” in the Temperature-Responsive Bilayer.

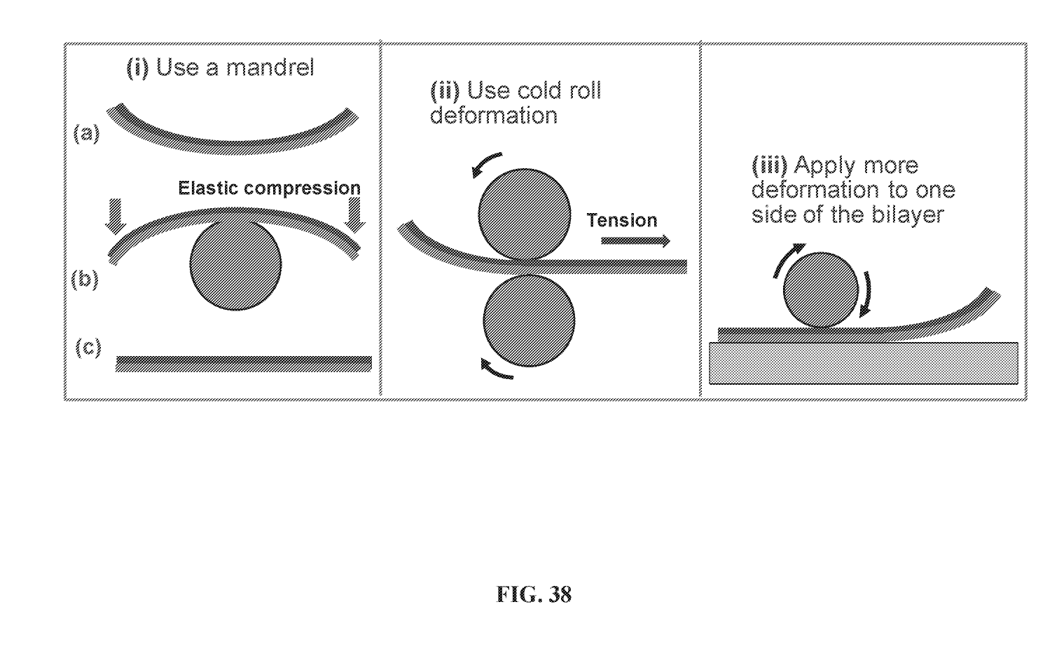

The temperature at which the bow structure is flat dictates the maximum temperature beyond which the thickness-change no longer occurs in the temperature-responsive smart textile. It is important to set the bow-flat temperature for proper service temperature range. Once the CTE mismatch bilayer is made, it needs to be made flat at a specific desired temperature, e.g., set at 37° C. (for 10° C.-to-body temperature operation of the textile thickness change) or set at 20° C. (for 0° C. to 20° C. operation), or 5° C. (for −15° C. to +5° C. operation). Methods to make the bilayer flat at a specific temperature: i) use a round mandrel to press a curved bilayer against to remove the existing curvature, ii) pass the curved bilayer through a rolling mill with tension, iii) use asymmetrical roll diameter pair, iv) apply an upward or downward tension during cold rolling to control/adjust the curvature, v) apply deformation to one side of the bilayer, etc. Shown in FIG. 38 are some exemplary methods to control the curvature of the CTE-mismatch bilayer to obtain a preset bow-flat temperature in the temperature-responsive bilayer.

(B) Porosity Changeable and Air-Flow Adjustable Smart Fabrics Activated Solely by Environmental Temperature Changes

The thermally adaptive smart textiles can also have structures that are not necessarily thickness changeable (thermal insulance changeable). Another structural configuration is the porosity changeable and air-flow adjustable smart fabrics activated solely by environmental temperature changes. The embodiments for pore opening in this case include the following examples;

i) Flap opening structures—An array of pre-made flaps in a single layer fabric (or these flap array containing single layer fabric can be stacked if desired) can be activated by temperature change to be bent upward or downward so as to create an array of holes (like window array opening). The flaps can be rectangular, square, oval shape or any elongated shape. The temperature responsive bilayer described above can be attached onto the bottom (or top) surface of the flapped region of the ordinary fabric. As illustrated in FIG. 14, various types of bilayer structure (metal-metal, metal-polymer, polymer-polymer combination) can be created with a CTE mismatch to induce bending to create opening (pore array) on temperature change. Different bilayer component materials are selected to induce significant bending and associated cooling effect for a person wearing such a flap-array fabric.

The bilayer bends up on temperature rise and pushes up the pre-cut-out flaps in the regular fabric to create a pore array. This thermally induced flap opening (and pore opening) allows air flow and cooler feeling, as well as produces aesthetic color or shape change in the fabric.

B-1. Description of Flap Opening Porosity-Changeable Smart Fabrics Activated Solely by Temperature Change.

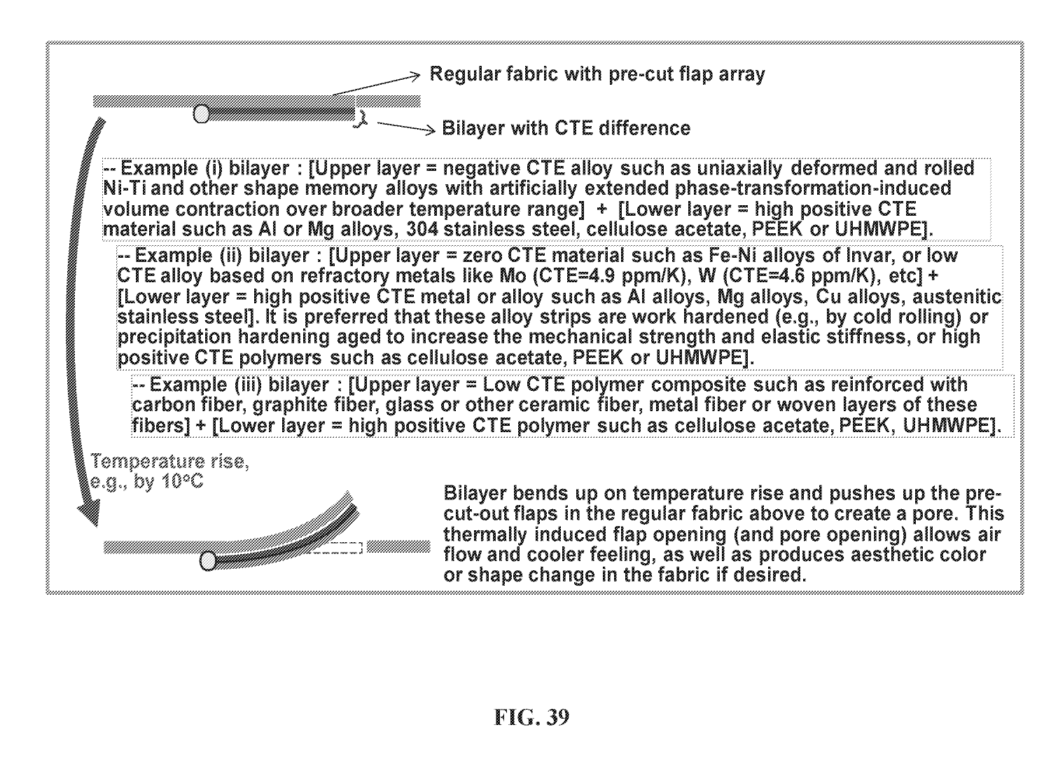

This class of porosity-changeable smart fabric structure utilizes the thermal expansion mismatch of the intimately coupled bilayer configuration, as described in FIG. 39.

Referring to the drawings, FIG. 39 schematically illustrates various different bilayer component materials to choose from in order to induce CTE (coefficient of thermal expansion) mismatch and significant bending on temperature change. The bilayer structure with a CTE (coefficient of thermal expansion) mismatch induces bending on temperature change due to the differential expansion. As a flap shaped bilayer bends up on temperature rise, it pushes up the pre-cut-out flaps in the regular fabric to create a pore. This thermally induced flap opening (and pore opening) allows air flow and cooler feeling to the wearer, as well as produces aesthetic color or shape change in the fabric if properly designed. It should be noted that the momenclature of “upper layer” is use arbitrarily to represent the negative CTE or lower CTE layer of the two component composite, as the “upper layer” means a layer that will thermally shrink when heated (or expand less than the other layer) so as to make the bilayer curve toward the side of that layer. The same bilayer can easily be flipped to become a “lower layer” if one desires the the bilayer to curve downward when the temperature is raised.

Three example structures of flap opening structure based on temperature changes alone are described as follows, in reference to FIG. 39.

Example (i) bilayer: The upper layer is made of a negative CTE material such as uniaxially deformation processed Ni—Ti and other shape memory alloys, with preferably artificially extended phase transformation temperature range for more practical applications (instead of rather abrupt and narrow phase change and associated volume change and thermal expansion/contraction), e.g., by a uniaxial deformation followed by flattening deformation into a ribbon geometry. The lower layer is made of high positive CTE material such as cellulose acetate.

Example (ii) bilayer: The upper layer is selected from a zero or near zero CTE material (e.g., CTE<˜5 ppm/° K or preferably <˜2 ppm/° K) such as 64 wt % Fe-36 wt % Ni alloys of Invar (or other binary or ternary or quatenary alloys with CTE of near zero around room temperature. It is preferred that the Invar type alloy strips are colled rolled severely (by at least 30%, preferably at least 60, even more preferably at least 80% reduction area deformed) so as to make the alloy strip mechanically stronger and stiffer for robust and more reliable operation when utilized and environmentally (e.g., temperature and humidity wise) cycled as a component of thickness-changeable textile or pore-openable textile.

As an alternative to the zero CTE material (there are a limited number of zero CTE materials, and for the purpose of lower cost, some other alloys with slightly higher positive CTE could be employed), e.g., a low CTE alloy with a CTE value of e.g., less than 10 ppm/° K, preferably less than 6 ppm/K can be utilized. For example, such a low CTE alloys can utilize a refractory metals/alloy type material such as Mo (CTE=4.9 ppm/° K), Nb (CTE=7.31 ppm/K), W (CTE=4.6 ppm/K), Ta (CTE=6.5 ppm/K), Zr (CTE=5.85 ppm/K), Hf (CTE=5.90 ppm/K), Re (CTE=6.70 ppm/K), etc. and their alloys. The mating, high-CTE material can be selected from metals or alloys with a high positive CTE such as Al alloys (CTE=23.6 ppm/K), Mg alloys (CTE=27.1 ppm/K), Cu alloys (CTE=16.5 ppm/K), austenitic 304 type stainless steel (CTE=16.5 ppm/K). It is preferred that these alloy strips are work hardened (e.g., by cold rolling) or precipitation hardening aged to increase the mechanical strength and elastic stiffness to provide enhanced mechanical robustness and reliability over long time thermal and strain cycling during use as a part of smart textiles.

Yet another alternative is to use a low CTE polymer as the upper layer. While polymers in general have high CTE compared to metals or ceramics, some polymers can be engineered to exhibit low CTE values, e.g., if the polymer is made into a composite by filling with low CTE inorganic material such as carbon, graphite, glass fiber, metal fiber, ceramic fiber or laminated with a layer of these materials. The desired CTE values of such a composite layer is at most 30 ppm/K, preferably at most 15 ppm/K, even more preferably at most 10 ppm/K. Example materials include 30% glass fiber reinforced PAI (Polyamide) with CTE=30 ppm/K, or 30% carbon fiber reinforced PEEK (Polyether ether ketone) with CTE=25 ppm/K.

Example (iii) bilayer: The upper layer is selected from a zero or near zero CTE material (e.g., CTE<˜5 ppm/K or preferably <˜2 ppm/K) such as 64 wt % Fe-36 wt % Ni alloys of Invar. The lower layer is made of high positive CTE material such as cellulose acetate (CTE=130 ppm/K), PEEK (Polyether ether ketone, CTE=50 ppm/K), UHMWPE (ultra-high molecular weight polyethylene, CTE=200 ppm/K).

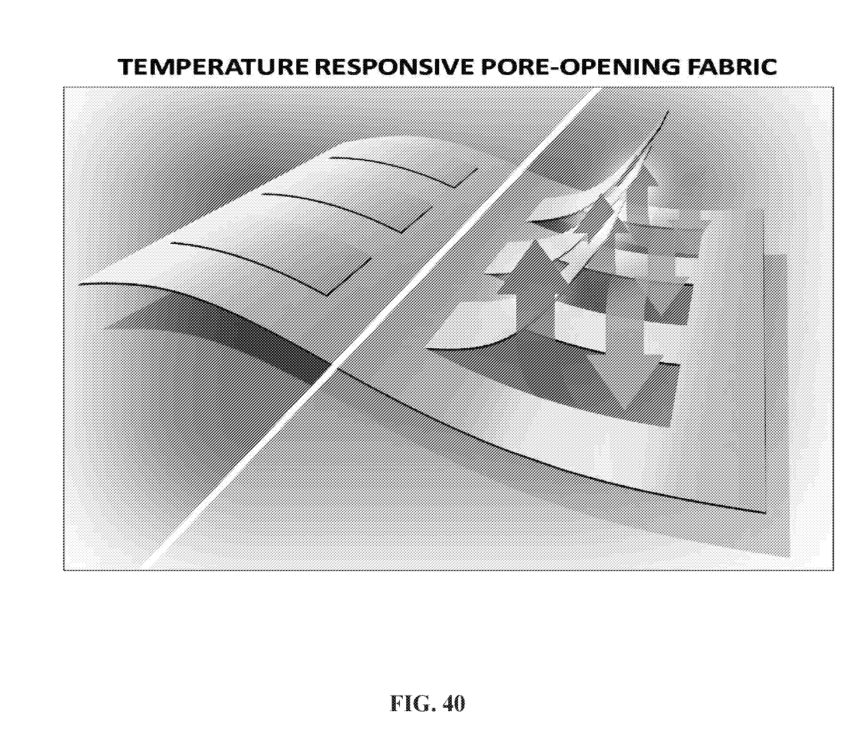

Referring to the drawings, FIG. 40 describes a temperature-responsive, pore-openable fabric by flap opening using a CTE mismatched bilayer placed underneath the pre-cut flap of any fabric. When the flap is open, air can get in and out to make the wearer of the clothing feel cooler.

B-2. Utilization of Temperature Activated Flap Opening Smart Fabrics for Color and Light Reflection Control.

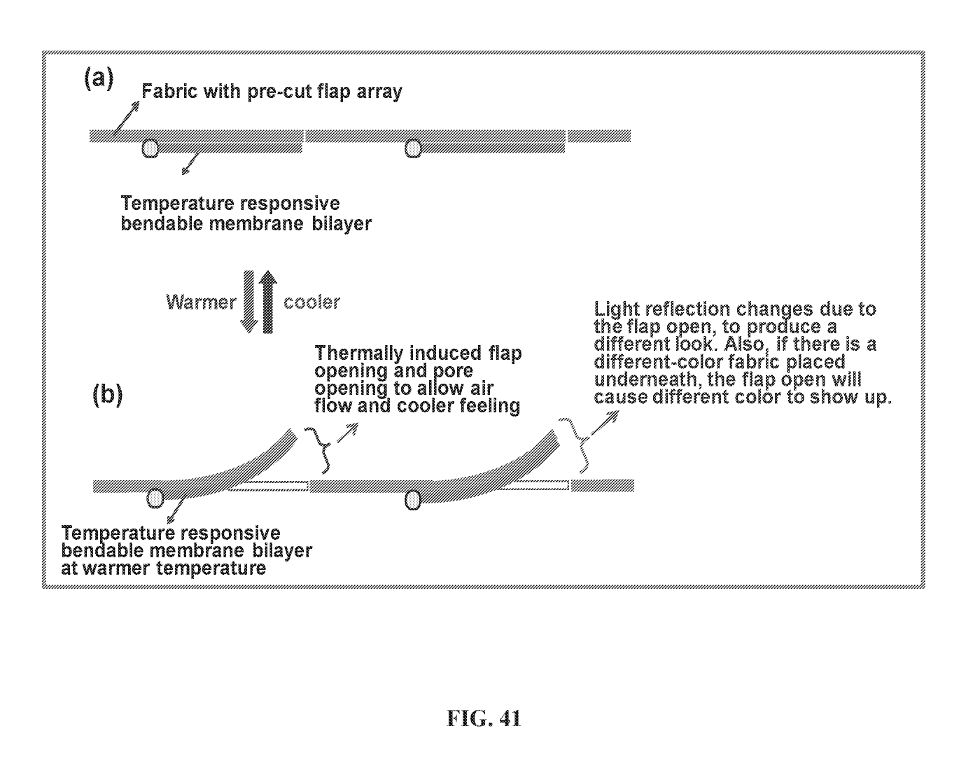

The flap opening porosity-changeable smart fabrics activated solely by temperature change as illustrated in FIG. 41, also describes the principle involved in such a design of material structure useful for apparels, drapery fabrics, a tent fabric or sleeping bag fabric due to an enhanced air flow. The temperature-only-responsive flap structure, unlike the humidity-responsive flap openable structure, does not cause any inadvertent flap opening on fog, light rain or humidity. The FIG. 41 type structure can also change color or light-reflection when an array of flaps are open. Light reflection changes due to the flap-open status, which produces an aethetically different look. Also, if there is a different-color fabric placed underneath, the flap open will cause different color to show up. These features can be utilized to design interesting new fabrics and dresses.

B-3. Methods of Attaching a Low CTE Layer and a High CTE Layer.

A tight coupling of the two CTE mismatched layers is important in order to maximize the temperature responsive fabric performance as well as to ensure long term robustness without failure of the material due to delamination, fracture, creep or fatigue. One of the embodiments to attach the two layers is to utilize adhesive polymer layer which can be e.g., spray coated, brush coated, ink jet print coated, stamping coated or dip coated. An important structural control that needs to be met is that the thickness of the adhesive polymer layer should be kept thin, so as to minimize stress accumulation, delamination, creep and loss of dimension change over time, and inadvertent interference with the thermal expansion behavior. The desirable thickness of the adhesive layer is at most 100 um, preferably less than 20 um, even more preferably less than 5 um.

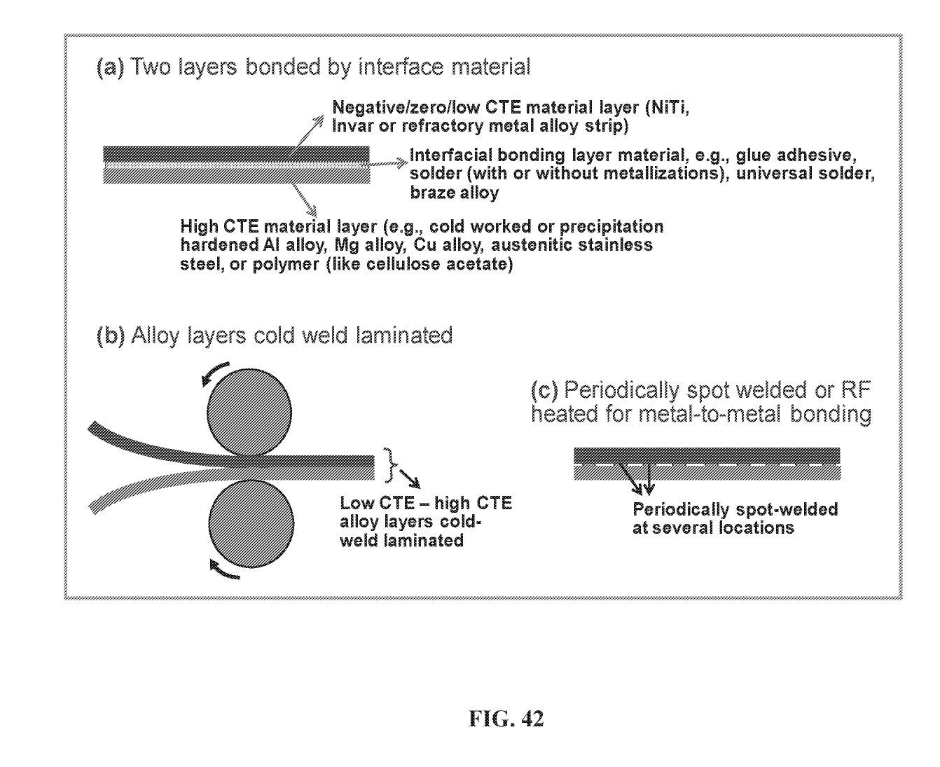

When two layers are both metallic, other metallic bonding agent beside the polymer adhesives can be used for even stronger coupling of the two layers. The CTE mismatched metal layers need to be bonded/attached to be coupled strongly in order to perform well as a temperature-responsive bendable bilayer. Shown in FIG. 42 are some exemplary methods of attaching two metallic layers of a low CTE layer and a high CTE layer to form a temperature-responsive bilayer. Bonding with interfacial layer (FIG. 42(a)) can be accomplished using polymer adhesives, but more preferably a solder layer bonding such as Sn—Ag, In—Sn, Bi—Sn can be utilized and heated to 150-300° C. for solder bonding to occur, optionally using flux to overcome any surface oxidation issues. A braze alloy or a universal solder (e.g., Sn—Ag, In—Sn, Bi—Sn base solder containing 1-5 wt % rare earth element for powerful interfacial bonding) can also be utilized. Two layer bonding via cold weld lamination (FIG. 42(b)), or bonding using a frequent periodic or non-periodic spot welding array or RF heating attachment (FIG. 42(c)) may also be utilized for strong interfacial bonding.

B-4. Aesthetic Design Using Flap Opening Porosity-Changeable Smart Fabrics Activated Solely by Temperature Change.

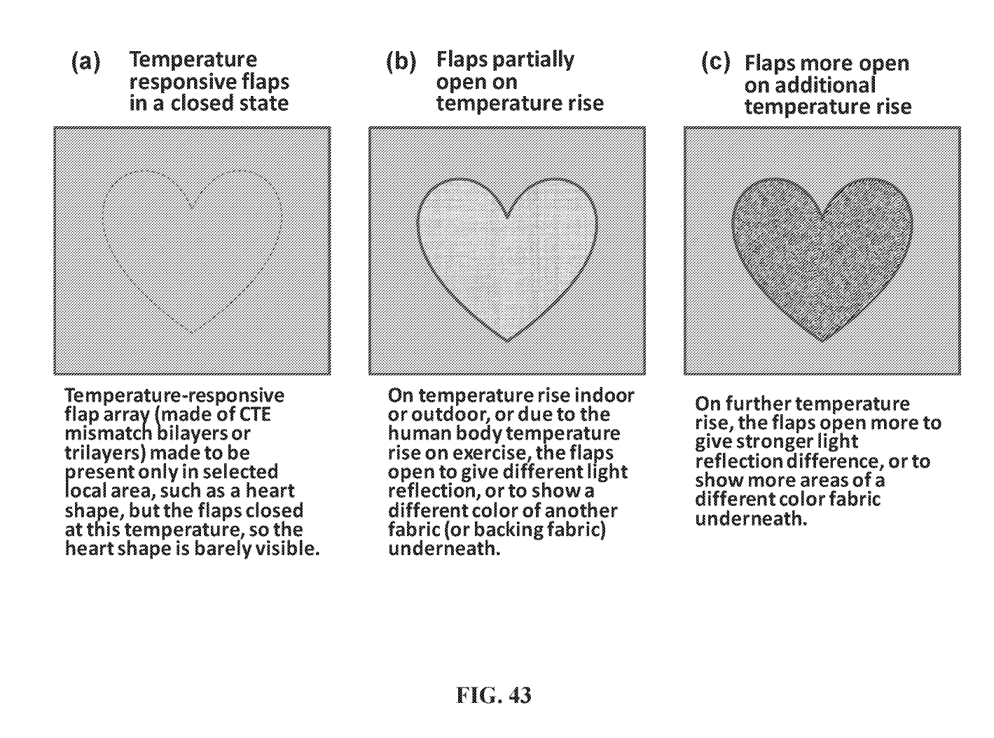

The flap opening (or pore opening) characteristics of the temperature-responsive bendable bilayer structure and associated change in optical behavior could be exploited as a part of apparel design feature. Illustrated in FIG. 43 are some exemplary selected local area color or light-reflection change by temperature-responsive flap opening using a CTE mismatched bilayer fabric. A temperature-responsive flap array (made of CTE mismatch bilayers or trilayers) can be made to be present only in selected local area, such as a heart shape in FIG. 43. When the flaps are closed at a particular temperature, the heart shape is barely visible. On temperature rise indoors or outdoors, or due to the human body temperature rise on exercise, the flaps open to give different light reflection, or to show a different color of another fabric (or backing fabric) underneath. On further temperature rise, the flaps open more to give stronger light reflection difference or a change of color shade, or to show more areas of a different color fabric underneath.

(C) Smart Fabrics Having a Combination of Thermal-Insulation Changeable and Through-Fabric Air Flow Changeable Characteristics

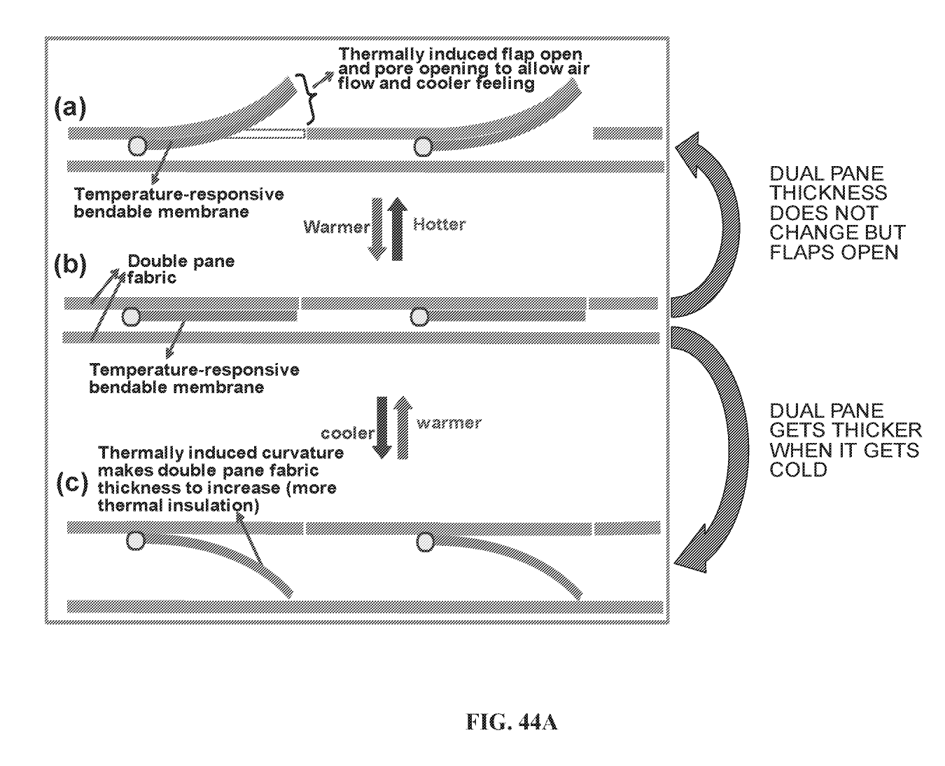

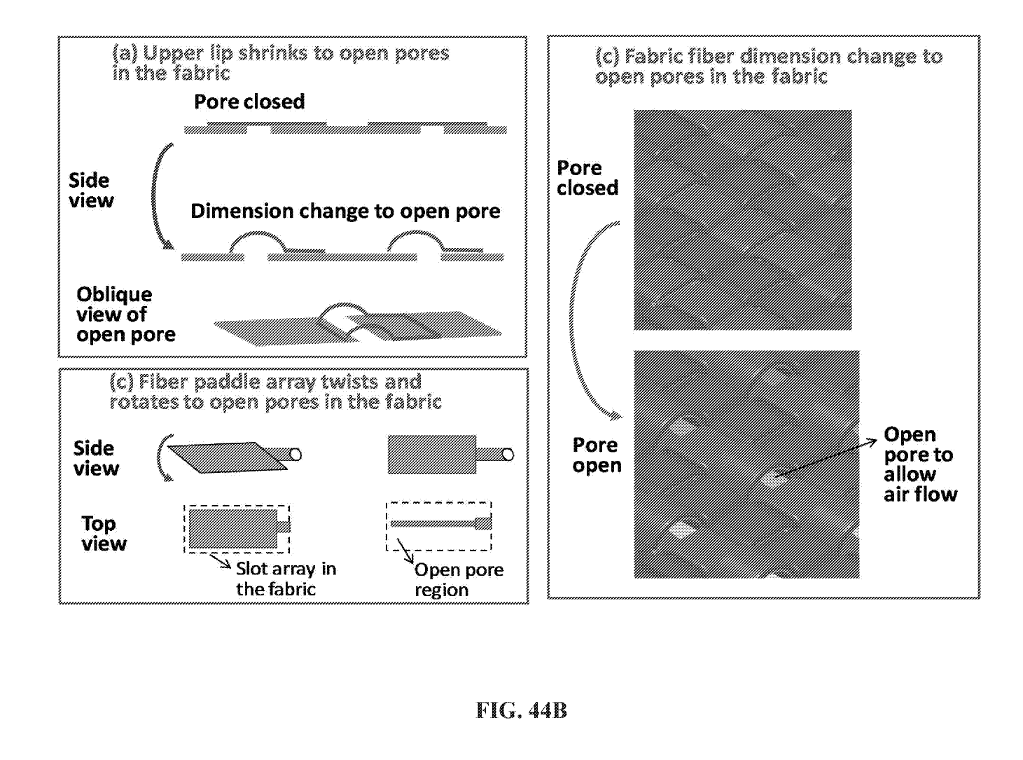

Another embodiment is that the thermally responsive bilayer can also be utilized as a pore-opening mechanism, as described in FIG. 44A. The bilayer with a large coefficient of thermal expansion (CTE) mismatch, such as a negative CTE shape memory alloy paired with a high positive CTE polymer like cellulose acetate, can produce a large curvature, with a height change as large as e.g., 1 cm change over 5° C. temperature change. An array of the bilayer beam is bonded onto the single layer fabric (e.g., by adhesives or stitching marked by yellow dots in the figure). When the temperature gets warmer, the curvature increases and the flap will open, thus allowing a fresh air to come in and making the wearer to feel cooler. The flap in the fabric is made elastic enough to return to the original position when the temperature cools down to the original temperature. In a double-pane fabric, the bending of the bilayer beam array can open the flaps upwards to make the wearer feel cooler, and if the temperature gets too cold, the bilayer bending downwards will increase the fabric thickness (and thermal insulation effect) to make the wearer feel warmer, as illustrated in FIG. 44A.

In addition to the pore opening through flap opening as in FIG. 44(A), there are other possible embodiments of opening small or large pores or gaps in the apparels, draperies, tents, sleeping bags and other fabric related applications, so as to allow increased air flow for cooling or warming. An example is a lateral pore opening, e.g., shown in FIG. 44(B). Shrinkage of curved bilayer responding to temperature change as illustrated in e.g., FIG. 44(B) (a) and (c), or twisting of a bilayer paddle as shown in FIG. 44(B) (c) can be utilized. Other movement of part of smart fabrics in any direction can be enacted by temperature change by design of the bilayer structures as to the position, dimension and characteristics of the component materials.

(D) Smart Fabrics Having a Porosity-Changeable and Through-Fabric Air Flow Changeable Characteristic Activated Solely by Environmental Humidity Changes

In hot or humid environment, a human begins to perspire and feel uncomfortable. If the fabric is made into a smart textile which opens flaps or increases pores when the humidity near the skin of a person gets to more than 65%, fresh air will come in and out to make the wearer feel cooler. In this embodiment section, humidity responsive materials, assembled structures and assembly techniques are disclosed.

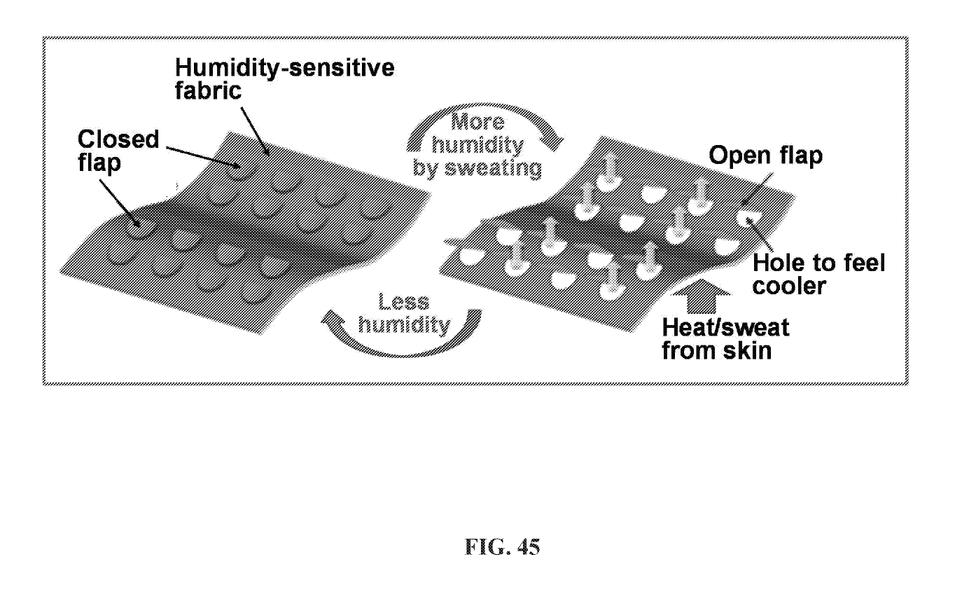

Referring to the drawings, FIG. 45 schematically illustrates an embodiment of humidity-responsive fabric. When the humidity increases such as in the case of a person sweating, the flaps in the humidity-responsive adaptive fabric curve up and open the pore, which will allow cooler air to come into under the fabric to make the wearer feel cooler. When the humidity is reduced, such as in the case of no more sweating, the flaps close and a warmer feeling can be restored.

While some polymers naturally have humidity-responsiveness and the gradient humidity can make the polymer flaps to bend upwards, an important aspects to consider for human apparel applications include the biocompatibility of not causing skin irritation as well as being affordable. A well-known polymer such as Nafion responds well to the presence of humidity gradient and can easily bend up, however, for the purpose of enhanced biocompatibility and minimal skin irritation, as well as for the purpose of lower-cost fabric design, a new fabric material without using Nafion type polymer will be more desirable.

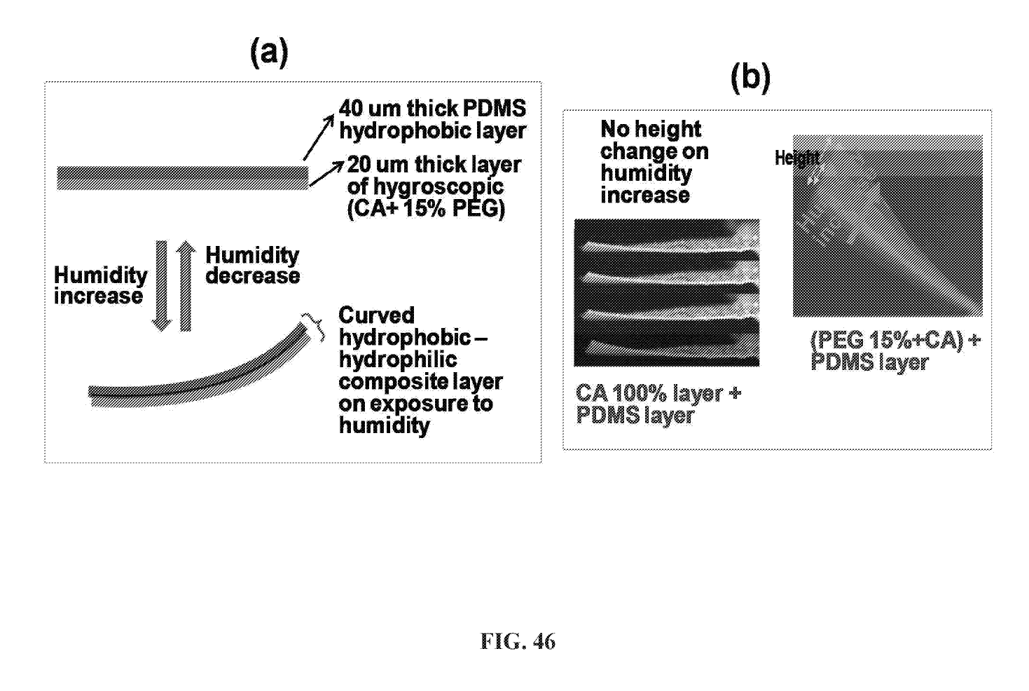

Shown in FIG. 46 is an example of such a new polymer with minimal skin irritation and of low cost, suitable for smart fabric applications. The hygroscopic material polyethylene glycol (PEG) absorbs humidity (water) and expands. If this hygroscopic material is paired with hydrophobic material that does not absorb humidity (water), the bilayer will bend up due to the differential expansion on humidity increase. However, it was found that the use of bare PEG causes a serious problem in that the PEG layer is too sticky for the human skin to feel comfortable in contact. Also, the viscosity of PEG is too low for convenient handling of the material for fabric fabrication.

Therefore, this problem is solved by embedding the hygroscopic PEG material into a less hygroscopic material such as cellulose acetate (CA), which is slightly hydrophobic, so the uncomfortable wet contact feeling is desirably diminished and also the handling for layer fabrication became much easier. This diluted and modified hygroscopic PEG is now paired with (attached onto) a hydrophobic material such as polydimethylsiloxane (PDMS). When the humidity is increased as in the case of human sweating, this bilayer curves up in a desirable fashion due to the differential volume expansion, and vice versa when the humidity is reduced back to the original value, as shown in FIG. 46(a).

The thickness of the humidity-absorbing, hygroscopic, diluted PEG layer in cellulose acetate (CA) is 20 um in the example shown in FIG. 46(a), while the thickness of the paired hydrophobic layer PDMS is 40 um. If the thickness of the hygroscopic layer is increased, the intensity of humidity-response (the curvature increase for a given humidity change) will increase. If the relative thickness of the PDMS layer is increased, the fabric will become more stable but with some compromise in the humidity responsiveness. The optimal thickness can be determined based on specific apparel design needs.

Also, the degree of dilution of hygroscopic PEG in slightly hydrophobic CA has a significant effect on the fabric bending behavior. Shown in FIG. 46(b) is the effect of the volume % change of PEG in CA matrix is. A pure 100% CA only layer (with no PEG mixed) produces no humidity response when paired with a PDMS layer. As the PEG volume % is increased from zero to 5% PEG, to 10% PEG, and then to 15% PEG, the intensity of humidity response (curvature created) increases. The relative humidity levels used for the tests were approximately in the range of 18-20 g/m³.

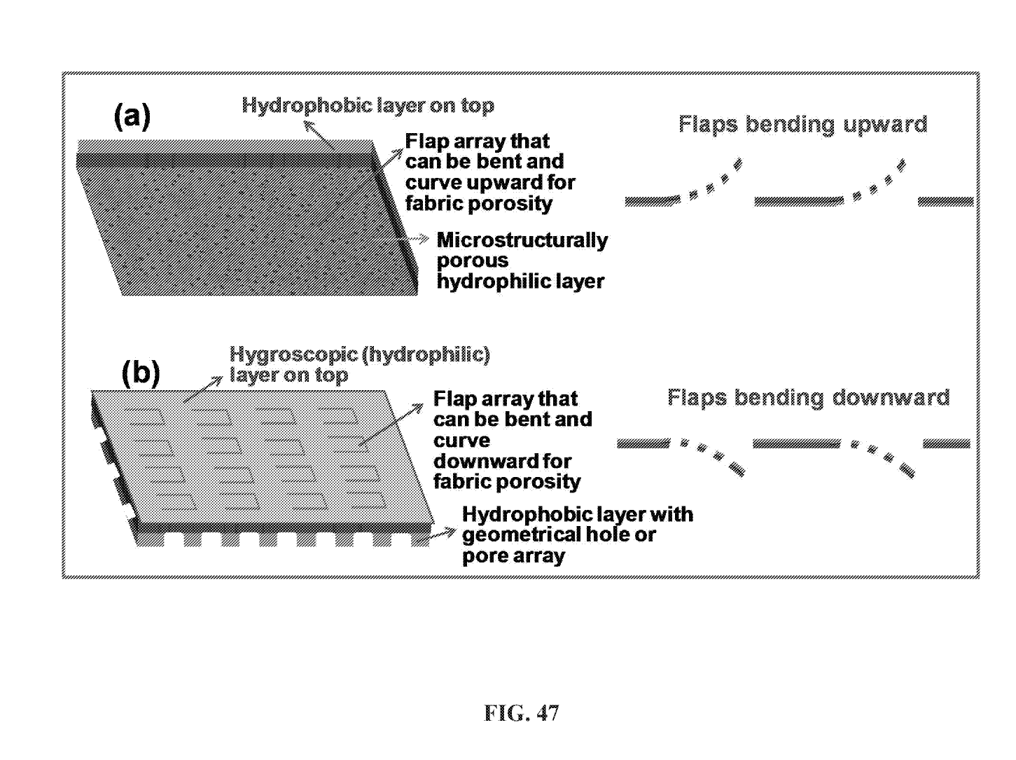

Shown in FIG. 47 are two configurations of bilayer humidity responsive polymer that can be bent up (or down) when the humidity and temperature are increased. The drawing in FIG. 47(a) shows the hydrophobic layer on top of the hygroscopic (hydrophilic) layer, so as to induce the fabric to bend upward when humidity is increased. The drawing in FIG. 47(b) shows the hygroscopic (hydrophilic) layer positioned above the hydrophobic layer (which is made to contain geometrically or microstructurally introduced holes or pores so that the humidity from underneath can reach the upper hygroscopic layer, and the introduction of humidity can bend the fabric downward, instead of the typical upward direction. Therefore, the fabric can be made to also bend downward depending on the design and configuration selected.

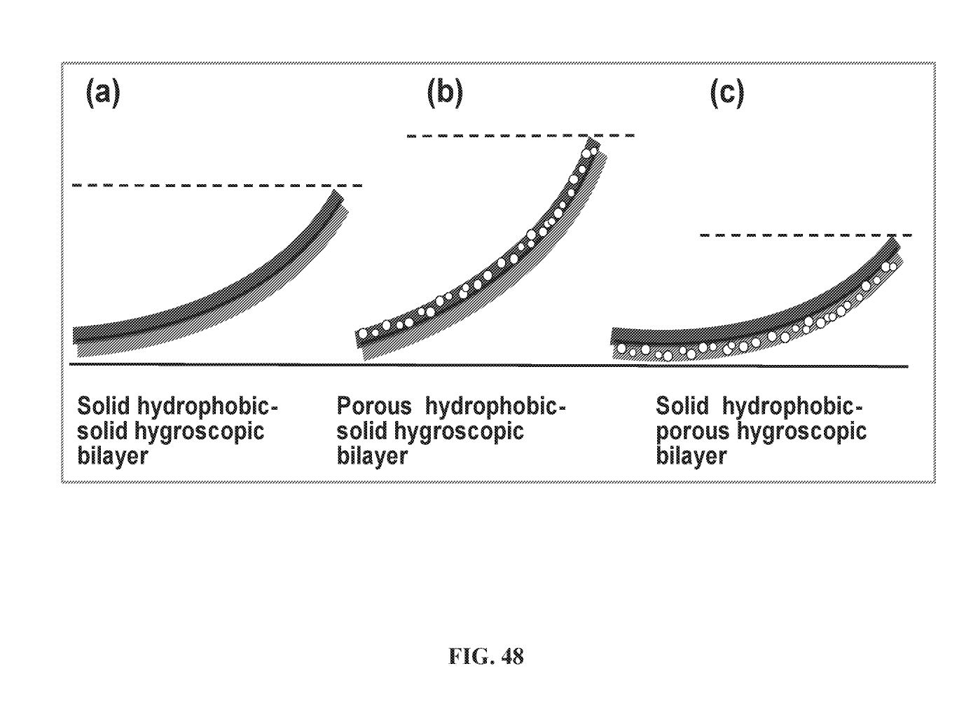

Another embodiment is to alter the porosity of either of the hydrophobic layer or the hygroscopic layer. Shown in FIG. 48 is the effect of porosity in hydrophobic layer vs the effect of porosity in hygroscopic layer. When the porosity is increased, the effective elastic modulus becomes reduced and the layer becomes less stiff. Therefore such a porosity in hydrophobic layer enhances the curvature on humidity exposure. If the porosity in the lower hygroscopic layer is increased, the pores enhance the humidity uptake speed and hence the fabric responds faster to the humidity change. Such an increased kinetics may be useful for some apparel applications. The reduced elastic modulus in the hygroscopic layer relative to the solid hydrophobic layer will make the hygroscopic layer less stiff and thus decrease the curvature. As long as the extent of curvature on humidity exposure is more than sufficient, the presence of porosity in the hygroscopic layer is beneficial for faster response time.

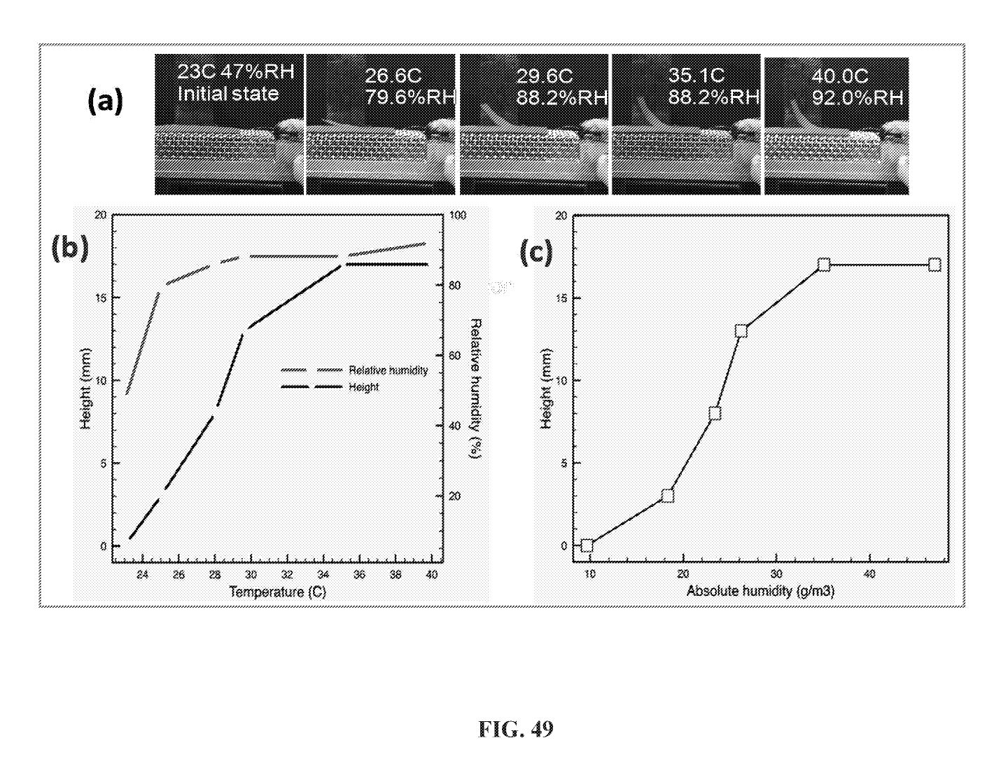

Polyethylene terephthalate (PET) is one of the most common fibers for clothing, and is a well-known thermoplastic material in the polyester family. Another example of the humidity-responsive bilayer is shown in FIG. 49. The polymer layer (and the flap array structure within) is composed of 150 um thick 100% polyester woven fabric with a synthesized humidity-responsive polymer (made of 30 um PET+60 um thick (CA-10% PEG)) attached onto the bottom face of the PET layer. It is clearly shown in FIG. 49(b) and FIG. 49(c) that the flap opening height is dependent on humidity as well as the temperature.

Yet another embodiment is the creation of humidity-responsive fabric which is also stretchable and flexible, as id desirable for some apparel applications. Human skin is stretchable and conforms to the overall change of shape of the muscle and flesh underneath. It will be desirable if the apparel we wear is stretchable and conforms to our body shape change as we move or reposition our body, yet is also humidity-responsive. Human body is also somewhat hydrophobic, which protects the body skin from outer hydrophilic invasion. In order to create such a polymer, a hydrophobic/hydrophilic mixed molecule polymers have been synthesized. PDMS is utilized as the hydrophobic component and PEG as a hydrophilic component. The advantages include a relatively synthesis method, inexpensive, an easy control of hydrophobic and hydrophilic structures and associated properties.

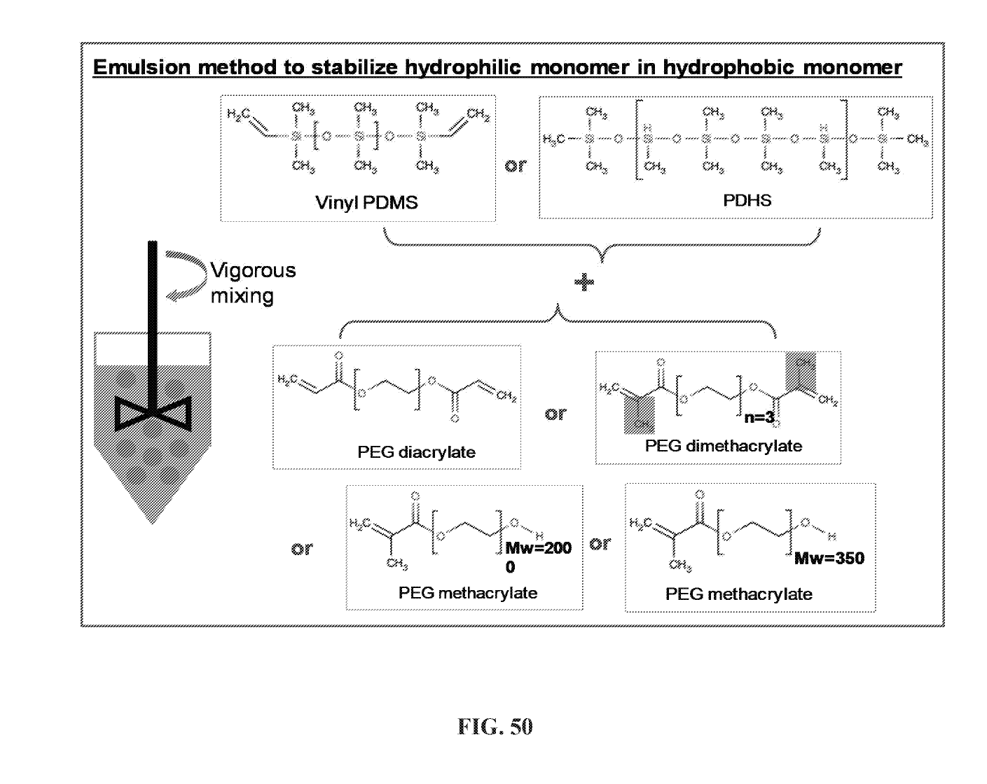

As hydrophobic and hydrophilic materials tend to repel each other and do not mix well, an emulsion method was utilized in this embodiment to stabilize hydrophilic monomer in hydrophobic monomer. A monomer such as PEG dimethacrylate, PEG methacrylate or PEG diacrylate works as a surfactant when water is added and the reactive sites are placed outside of water emulsion. It was found that PEG acrylate did not work because the hydrophobicity of reactive position is not sufficient. After weighing of each of the selected monomers of at least one hydrophobic monomer (such as Polydihexylsilane (PDHS), vinyl PDMS, etc) and one hydrophilic monomer (selected from various monomers of PEG dimethacrylate, PEG methacrylate, PEG diacrylate), as shown in FIG. 50, and combining them, a vigorous mixing (e.g., 400 rpm mixing and 4,000 rpm degassing) was carried out to make small particle emulsion which can improve the stability of e.g., PEG monomers in the PDMS elastomer. A small amount (ppm level) of Pt was also used for enhanced polymerization (curing agent for PDMS). The hydrophobic/hydrophilic mixture was then cast into a layer and thermally cured at ˜110° C./20 minutes. Amphiphilic solvent such as ethanol will stabilize the hydrophobic reactive site and the polymerization doesn't occur because the reactive site will be stabilized inside emulsion of ethanol.

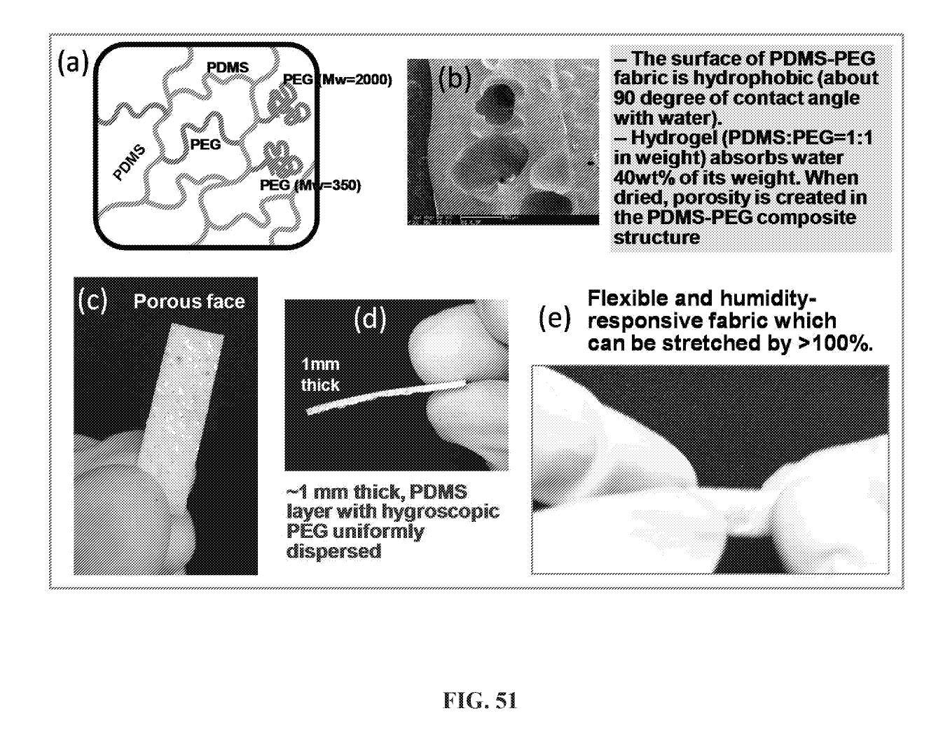

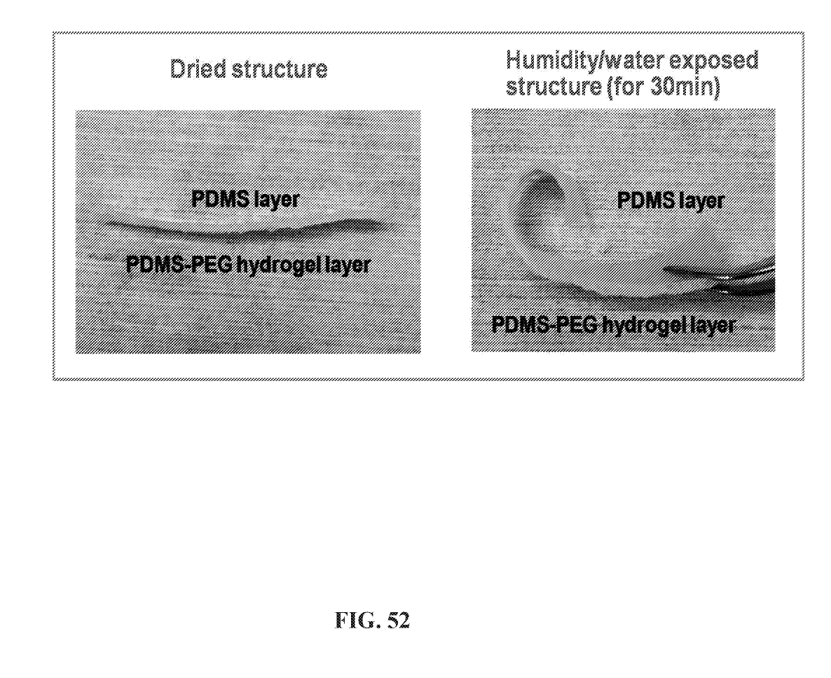

Shown in FIG. 51 is a well-mixed hydrophobic/hydrophilic polymer structure, with different MW PEGs combined. A PEG material with a higher molecular weight (e.g., MW=2000 vs MW=350) is more hygroscopic. A proper mix of higher MW and lower MW PEG can be utilized to control the degree of hygroscopic properties (and responsiveness to humidity and water). If dried in the water-absorbed state, the evaporation of water can create a porous structure which can be utilized to control the elastic modulus as well as the extent of humidity-responsiveness and the kinetics of response as well. The hydrophobic/hydrophilic polymer structure can also be paired with another layer of PDMS, as shown in FIG. 52, which responds to humidity and creates a curvature.

For reduction to practice, several experimental samples of humidity-responsive, dimension-changeable structures (flap openable structures) were fabricated and demonstrated in the following examples.

### EXAMPLE 9

A humidity-responsive textile was constructed by laminating hygroscopic film below the flap pattern in the fabric which has knitted structure and composed of 60% polyester, 39% rayon and 1% spandex. Hygroscopic film was prepared by printing a solution of cellulose acetate and polyethylene glycol dissolved in acetone with the weight ratio of cellulose acetate to polyethylene glycol being 9 to 1, and was dissolved in acetone. Hygroscopic film was laminated with PET (polyethylene terephthalate) film and the fabric using acrylic adhesive and hot pressed and hygroscopic film and PET film was 30 μm each. And then, the flap was cut out on three sides of a rectangle using laser cutter (2.5 cm length and 1.3 cm width) within a 5 cm×5 cm area fabric.

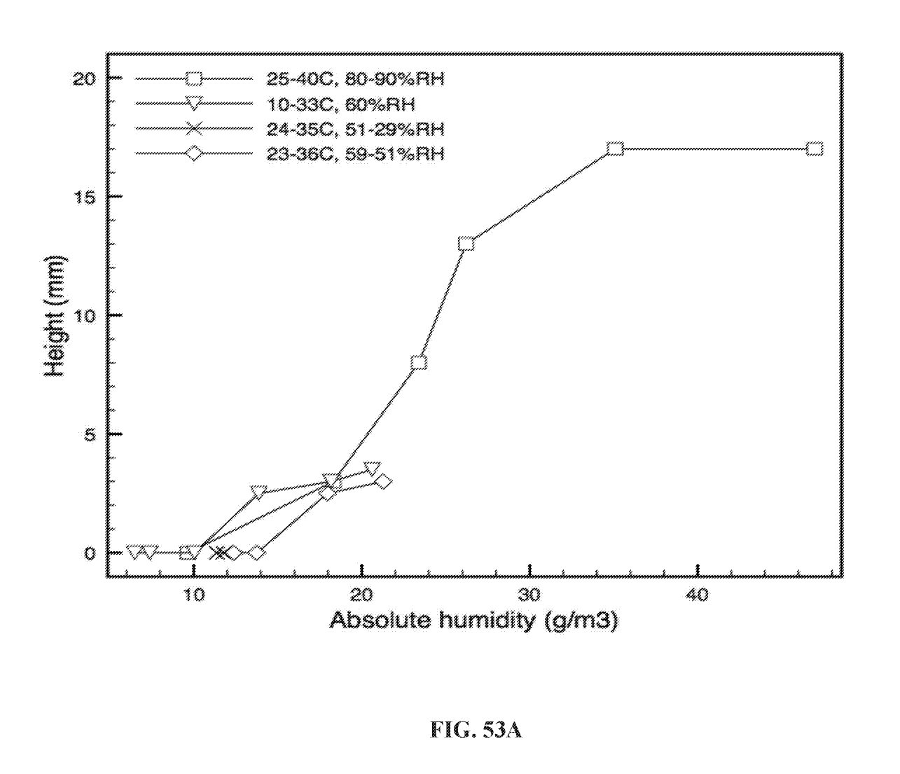

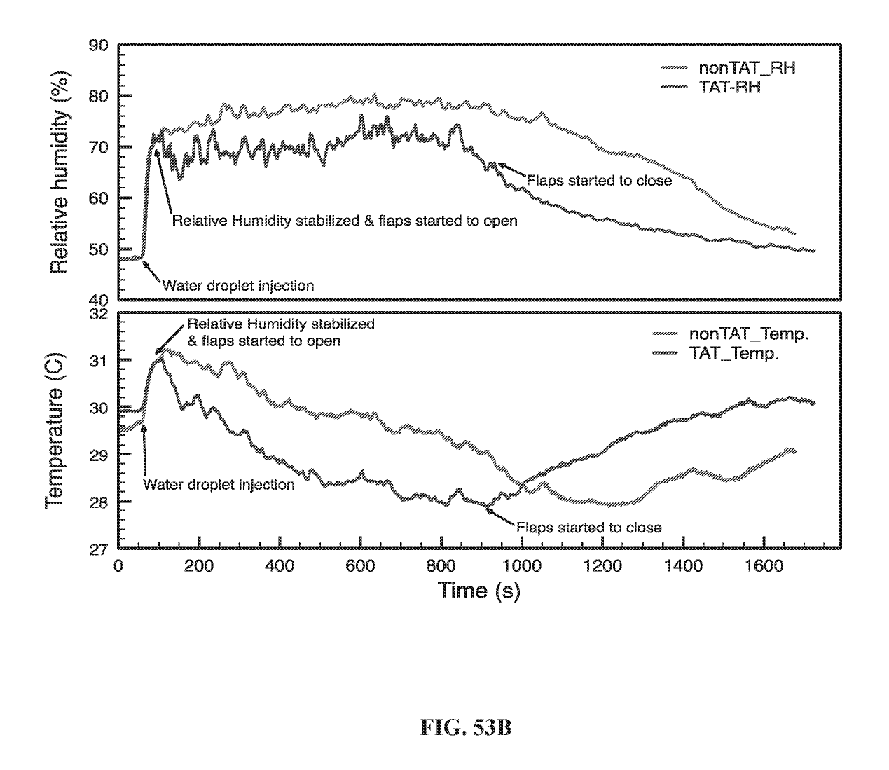

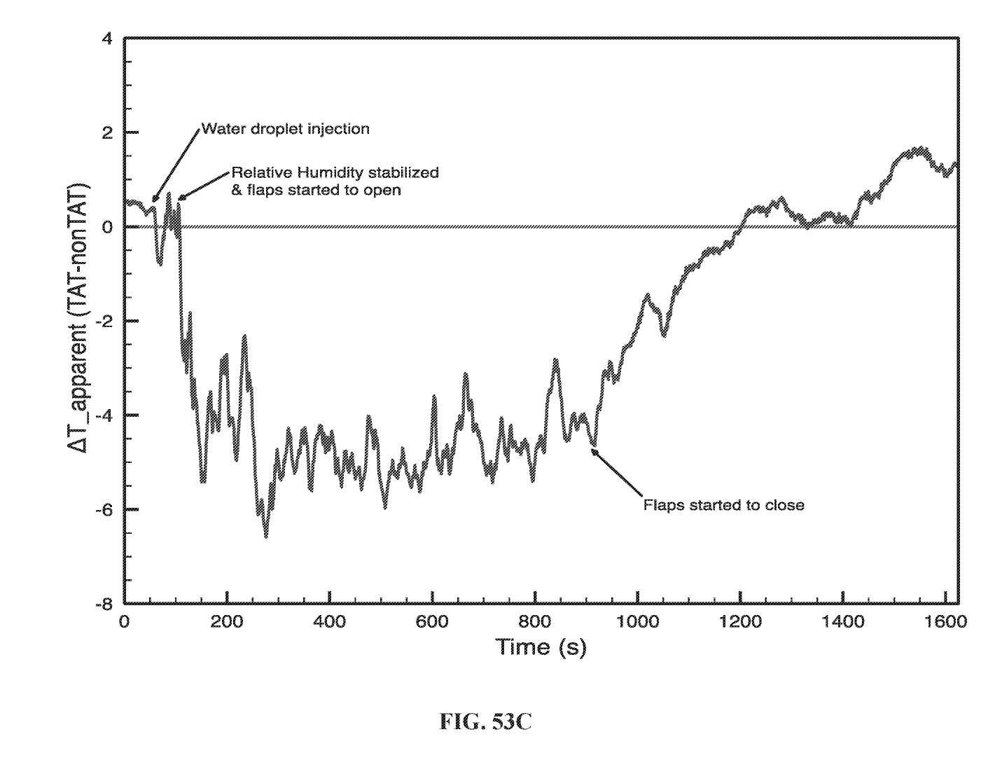

The flap opening degree on increasing the absolute humidity was estimated by measuring the height of the edge of flap from the base fabric horizontal plane. Various humidity and temperature conditions were tried, with the height obtained varying up to 17 mm as absolute humidity changed from 6 g/m3 to 47 g/m3 (FIG. 53(A)).

The cooling effect of humidity-responsive flap openable textile was confirmed to be 4° C. by measuring temperature change below the textile upon humidity change in an appropriately sealed chamber, with the top opened and covered with humidity-responsive textile. The heating element was placed in the bottom. A voltage was applied to keep a constant temperature 37° on the surface, and then 100 ul of water was inserted over the heating element using a syringe to increase the humidity while recording the temperature at various locations within the chamber.

The blue line in FIG. 53(B) indicates the humidity and the temperature changes of humidity responsive flap openable textiles inside the insulated box, and the red line indicates those of textiles which don't have flaps on the textiles. FIG. 53(C) indicates the difference of the apparent temperature between the humidity responsive flap openable textiles and the textile which does not have flaps.

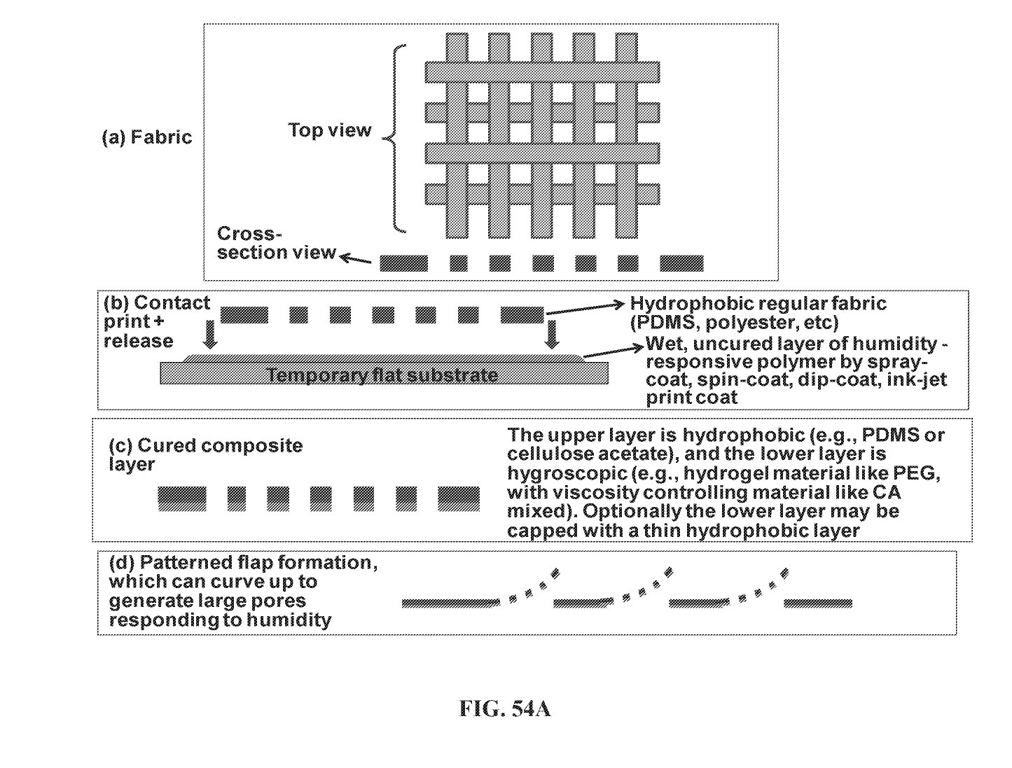

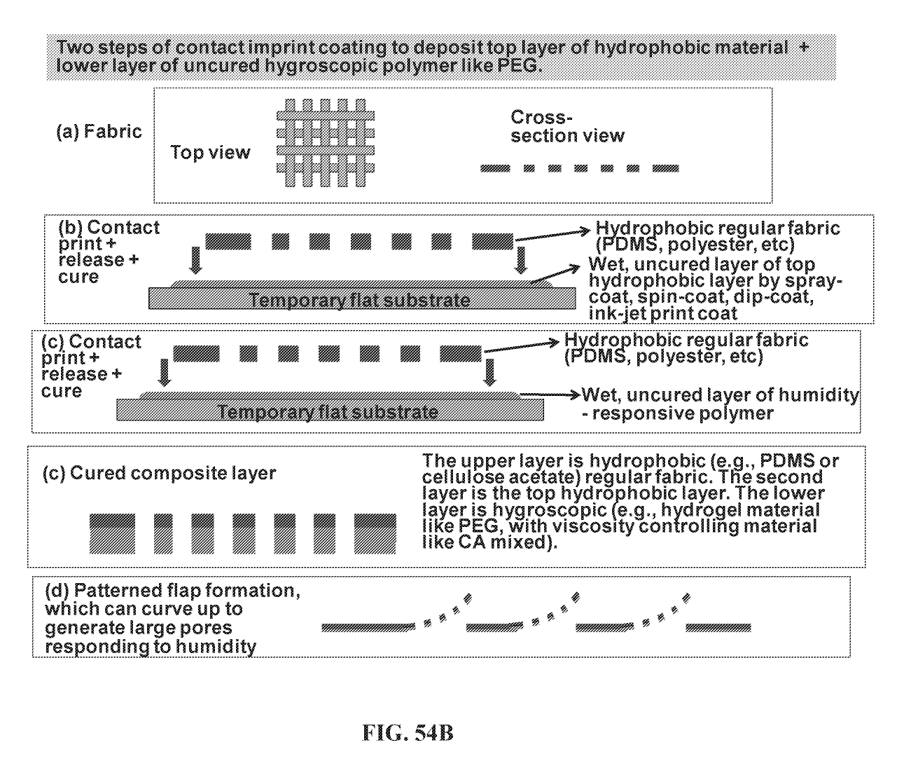

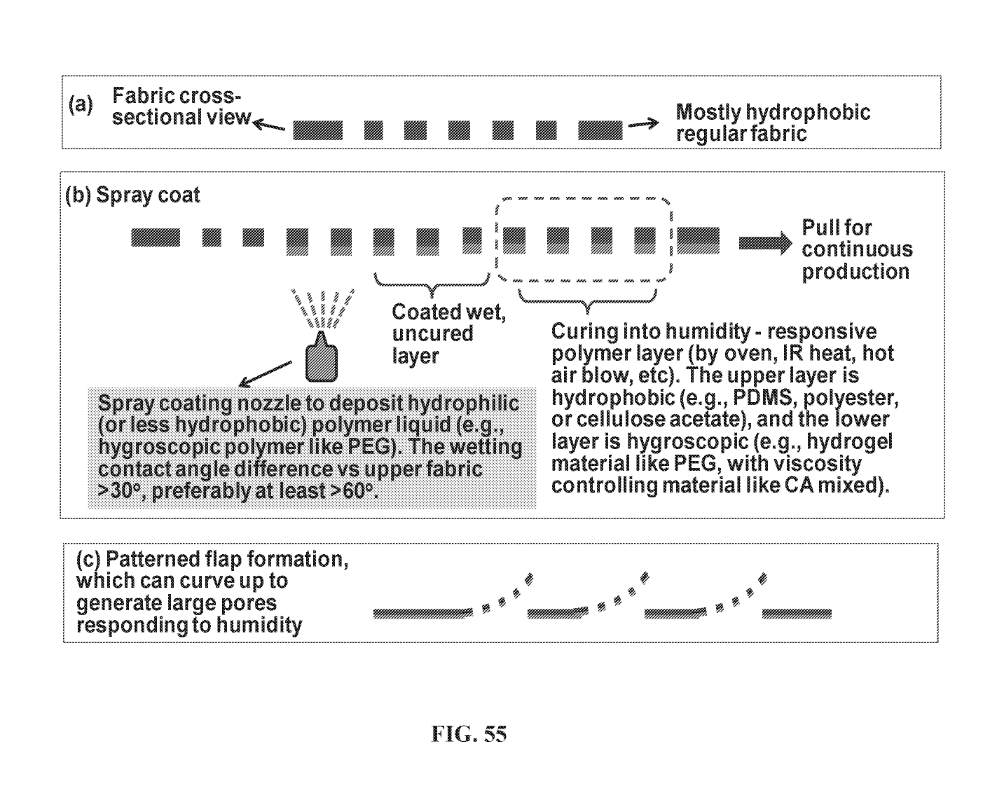

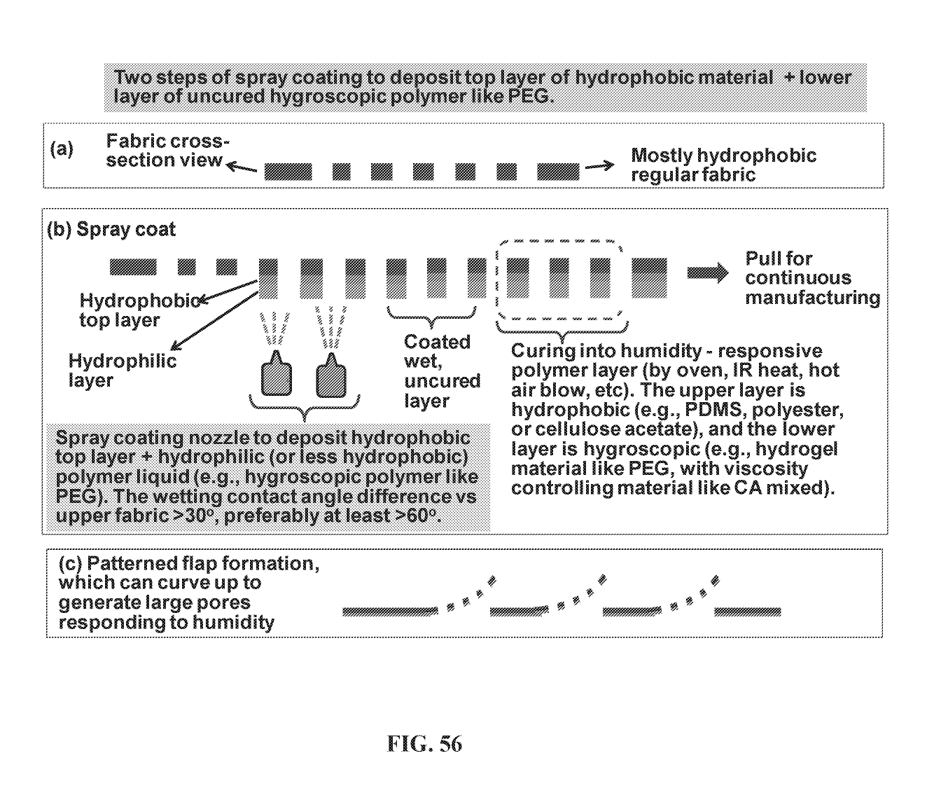

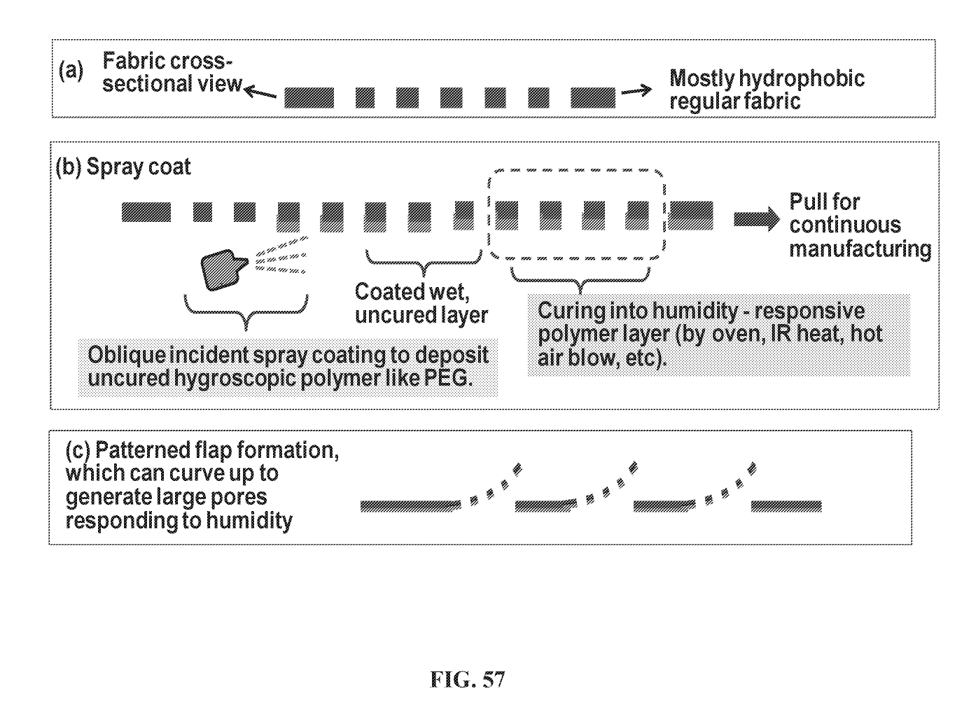

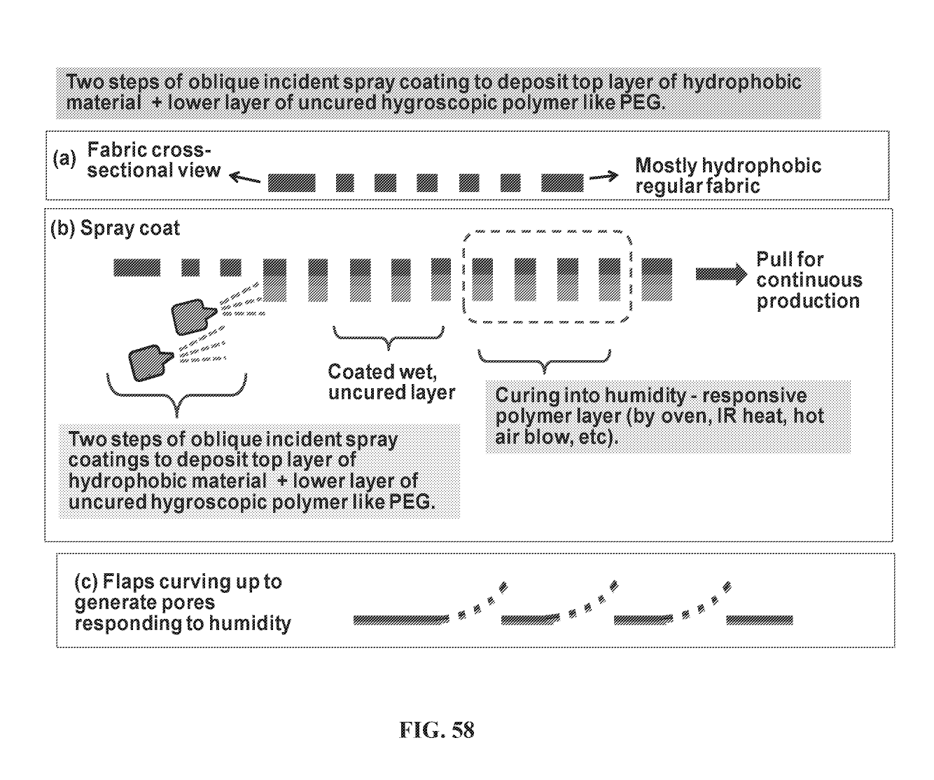

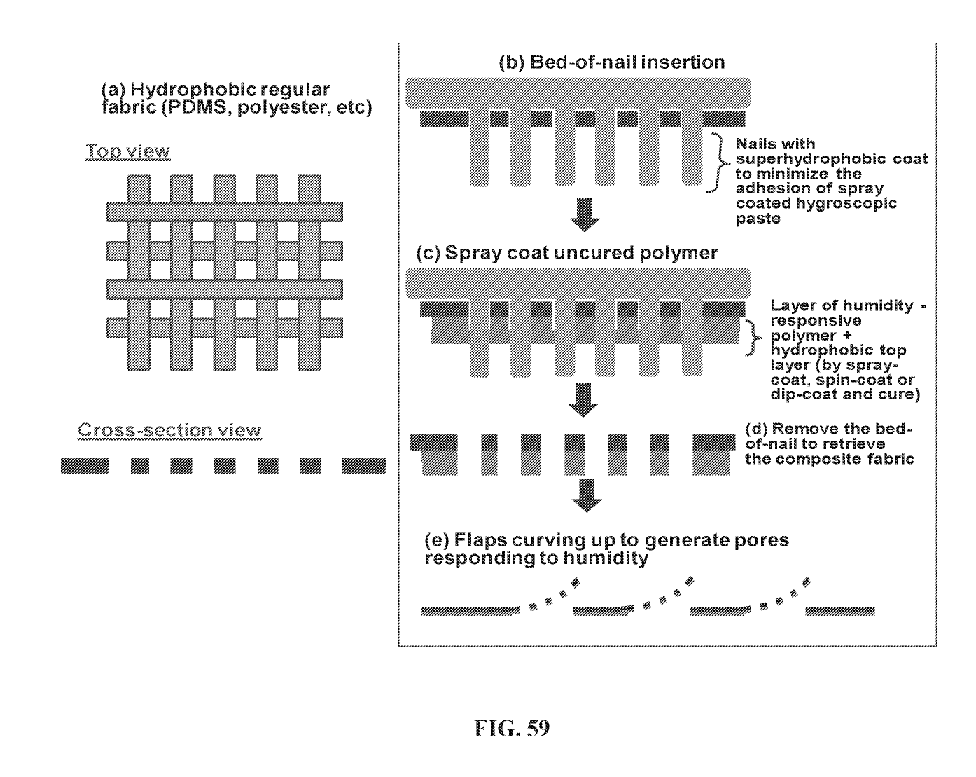

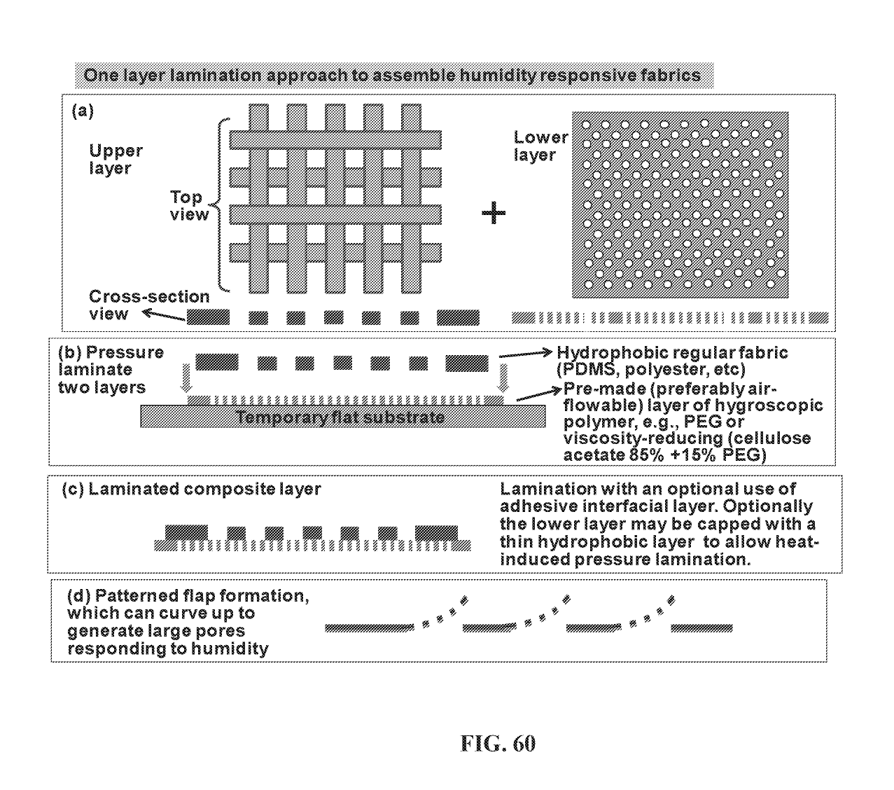

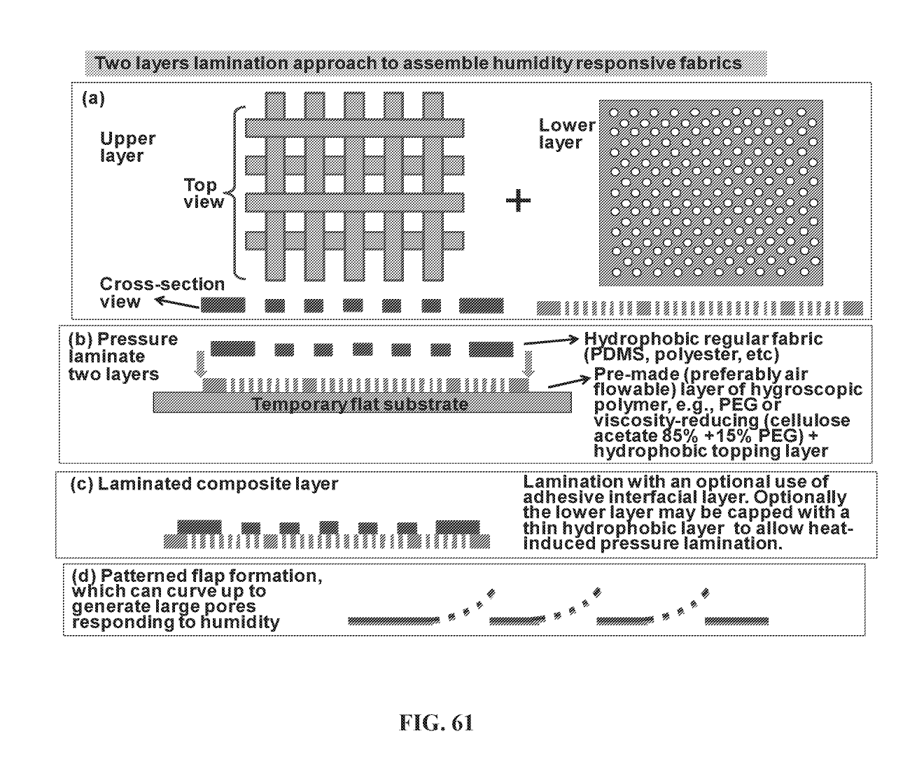

Various humidity-responsive polymer structures need to be assembled into a desirably configured fabrics to produce apparels that can be worn by people depending on their choice and needs. Shown in FIG. 54 to FIG. 61 are various assembly methods and possible manufacturing techniques for constructing the humidity responsive fabrics. Imprinting technique, spray coating technique, pressure lamination technique and other approaches can be utilized according to this embodiment as described in these drawings.

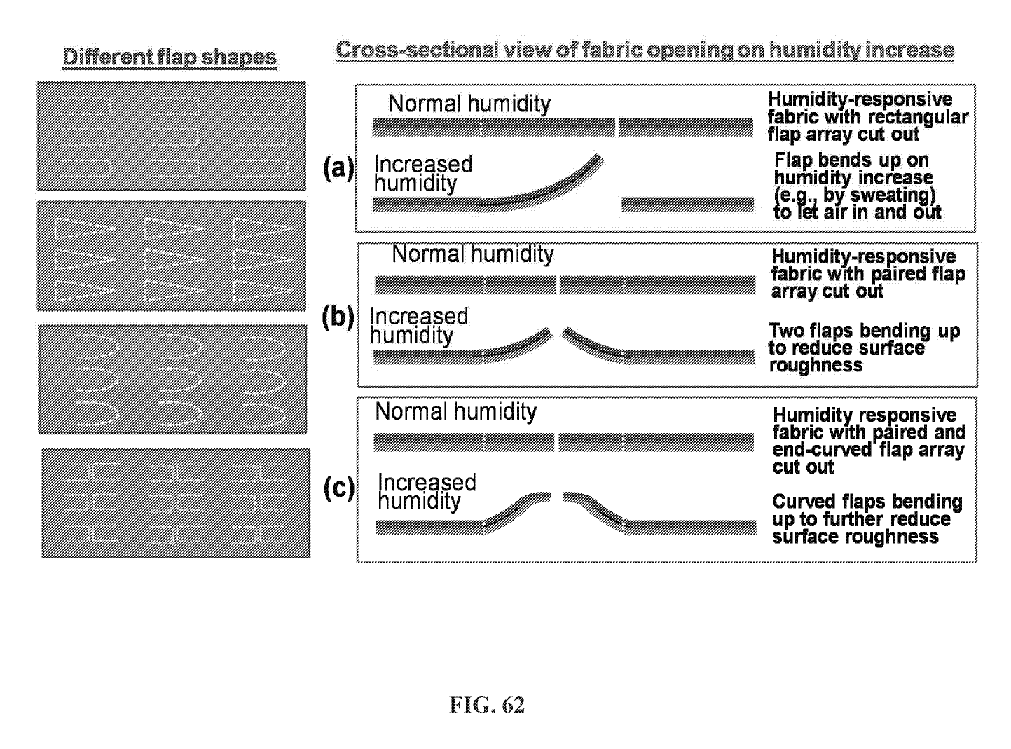

Shown in FIG. 62 are some possible geometry of flaps (left figure) such as rectangular, square, oval, circular or random shape, depending on the need and fashion design. Usually a higher aspect ratio of the flaps tends to provide more height change of the flaps and more cooling effect under human sweating conditions. Shown on the right side of FIG. 62 are possible configurations of the flaps. While these open flaps do not directly touch the human skin, the protruding nature could give some frictional feeling or less comfortable feeling to the wearer. The flaps can be split to a symmetrical configuration, e.g., two, three, four or six smaller flaps opening and closing simultaneously. The end of flaps can be optionally bent so as to provide less frictional feeling when touched by the wearer. Optional addition of edge coating is not excluded.

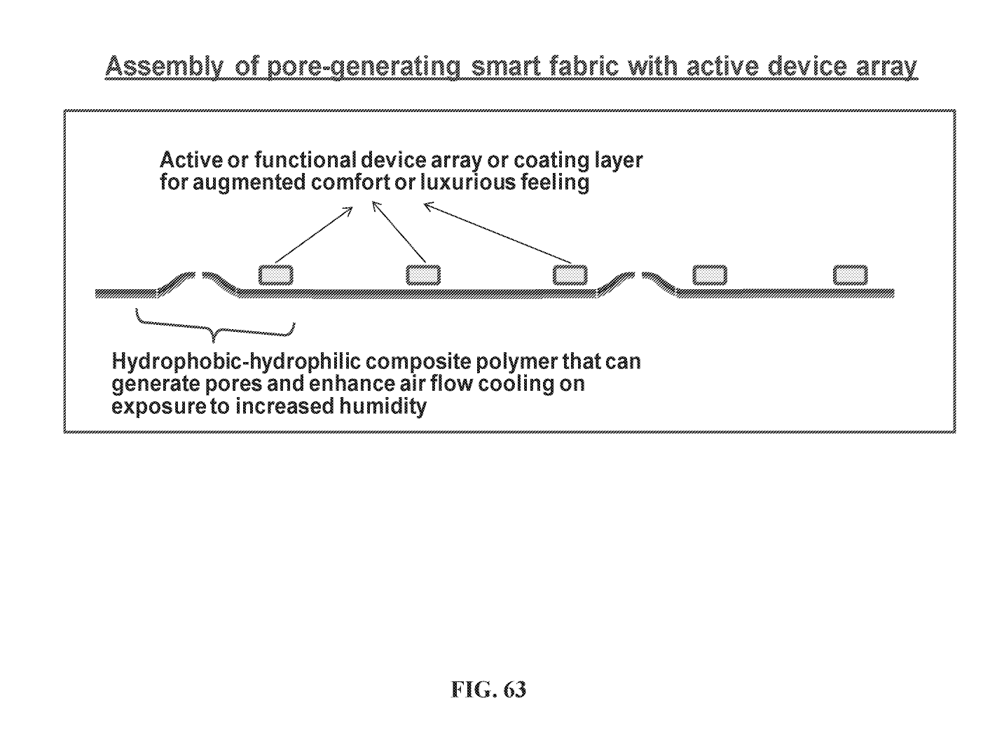

For augmented comfort or luxurious feeling of the apparels, active functional device array can optionally be added to the humidity responsive fabrics of this embodiment as shown in FIG. 63. According to the embodiment, such functional device array or coating layer that can be added on the surface of the humidity responsive fabrics includes solar cell array, UV or NIR or IR reflective layer, UV or NIR or IR absorbing layer, UV or NIR or IR transmitting layer, superhydrophobic non-wettable or water-proof layer, water evaporation cooling device, batteries for heating, thermoelectrics for cooling/heating, ultrasonic device for vibration for easier air transport through fabric, de-ordorant device or layer, color-changing device or layer, scent-generating device, acoustic or radio type device, display device, camera, sensors (for temperature, humidity, UV light, gas, human pulse, noise, etc) Wi-Fi receiving or transmitting device, etc.

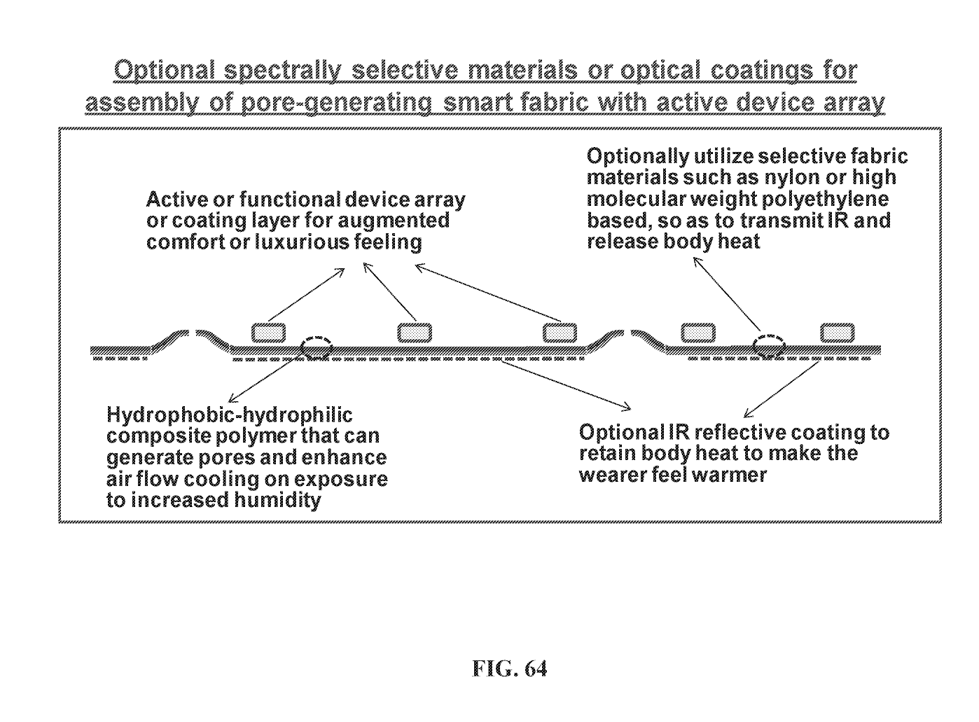

Shown in FIG. 64 is a more specific embodiment for the humidity responsive smart fabric to retain or easily release body heat of the apparel wearer. In cold weather or lower-temperature-setting circumstances in a building or housing, it is desirable to retain as much body heat as possible, for example by using IR absorbing fabric or added coating on the outside, and IR reflecting coating on the inside surface.

For warm weather environment, according to some embodiments, some specific selected fabric materials (at least the inner fabric) can be utilized such as nylon or high molecular weight polyethylene based, so as to transmit more of IR and release body heat. The body heat emission (radiation) spectrum is near ˜8-15 um wavelength IR, and some specific fabric materials such as nylon or high molecular weight polyethylene based materials allow much more IR transmission than other fabrics such as cotton. Additional nanostructuring can also be applied to further enhance the IR reflecting or IR transmitting characteristics of the fabric material or coating material. However, for the case where it is more desirable to retain the body heat, e.g., in cold weathered region, it is desirable to add an IR reflecting coating to the inside surface of the fabric as illustrated in FIG. 20.

In this disclosure, the processing or assembly operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

While this patent document contains many specifics, these should not be construed as limitations on the scope of any disclosed technology or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

With regard to drawings and embodiments, only a few exemplary embodiments are described. Other embodiments and their variations and enhancements can be made based on what is described and illustrated. Various applications of the structures that enables shape change, thickness change, porosity change, or thermal insulation change include structures for sensors and actuators, as well as control/adjustment of temperature, humidity or gas-permeability, and liquid permeability, are possible for wearable or non-wearable devices and structures. The disclosed structures are also applicable to mechanical, thermal, optical, and electrical designs/structures, with the application to materials comprising fabrics (apparels, curtains, draperies, back packs, outdoor or sporting goods structures including tents).

(E) Passive or Active Control of Optical, Thermal, Acoustic, Display, Aesthetic and Electronic Characteristics Either Activated by Temperature Changes or Powered by Electrical Energy Supplied by Energy Storage Devices, Energy Generating Devices or Provided by Self-Sufficient Solar Cell Devices

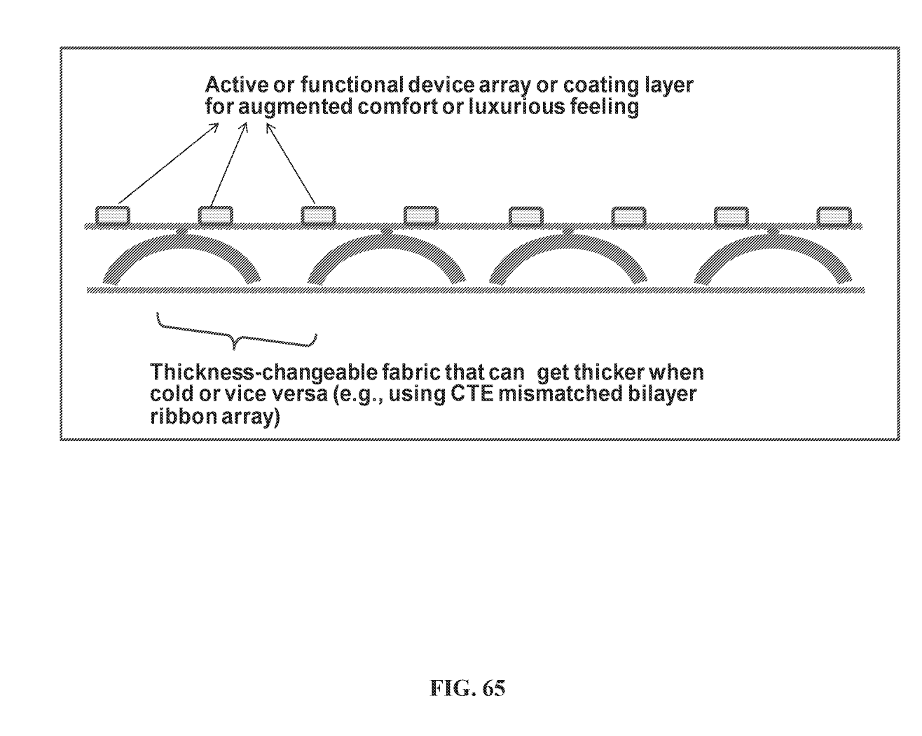

For augmented comfort or luxurious feeling of the apparels, active functional device array can be added as shown in FIG. 65. Such functional device array or coating layer added on the surface of thickness-changeable fabric includes solar cell array, UV or NIR or IR reflective layer, UV or NIR or IR absorbing layer, UV or NIR or IR transmitting layer, superhydrophobic non-wettable or water-proof layer, water evaporation cooling device, batteries for heating, thermoelectrics for cooling/heating, ultrasonic device for vibration for easier air transport through fabric, de-odorant device or layer, color-changing device or layer, scent-generating device, acoustic or radio type device, display device, camera, sensors (for temperature, humidity, UV light, gas, human pulse, noise, etc) Wi-Fi receiving or transmitting device, etc.

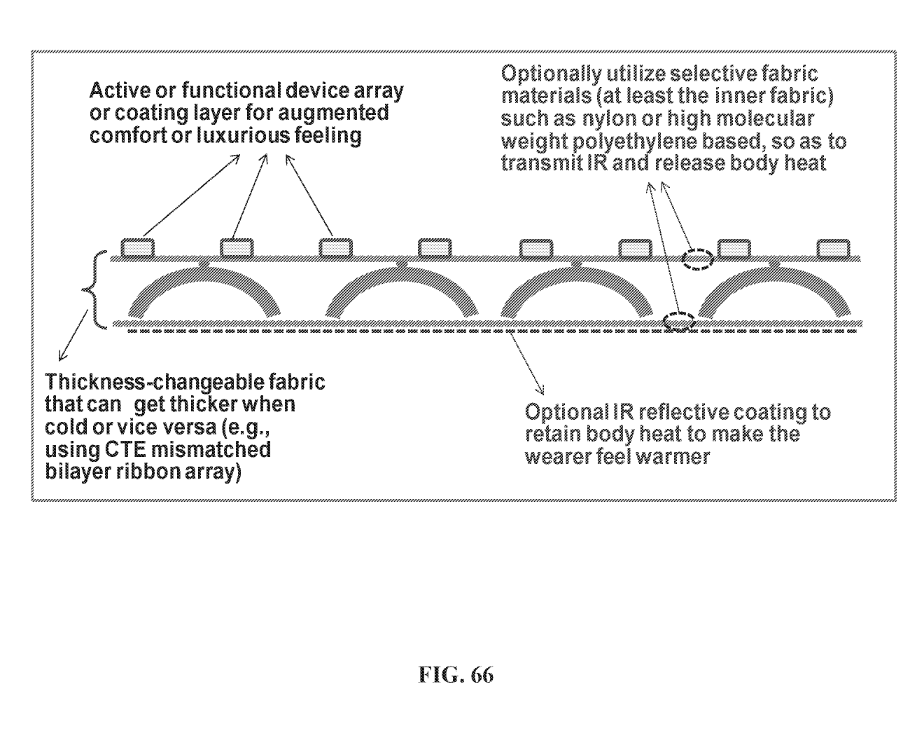

Shown in FIG. 66 is a more specific embodiment for the thickness changeable smart fabric to retain or easily release body heat of the apparel wearer. In cold weather or lower-temperature-setting circumstances in a building or housing, it is desirable to retain as much body heat as possible, for example by using IR absorbing fabric or added coating on the outside, and IR reflecting coating on the inside surface.

For warm weather environment, according to some embodiments, some specific selected fabric materials (at least the inner fabric) can be utilized such as nylon or high molecular weight polyethylene based, so as to transmit more of IR and release body heat. The body heat emission (radiation) spectrum is near ˜8-15 um wavelength IR, and some specific fabric materials such as nylon or high molecular weight polyethylene based materials allow much more IR transmission than other fabrics such as cotton. Additional nanostructuring can also be applied to further enhance the IR reflecting or IR transmitting characteristics of the fabric material or coating material.

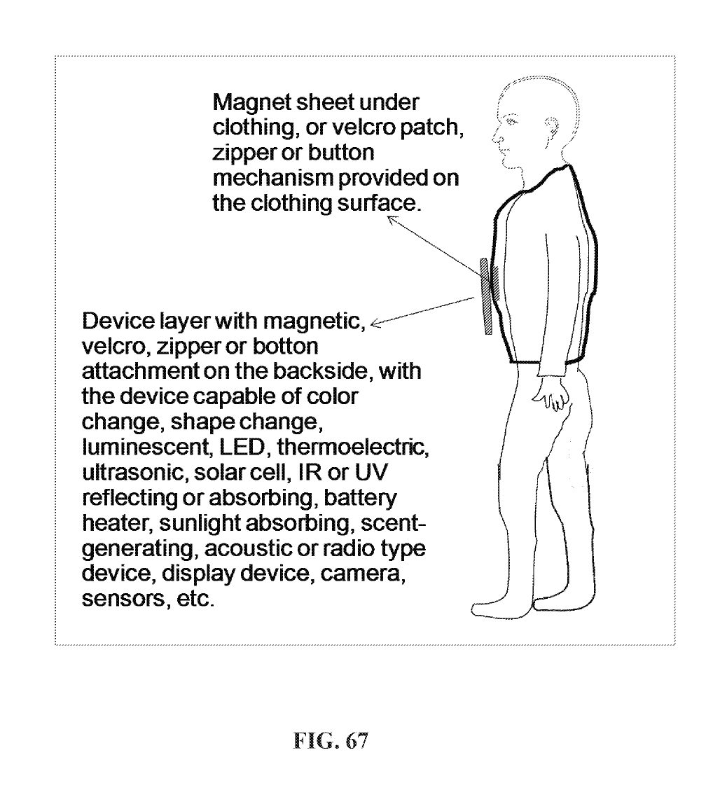

The functional devices shown in FIG. 65 and FIG. 66 need to be integrated into textiles and apparels using some attachment methods. Shown in FIG. 67 are some example methods of how functional device layer can be attached onto the fabric using magnetic, velcro, zipper or button attachment mechanism. The thickness-changeable fabrics with thermal regulation capabilities together with color change or shape change induced by CTE mismatched bilayer material, can thus be provided with other functional properties. Such a convenient attachment/detachment mechanism allows the devices to be utilized without having to be washed or dried in a laundry process, as washing and drying process can introduce humidity and temperature that the functional devices may or may not survive.

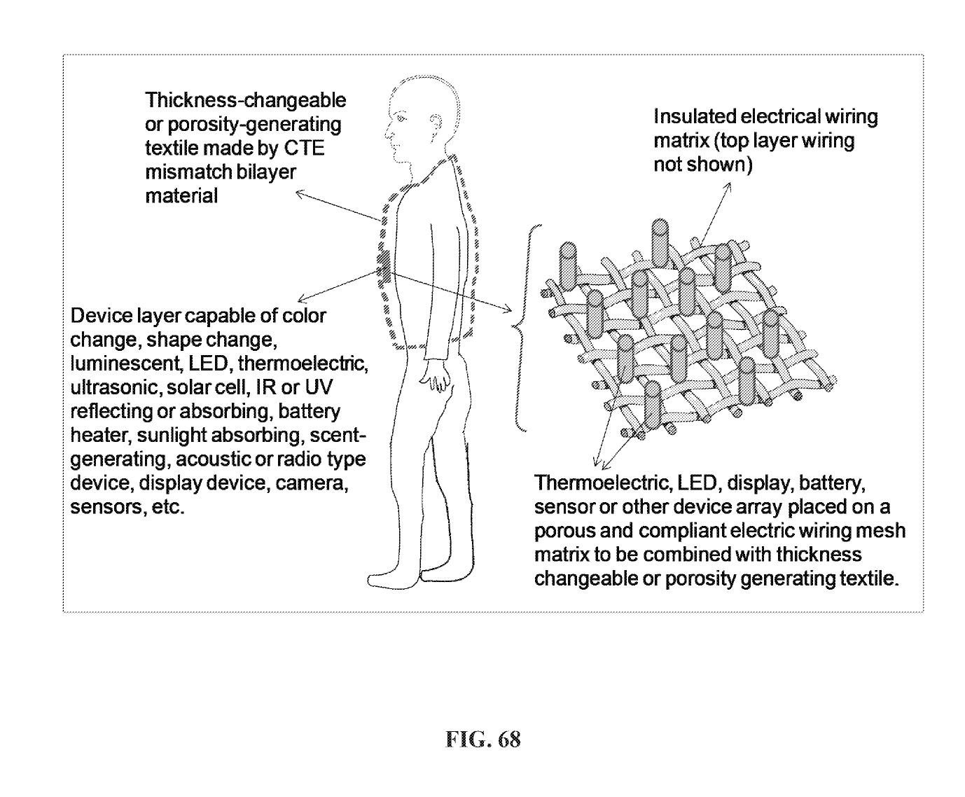

When functional devices are incorporated onto a smart textile, care should be taken in such a way that the natural convection (air flow) through the fabric itself is not blocked. For example, in the case of LED, thermoelectric device, battery device, solar cell device, etc being integrated into a fabric, the electrical wiring has to be configured in such a way the plenty of porosity and associated easy air flow is guaranteed. Also, mechanical flexibility needs to be provided so that the wearer does not feel too much of stiffness and uncomfortableness due to the presence of the functional devices attached onto the fabric. An example of such a desirable integration of functional devices is shown in FIG. 68, which shows a combined thickness-changeable or porosity-generating textile with functional device array placed on a porous and compliant electric wiring mesh matrix.

Synergistic Effect

In the case that the thermally adaptive textile comprises thermally dimension changeable structures (such as thickness-changeable or flap-openable fabrics), and is combined with active thermoelectric cooling devices underneath (FIG. 68), there is an additional synergistic benefit. The dumped heat from the active thermoelectric cooling will be going outward to warm the passive thermally adaptive textile outside the thermoelectric cooler to raise the temperature of the bendable bilayer array so that the adaptive clothing becomes thinner or the flaps get opened for additional cooler feeling.

In some embodiments, an article of manufacture may include a dual pane fabric arrangement comprising a first pane of fabric and a second pane of fabric separated by an intra-layer gap and an insert layer disposed in the intra-layer gap, wherein the insert layer causes a thickness of the intra-layer gap to change responsive to changes in ambient temperature. Various embodiments of the article, the dual pane fabric arrangement and the insert layer are described throughout the present document. For example, FIG. 1 discloses an insert layer (called thermally adaptive interlayer or simply interlayer). For example, some embodiments are illustrated and described with respect to FIG. 7, FIG. 10, FIG. 11, FIG. 14, FIG. 19, FIG. 22, FIG. 23, FIG. 24, FIG. 25, FIG. 32, FIG. 33 to FIG. 40, and FIG. 66 to FIG. 68.

In some embodiments, an article of manufacture includes a single pane fabric having cut-out portions and an array of bilayer flaps attached onto top or bottom surface of cut-out portions of the single pane in such a way that when the array of bilayer flaps bends upon a temperature change, a corresponding attached fabric portion in contact with each of the flaps also bend upward or downward to alter flow of ambient medium in and out of the fabric plane. Various embodiments of the article, the single pane fabric and the array of flaps are described throughout the document.

In some embodiments, an article of manufacture includes a dual pane fabric arrangement comprising a first pane of fabric and a second pane of fabric separated by an intra-layer gap, wherein at least one of the first pane and the second pane comprises an array of bilayer attached flaps move upward or downward controllable to alter flow of ambient medium in and out of the intra-layer gap and an insert layer disposed in the intra-layer gap, wherein the insert layer is coupled to the array of flaps to control opening and closing of the array of flaps to alter the flow of the ambient medium in and out of the intra-layer gap. Various embodiments of the dual pane fabric arrangement and the insert layer are described throughout the present document. For example, FIG. 39 to FIG. 50 and FIGS. 62 to 64 illustrate some embodiments of the article.

In some embodiments, a process of manufacturing an insert layer may include producing an arrangement of materials by adhesively bonding a first laminar material having a first coefficient of thermal expansion (CTE) with a second laminar material having a second CTE that is different from the first CTE using an intermediate bonding material, and roller compressing the arrangement of materials to produce the insert layer. For example, some embodiments are depicted and described with reference to FIG. 10, FIG. 11, FIG. 12, FIG. 15, FIG. 16, FIG. 38, FIG. 42, etc.

In some embodiments, a humidity-responsive porosity-changeable arrangement includes a fabric and a hygroscopic layer attached at a bottom or a top of the fabric. The hygroscopic layer has geometrically shaped pores that allow air to flow to and away from the fabric. Various embodiments of the arrangement, the fabric and the hygroscopic layer are disclosed throughout this document. For example, some embodiments are depicted and described with reference to FIG. 54A to FIG. 62, etc.

In some embodiments, a method of assembly to produce humidity responsive porosity-changeable fabrics or clothing or other wearable or non-wearable structures includes attaching a humidity absorbable material layer to a regular fabric using imprint bonding, utilizing dip coated, spin coated, spray coated or ink-jet coated liquid layer. Various embodiments of the method are described throughout the present document.

In some embodiments, method of assembly to produce humidity responsive porosity-changeable fabrics or clothing or other wearable or non-wearable structures includes attaching a humidity absorbable material layer to a regular fabric using one of a stitching or a pressure lamination or an adhesive lamination technique.

In some embodiments, a method of assembly to produce humidity responsive porosity-changeable fabrics, clothing or other wearable or non-wearable structures includes attaching a humidity absorbable material layer to the regular fabric using a single layer or a two layer spray coating technique.

Various implementations that use the technology described throughout the present document and drawings can be described using the following clauses below.

Clause 1. Articles and methods of assembly to produce thermally adaptive textiles or clothing, or thermally adaptive curtains/draperies for a building or home, or thermally adaptive outdoor camping equipment such as tents or sleeping bags, by attaching temperature responsive thickness changeable bilayer inserts of repeatable “Shape-Memory Structure” onto two separated fabrics in the form of dual pane fabric;

which responds to temperature increase or decrease to cause bending in at least a part of the material to change thermal insulation of the double pane fabric by increasing or decreasing the thickness of air trapped between the two layers, with these star-structured insert made of CTE mismatched bilayer composite material representing a repeatable “Shape-Memory Structure” which exhibits very reproducible expansion and contraction behavior on temperature cycling. According to the invention, the desirable degree of thickness expansion or contraction in the “Shape-Memory Structure” is typically more than 0.2 cm height change for 10 cm length leg horizontal dimension of the structure (equivalent to 2% height change relative to the horizontal length dimension) when the environment temperature is altered by 10° C. Therefore, the disclosed “Shape-Memory Structure” exhibits a ratio of vertical height change to the horizontal dimension, of at least 2%, preferably at least 5%, even more preferably at least 10% per 10° C. temperature change. The desired size of the stars is e.g., in the range of 0.1-100 cm in overall diameter (or equivalent diameter) depending on the applications, preferably 0.2-10 cm, even more preferably 0.5-2 cm. For tent or other type of applications (e.g., for applications such as to open up a large gap in the back of the apparel or on the side of a jacket to let a fresh air flow in through a 1-10 cm level gap), the dimension can be larger, while for apparel applications, the dimension can be smaller. The desired thickness span that the star structure can change is e.g., in the range of 0.01-10 cm, preferably 0.1-5 cm, even more preferably in the range of 0.5-2 cm. The usable temperature range is typically in the range of −50° C. to +50° C. For winter sports. such as cross skiing jackets, the usable temperature range can be pre-set to extend to sub-zero temperatures. For summer jackets in hot weather, the temperature range can be extended toward higher temperature.

with the thickness changeable layer attached onto fabric by replacing the regular fabric in local or whole garment, or by using stitching, adhesive bonding, stapling, physical attachment using magnets, zippers, velcros, buttons, and related techniques;

with the bilayer comprising two substantially different coefficient of thermal expansion (CTE), with the CTE difference of at least 10 ppm/T, preferably at least 20 ppm/° C., even more preferably 50 ppm/° C.

Clause 2. Articles and methods of assembly to produce thermally adaptive textiles or clothing, or thermally adaptive curtains/draperies for a building or home, or thermally adaptive outdoor camping equipment such as tents or sleeping bags, by attaching temperature responsive, pore-opening bilayer material,

which responds to temperature increase or decrease to cause bending in at least a part of the material so as to open or close the flap array and provide thermal regulation of increased or decreased air flow, with these flaps made of CTE mismatched bilayer composite material representing a repeatable “Shape-Memory Structured Flaps” which exhibits very reproducible opening and closing dimensional change behavior on temperature cycling. According to the invention, the desirable degree of flap opening in the “Shape-Memory Structured Flaps” is typically more than 0.2 cm maximum height change for 5 cm length leg horizontal dimension of the structure (equivalent to 4% height change relative to the horizontal flap length dimension) when the environment temperature is altered by 10° C. Therefore, the disclosed “Shape-Memory Structured Flaps” exhibit a ratio of maximum vertical height change to the horizontal flap length dimension, of at least 4%, preferably at least 10%, even more preferably at least 20% per 10° C. temperature change;

with the flap openable layer attached onto fabric by replacing the regular fabric in local or whole garment, or by using stitching, adhesive bonding, stapling, physical attachment using magnets, zippers, Velcro, buttons, and related techniques;

with the bilayer for the flaps comprising two substantially different coefficient of thermal expansion (CTE), with the CTE difference of at least 10 ppm/° C., preferably at least 20 ppm/° C., even more preferably 50 ppm/° C.

with the pore opening configuration selected from vertical pore opening like the case of flap opening, lateral pore opening by lateral bending or movement of the temperature-responsive bilayer, rotational movement of temperature-responsive bilayer to increase the size of the opened pore, or various other configurational changes to open the pore, including a large gap opening on the back or side of apparel for easy flow of fresh air for cooler feeling.

Clause 3. The bilayer articles of Clause 1 and Clause 2 wherein the lower CTE material and the higher CTE material are bonded for coupling, and the lower CTE material is made of shape memory alloys preferably having negative CTE values with essentially constant linear behavior over a temperature span of at least 30° C., preferably at least 50° C. The negative CTE materials is in general fabricated from Cu—Al—Zn, Cu—Al—Mn, Ni—Ti and/or shape memory polymers, or by using negative CTE Kevlar type aromatic polyamide materials, which are adhered to positive CTE materials. The higher CTE material is selected from high strength polymer or composite materials such as cellulose acetate, UHMWPE (ultra-high-molecular-weight polyethylene) or higher CTE alloys such as Al alloys, Mg alloys, Cu alloys austenific stainless steel, with CTE values of at least 15 ppm/° C., preferably at least 20 ppm/T, more preferably at least 50 ppm/° C.

Clause 4. The bilayer articles of Clause 1 and Clause 2 wherein the lower CTE material and the higher CTE material are bonded for coupling, and the lower CTE material is selected from near zero CTE material or low CTE material such as Invar alloy or refractive metal alloy, with CTE value of less than 10 ppm/° C., preferably less than 6 ppm/° C., even more preferably less than 2 ppm/° C. The bilayer articles of Clause 1 and Clause 2 wherein the metallic components are selected to be creep deformation resistant, with increased yield strength by at least 30%, preferably at least 100% as compared to the metals or alloys without plastic deformation. Alternatively, the bilayer articles of Clause 1 and Clause 2 wherein the metallic components are selected to be creep deformation resistant by utilizing precipitation hardening, so as to make the yield strength to be increased by at least 30%, preferably at least 100% as compared to the metals or alloys without precipitation hardening. For the bilayer articles of Clause 1 and Clause 2 wherein polymer components are selected to be a part of the structure, such polymer materials can be strengthened by dispersion hardening of inserted fiber made of glass, metal, ceramic, carbon, or a mesh of these materials. The desired volume fraction of the dispersoid particles or fibers is in the range of 0.1-20 vol %, preferably 0.2-5 vol %, even more preferably 0.5-2 vol %. The desired volume fraction of inserted mesh is in the range of 2-40 vol %, preferably 5-30 vol %, even more preferably 10-20 vol %.

Clause 5. The bilayer articles of Clause 1 and Clause 2 wherein the two layer materials are bonded by adhesives, solder layers, cold welding laminations, spot welding, or RF heating.

Clause 6. The bilayer articles of Clause 1 and Clause 2 wherein the two layer materials are structured with at least one layer having an array or pores, an array of strips, or surface roughness of nano or micropatterning.

Clause 7. The bilayer articles of Clause 1 and Clause 2 wherein at least two sets of bilayers are mirror image attached at the ends to form a bow structure, and there are one or more bow structures arranged as an array between a dual pane fabric to enable the thickness to increase when the environmental temperature gets colder, and the thickness gets reduced when the environmental temperature gets hot, so as to make the person wearing such a fabric feel more comfortable.

Clause 8. The bilayer articles of Clause 1 and Clause 2 wherein at least two sets of bilayers are mirror image attached at the ends to form a bow structure, and there are one or more bow structures arranged in a higher density packed array having a triangular array or square array, using a triangular or square arrangement of neighboring bow structures placed with a small spacing between them, but sufficient spacing to prevent touching or mechanical interference. The desired spacing between neighboring bow structure elements in the dense packing arrangement is at most 2 cm, preferably at most 1 cm, more preferably at most 0.5 cm.

Clause 9. The bilayer of Clauses 1 wherein the amount of thickness change for the dual pane fabric is at least 0.1 mm per degree C. change of environment temperature, preferably at least 1 mm per degree C. change of temperature, and more preferably at least 0.5 cm per degree C. change of temperature.

Clause 10. The bilayer article of Clause 2 having temperature-only-responsive, flap opening structure using CTE mismatch fabric

It allows a change of temperature (underneath the clothing, inside a tent fabric or sleeping bag fabric or behind a drapery) due to enhanced air flow.

It does not cause inadvertent flap opening on fog, light rain or humidity.

It also changes color or light-reflection when an array of flaps are open.

Clause 11. The bilayer article of Clause 2 wherein selected local area color or light-reflection is altered by temperature-responsive flap opening using a CTE mismatched bilayer fabric so as to provide unique design characteristics with enhanced aesthetic properties.

Clause 12. The bilayer articles of Clause 1 and Clause 2 wherein selected local area shape change is introduced by design by temperature-responsive thickness change or by temperature-responsive flap opening so as to produce unique variable three-dimensional design characteristics with enhanced aesthetic properties.

Clause 13. The bilayer articles of Clause 1 and Clause 2 wherein at least two bilayers are stacked in at least some selected regions of garment to amplify the thickness changes or to provide a thicker layer composite structures with flap openable structrures.

Clause 14. The bilayer articles of Clause 1 and Clause 2 wherein the temperature at which one bilayer material or two bilayer material connected into a bow shape is set flat to dictate the starting temperature of bending.

Clause 15. The bilayer articles of Clause 1 with a thickness changeable structure wherein the maximum temperature beyond which the thickness-change no longer occurs in the temperature-responsive smart textile is set at a pre-set temperature.

Clause 16. The bilayer articles of Clause 1 and Clause 2 wherein the temperature at which one bilayer material or two bilayer material connected into a bow shape is set flat at a specific temperature using a method of i) using a round mandrel to press a curved bilayer against to remove the existing curvature, ii) passing the curved bilayer through a rolling mill with tension, iii) using asymmetrical roll diameter pair, iv) applying an upward or downward tension during cold rolling to control/adjust the curvature, or v) applying deformation to one side of the bilayer, etc.

Clause 17. Method of continuously laminating the negative/zero/low CTE and positive CTE layers to produce an insert material for temperature-responsive thickness changeable textiles, with the laminated structure having an adhesive bonding material at the interface, and is roller compression pressed for good adhesion and optionally cured in situ.

Clause 18. The insert in Clause 1 wherein the insert is in the form of bendable beam or ribbon, in the form of screw, or in the form of wave spring, or bow-style form.

Clause 19. The insert in Clause 1 and Clause 2 having friction reducing structures on the ends of temperature responsive, CTE mismatched bilayer ribbons, with slippery spheres attached at the end, ribbon ends curved up, or ribbon ends curved down.

Clause 20. The bilayer articles of Clause 1 and Clause 2 wherein the thickness changeable structure is combined with porosity generating or flap openable structure, so that flap opening on temperature rise for air flow makes the wearer feel cooler, while the dual pane getting thicker on temperature decrease for more thermal insulation to make the wearer feel warmer.

Clause 21. The temperature responsive thickness-changeable textile of Clause 1 wherein the surface of the textile has an attached active functional device array or functional coating layer on the surface of thickness-changeable fabric for augmented comfort or luxurious feeling (e.g., solar cell array, UV, NIR or IR reflective layer, UV, NIR or IR absorbing layer, UV, NIR or IR reflective or transmitting layer, superhydrophobic non-wettable layer, water evaporative cooling device, batteries for heating, thermoelectrics for cooling/heating, ultrasonic device for vibration for easier air transport through fabric, de-odorant device or layer, color-changing device or layer, scent-generating device, acoustic or radio type device, display device, camera, sensors (for temperature, humidity, UV light, gas, human pulse, noise, etc) Wi-Fi receiving or transmitting device.

Clause 22. The flap openable, pore-changeable structure of Clause 2 wherein the surface of the textile has an attached active functional device array or functional coating layer for augmented comfort or luxurious feeling (e.g., solar cell array, UV, NIR or IR reflective layer, UV, NIR or IR absorbing layer, UV, NIR or IR reflective or transmitting layer, superhydrophobic non-wettable layer, water evaporative cooling device, batteries for heating, thermoelectrics for cooling/heating, ultrasonic device for vibration for easier air transport through fabric, de-odorant device or layer, color-changing device or layer, scent-generating device, acoustic or radio type device, display device, camera, sensors (for temperature, humidity, UV light, gas, human pulse, noise, etc) Wi-Fi receiving or transmitting device.

Clause 23. The thickness changeable fabric of Clause 1 and the pore-generating fabric of Clause 2 wherein at least one of the functional devices selected from solar cell array, UV, NIR or IR reflective layer, UV, NIR or IR absorbing layer, UV, NIR or IR reflective or transmitting layer, superhydrophobic non-wettable layer, water evaporative cooling device, batteries for heating, thermoelectrics for cooling/heating, ultrasonic device for vibration for easier air transport through fabric, de-odorant device or layer, color-changing device or layer, scent-generating device, acoustic or radio type device, display device, camera, sensors (for temperature, humidity, UV light, gas, human pulse, noise, etc) Wi-Fi receiving or transmitting device, is incorporated with the smart textile with porous electrical wiring arrangement so that the natural air flow through the regular fabric is minimally blocked, and the mechanical compliance of the fabric comprising the functional devices is ensured.

Clause 24. The Clauses of 18-20 wherein the IR transmitting layer fabric is selected from nylon or polyethylene, or other polymers, preferably nanofiber structured or micro fiber ensemble structures, which can allow emission and dissipation of body heat IR to make the wearer feel cooler. The desired degree of IR transmission is at least 40%, preferably at least 70%, even more preferably at least 85%. The desired average fiber diameter dimension of the IR transmitting structure is in the range of 50 nm to 50 um, preferably in the range of 100 nm to 5 um, even more preferably in the range of 200 nm to 2 um.

Clause 25. Article comprising the structures, materials, devices having thickness-changeable (insulation changeable) textiles of Clause 1 or porosity-changeable structures of Clause 2, having optional functional devices attached, with the applications of the articles and methods including but not limited to, apparels, curtains, back packs, outdoor or indoor camping equipments such as tents, sleeping bags, beach picnic equipment such as adjustable sunlight blockable/transmissible curtains or awnings or beach umbrellas, thermally regulated military personnel clothings, athletes clothings such as downhill or cross-country skiers, ice skaters, mountain hikers, special garments for extreme environments.

Clause 26. Humidity responsive porosity-changeable fabrics or structures comprising regular fabric assembled with a single hygroscopic layer attached at the bottom or top, having geometrical pores for air flow.

Clause 27. Humidity responsive porosity-changeable fabrics of Clause 26 comprising regular fabric assembled with a two-layered material of hydrophobic top layer and hygroscopic bottom layer attached at the bottom or top of the regular fabric. The Two-layered humidity responsive material comprises mostly hydrophobic top layer bonded with diluted hygroscopic layer with reduced feeling of wetness by at least 50%, with a viscosity enhanced by at least 30%, with the two-layered humidity responsive material bonded onto the upper regular fabric.

Clause 28. The humidity responsive porosity-changeable fabrics of Clause 27 wherein the two-layered humidity responsive material is hydrophobic PDMS (Polydimethylsiloxane) and with the diluted hygroscopic material layer comprising cellulose acetate and the hygroscopic material layer of 5-30 volume %.

Clause 29. The humidity responsive porosity-changeable fabrics of Clause 26 or 27 wherein the hygroscopic material layer is selected from e.g., PDMS or PDHS (Polydihexylsilane) with monomer-wise mixed hygroscopic molecules of PEG selected from e.g., PEG dimethacrylate, PEG methacrylate, PEG diacrylate, which also exhibits mechanical flexibility and stretchability of at least 30%, preferably at least 100%.

Clause 30. The humidity responsive porosity-changeable fabrics of Clauses 26-29 wherein porosity of at least 5%, preferably at least 30% is introduced by drying of pre-absorbed water.

Clause 31. The humidity responsive porosity-changeable fabrics of Clauses 26-30 wherein the porosity is introduced in the hydrophobic layer, hygroscopic layer or both. For the porosity in the hydrophobic layer, elastic modulus is desirably reduced by at least 10% and flap opening height increase by at least 10%. For the porosity in the hygroscopic layer, the kinetics of humidity penetration is desirably increased by at least 10% faster time to reach the same flap height for the identical conditions as compared to the absence of porosity in the hygroscopic layer.

Clause 32. The humidity responsive porosity-changeable fabrics of Clause 26 wherein the flap shape is rectangular, triangular, oval, circular, or random geometry, with an elongation aspect ratio of at least 0.5, preferably at least 2.

Clause 33. The humidity responsive porosity-changeable fabrics of Clause 26 wherein the flap configuration is a one piece opening up, two or more split pieces opening up simultaneously, with the flap ends optionally curved to reduce frictional feeling.

Clause 34. Method of assembly to produce humidity responsive porosity-changeable fabrics or clothing or other wearable or non-wearable structures by attaching humidity absorbable material layer to the regular fabric using imprint bonding, utilizing dip coated, spin coated, spray coated or ink-jet coated liquid layer.

Clause 35. Method of assembly to produce humidity responsive porosity-changeable fabrics or clothing or other wearable or non-wearable structures by utilizing stitching or pressure lamination technique, or adhesive lamination technique.

Clause 36. Method of assembly to produce humidity responsive porosity-changeable fabrics, clothings or other wearable or non-wearable structures by attaching humidity absorbable material layer to the regular fabric using single layer or two layer spray coating technique.

Clause 37. The humidity responsive, porosity-changeable textile of Clauses 26-36 wherein the surface of the textile has attached active functional device array or functional coating layer on the surface of thickness-changeable fabric for augmented comfort or luxurious feeling (e.g., solar cell array, UV, NIR or IR reflective layer, UV, NIR or IR absorbing layer, UV, NIR or IR reflective or transmitting layer, superhydrophobic non-wettable layer, water evaporative cooling device, batteries for heating, thermoelectrics for cooling/heating, ultrasonic device for vibration for easier air transport through fabric, de-ordorant device or layer, color-changing device or layer, scent-generating device, acoustic or radio type device, display device, camera, sensors (for temperature, humidity, UV light, gas, human pulse, noise, etc) Wi-Fi receiving or transmitting device.

Clause 38. The Clause of 37 wherein the IR transmitting layer fabric is selected from nylon or polyethylene, preferably comprising nanostructured or micro-dimension fibers.

Clause 39. Article comprising the structures, materials, devices having humidity responsive, porosity-changeable textiles, with the articles include but not limited to, indoor or outdoor apparels, back packs, outdoor or indoor tents.

While this patent document contains many specifics, these should not be construed as limitations on the scope of any disclosed technology or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Only a few embodiments are described. Other embodiments and their variations and enhancements can be made based on what is described and illustrated. Various applications of the structures that enables shape change, thickness change, porosity change, or thermal insulation change include structures for sensors and actuators, as well as control/adjustment of temperature, humidity or gas-permeability, and liquid permeability, are possible for wearable or non-wearable devices and structures. The structures are also applicable to mechanical, thermal, optical, and electrical designs/structures, with the application to materials comprising fabrics (apparels, curtains, draperies, back packs, outdoor or sporting goods structures including tents).

1. An article of manufacture, comprising:
a dual pane fabric arrangement comprising a first pane of fabric and a second pane of fabric separated by an intra-layer gap; and
an insert layer disposed in the intra-layer gap, wherein the insert layer causes a thickness of the intra-layer gap to change responsive to changes in ambient temperature.

2. The article of claim 1, wherein the insert layer causes the thickness of the intra-layer gap to change due to bending in at least a part of the insert layer due to changes in the ambient temperature.

3. The article of claim 1, wherein the insert layer comprises a repeatable shape memory structure that wrinkles on temperature change.

4. The article of claim 1, wherein the insert layer comprises a shape memory structure comprising an array of circular shaped, oval shaped, trilobal shaped, ribbon shaped or random shaped fibers or partially flattened fibers with an off-centered relative arrangement of the two elongated materials having different coefficients of thermal expansion,

5. The article of claim 4, wherein the two elongated materials comprise a metal-metal, a metal polymer, a polymer-polymer, or a polymer-composite combination,

6-13. (canceled)

14. The article of claim 1
wherein at least one of the first pane and the second pane comprises an array of bilayer attached flaps move upward or downward controllable to alter flow of ambient medium in and out of the intra-layer gap; and
wherein the insert layer is coupled to the array of flaps to control opening and closing of the array of flaps to alter the flow of the ambient medium in and out of the intra-layer gap.

15. The article of manufacture of claim 14, wherein the ambient medium comprises air.

16. The article of manufacture of claim 1, wherein the insert layer comprises a first portion having a first coefficient of thermal expansion (CTE) and a second portion having a second, different CTE, the first portion and the second portion being connected to each other to change shape in response to changes in the ambient temperature.

17-21. (canceled)

22. The article of manufacture of claim 16, wherein the first portion comprises a lower CTE material and the second portion comprises a higher CTE material, and wherein the first portion and the second portion are bonded for coupling, and the lower CTE material is made of a shape memory alloy with distributed phase transformation temperatures with a linear change of dimension with temperature.

23. The article of manufacture of claim 22, wherein the lower CTE material has a negative CTE value.

24-38. (canceled)

39. The article of manufacture of claim 16, wherein the first portion comprises a lower CTE material and the second portion comprises a higher CTE material, wherein the lower CTE material and the higher CTE material are bonded for coupling, and the lower CTE material comprises a near-zero CTE type materials

40. The article of manufacture of claim 39, wherein the lower CTE material includes an Invar alloy a refractive metal alloy, or a Kevlar type low CTE or negative CTE polymer.

41-44. (canceled)

45. The article of manufacture of claim 16, wherein the insert layer comprises two layer materials that are structured with at least one layer having an array or pores, an array of strips, or surface roughness of nano or micropatterning.

46. The article of manufacture of claim 16, wherein the insert layer comprises at least two bilayers, wherein each bilayer is shaped as a strip and the at least two bilayers are connected at long ends of the strip to form a bow structure.

47-78. (canceled)

79. A humidity responsive porosity-changeable arrangement, comprising:
a fabric; and
a hygroscopic layer attached at a bottom or top of the fabric, the hygroscopic layer having geometrical pores that allow air to flow to and away from the fabric.

80. The arrangement of claim 79, further comprising a two-layered humidity responsive material that includes a hydrophobic top layer bonded with a diluted hygroscopic layer that reduces a feeling of wetness by at least 50%, with a viscosity enhanced by at least 30%, wherein the two-layered humidity responsive material bonded onto the upper regular fabric.

81. (canceled)

82. The humidity responsive porosity-changeable fabrics of claims 79, wherein the hygroscopic material layer is selected from PDMS (Polydimethylsiloxane) or PDHS (Polydihexylsilane) with monomer-wise mixed hygroscopic molecules of PEG (hygroscopic polyethylene glycol) selected from PEG dimethacrylate, PEG methacrylate, PEG diacrylate, which also exhibits mechanical flexibility and stretchability between 30% and 100%.

83-90. (canceled)

91. The humidity responsive porosity-changeable arrangement of claim 79, wherein the geometric pores are covered by a flap, wherein the flap is made up of a one piece opening up, two or more split pieces opening up simultaneously, with the flap ends optionally curved to reduce frictional feeling.

92-98. (canceled)

99. An article of manufacture, comprising:
a single pane fabric having cut-out portions; and
an array of bilayer flaps attached onto top or bottom surface of cut-out portions of the single pane in such a way that when the array of bilayer flaps bends upon a temperature change, a corresponding attached fabric portion in contact with each of the flaps also bend upward or downward to alter flow of ambient medium in and out of the fabric plane.

100. The article of manufacture of claim 99, wherein the ambient medium comprises air.
